(19) United States
(12) Patent Application Publication
(10) Pub. No.: US 2012/0138206 A1
(43) Pub. Date: Jun. 7, 2012

(54) ADHESIVES AND SEALANTS CONTAINING CYCLOHEXANE POLYCARBOXYLIC ACID DERIVATIVES

(75) Inventors: Jochen Wagner, Ruppertsweiler (DE); Boris Breitscheidel, Limburgerhof (DE); Tobias Austermann, Muenster (DE); Helmut Mack, Traunstein (DE)

(73) Assignee: BASF SE, Ludwigshafen (DE)

(21) Appl. No.: 13/386,236

(22) PCT Filed: Jun. 4, 2010
(86) PCT No.: PCT/EP10/57812

§ 371 Date: Jan. 20, 2012

(30) Foreign Application Priority Data
Jul. 23, 2009 (EP) 09166195.9

(51) Int. Cl. B29C 65/00; C09J 181/04; C09J 133/00; C09J 11/06; C09J 175/02

(52) U.S. Cl. 156/60; 524/285

(57) ABSTRACT

The invention relates to an adhesive or sealant comprising at least (A) 10% to 90% by weight of a compound selected from the group consisting of polyurethanes, polyureas, polyacrylates and polysulphides and at least (B) 1% to 50% by weight of a cyclohexanepolycarboxylic acid derivative, the adhesive or sealant containing no C₄ to C₈ alkyl terephthalate. The composition features a low glass transition temperature and also a low dirt pick-up tendency, without detriment to the further performance properties. An additional advantage of the proposed adhesives and sealants lies in their well-balanced mechanical properties. A process for preparing them, and their use for material bonds between parts to be joined, are disclosed.

The present invention relates to adhesives and sealants based on polyurethanes, poly-ureas, polyacrylates and polysulphides and comprising cyclohexanepolycarboxylic acid derivatives, to a process for preparing them and to their use.

Adhesives and sealants based on polyurethanes, polyureas, polyacrylates and poly-sulphides have a very broad application spectrum and are used, in formulations adapted to the particular end use, in—for example—construction and civil engineering, in the aircraft or automotive industry, and in watercraft construction. A key component of such a formulation is generally plasticizers, which may account for a fraction of more than 40% of the total formulation. Plasticizers, according to DIN 55945, are inert organic solids and liquids with a low vapour pressure. Through their solvency and swelling capacity they reduce the hardness of the polymer, compatibilize the filler/polymer mixture and raise the low-temperature elasticity. Plasticizers in adhesives and sealants also serve in particular to increase the expandability of the film that is produced.

A frequent problem affecting adhesives and sealants is a tacky surface. Especially when the optical requirements imposed on the adhesive and sealed joint are exacting, this leads to problems, since the surface may become soiled. Reducing the surface tack, on the other hand, is often accompanied by a high glass transition temperature and hence by embrittlement of the adhesives and sealants.

The problem which therefore arises is that of providing an adhesive or sealant based on polyurethanes, polyureas, polyacrylates and polysulphides that in the cured state has a low surface tack and hence a low dirt pick-up tendency, while at the same time having a very low glass transition temperature with good expandability and good tensile strength.

This problem has been solved in accordance with the invention by adhesives or sealants comprising (A) 10% to 90% by weight of at least one compound selected from the group consisting of nonsilyated polyurethanes, polyureas, polyacrylates and polysulphides and (B) 1% to 50% by weight of at least one cyclohexanepolycarboxylic add derivative, the adhesive or sealant containing no C₄ to C₈ alkyl terephthalate. Surprisingly it has been found that the cyclohexanepolycarboxylic acid derivatives in the adhesives or sealants of the invention have a low glass transition temperature without detriment to the other performance properties. Surprisingly the formulations of the invention additionally feature a low tack in the cured state and thus a low dirt pick-up tendency, are compatible with the binders of the invention and are inexpensive.

The present invention accordingly provides an adhesive or sealant based on poly-urethanes, polyureas, polyacrylates and polysulphides and comprising at least one cyclohexanepolycarboxylic acid derivative, to a process for preparing these adhesives and sealants, and to their use.

Preferably the adhesive or sealant comprises, as cyclohexanepolycarboxylic acid derivatives, esters of the formula (I),

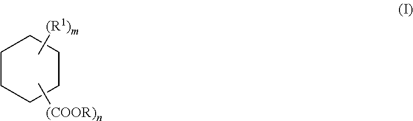

in which
R¹ is a substituent on the saturated cyclohexane ring and is a C₁-C₁₀ alkyl or C₃-C₈ cycloalkyl group,
m is 0, 1, 2, 3 or 4,
n is 2, 3 or 4, and
R is a C₁-C₃₀ alkyl, C₁-C₃₀ alkoxy, C₃-C₈ cycloalkyl, C₈-C₃₀ arylphenyl or C₁-C₃₀ alkyl-cycloalkyl group, with at least one radical R being a C₁-C₃₀ alkyl, C₁-C₃₀ alkoxy or C₃-C₈ cycloalkyl group.

In the formula (I) the radicals R¹ may be alike or different when m is 2, 3 or 4. The C₁-C₁₀ alkyl groups may be linear or branched. If R¹ is an alkyl group, it is preferably a C₁-C₈ alkyl group, more preferably a C₁-C₆ alkyl group. Examples of such alkyl groups are methyl, ethyl, n-propyl, isopropyl, n-butyl, isobutyl, sec-butyl, tert-butyl, n-pentyl, n-hexyl, n-octyl and 2-ethylhexyl. Preferably m is 0.

The radicals R may be alike or different. The C₁-C₃₀ alkyl groups and the alkyl radicals of the C₁-C₃₀ alkoxy groups may be linear or branched. R is preferably C₁-C₃₀ alkyl, C₂₀ alkyl, more preferably C₁-C₁₈ alkyl, very preferably C₁-C₁₃ alkyl. Examples of such alkyl groups are the alkyl groups already specified for R¹, and also n-nonyl, isononyl, n-decyl, isodecyl, n-undecyl, isoundecyl, n-dodecyl, isododecyl, n-tridecyl, isotridecyl, stearyl, and n-eicosyl.

The alkyl groups may in each case be individual isomers of the stated alkyl groups, or mixtures of different alkyl groups. The different alkyl groups may be different isomers with the same number of carbon atoms and/or may be alkyl groups which have a different number of carbon atoms.

The cyclohexanepolycarboxylic acid derivatives used in accordance with the invention are more particularly mono-, di-, tri- and, tetra-esters and anhydrides of the cyclohexanepolycarboxylic acids. Preferably all of the carboxylic acid groups are in esterified form. The esters used are alkyl, cycloalkyl and alkoxyalkyl esters, preferably alkyl esters, with preferred alkyl groups R having already been specified above.

The at least one cyclohexanepolycarboxylic acid derivative is preferably selected from the group consisting of ring-hydrogenated monoalkyl and dialkyl esters of phthalic acid, isophthalic acid and terephthalic acid, ring-hydrogenated monoalkyl, dialkyl and trialkyl esters of trimellitic acid, trimesic acid and hemimellitic acid, or monoalkyl, dialkyl, tri-alkyl and tetraalkyl esters of pyromellitic acid, it being possible for the alkyl groups R to be linear or branched, and the alkyl groups R each containing 1 to 30, preferably 1 to 20, more preferably 1 to 18, very preferably 1 to 13 carbon atoms, and mixtures of two or more of these. Suitable alkyl groups R have already been specified above. Particular preference is given to cyclohexane-1,2-dicarboxylic acid dialkyl esters.

Particular preference is given to cyclohexane-1,4-dicarboxylic acid alkyl esters, such as, for example, monomethyl cyclohexane-1,4-dicarboxylate, dimethyl cyclohexane-1,4-dicarboxylate, diethyl cyclohexane-1,4-dicarboxylate, di-n-propyl cyclohexane-1,4-dicarboxylate, di-n-butyl cyclohexane-1,4-dicarboxylate, di-tert-butyl cyclohexane-1,4-dicarboxylate, diisobutyl cyclohexane-1,4-dicarboxylate, monoglycol cyclohexane-1,4-dicarboxylate, diglycol cyclohexane-1,4-dicarboxylate, di-n-octyl cyclohexane-1,4-dicarboxylate, diisooctyl cyclohexane-1,4-dicarboxylate, mono-2-ethylhexyl cyclo-hexane-1,4-dicarboxylate, di-2-ethylhexyl cyclohexane-1,4-dicarboxylate, di-n-nonyl cyclohexane-1,4-dicarboxylate, diisononyl cyclohexane-1,4-dicarboxylate, di-n-decyl cyclohexane-1,4-dicarboxylate, di-n-undecyl cyclohexane-1,4-dicarboxylate, diisodecyl cyclohexane-1,4-dicarboxylate, diisododecyl cyclohexane-1,4-dicarboxylate, di-n-octa-decyl cyclohexane-1,4-dicarboxylate, diisooctadecyl cyclohexane-1,4-dicarboxylate, di-n-eicosyl cyclohexane-1,4-dicarboxylate, monocyclohexyl cyclohexane-1,4-dicarboxylate and dicyclohexyl cyclohexane-1,4-dicarboxylate;

diisopropyl cyclohexane-1,4-dicarboxylate, di-n-hexyl cyclohexane-1,4-dicarboxylate, diisohexyl cyclohexane-1,4-dicarboxylate, di-n-heptyl cyclohexane-1,4-dicarboxylate, diisoheptyl cyclohexane-1,4-dicarboxylate, di-2-propylheptyl cyclohexane-1,4-dicarboxylate, diisoundecyl cyclohexane-1,4-dicarboxylate, di-n-dodecyl cyclo-hexane-1,4-dicarboxylate, di-n-tridecyl cyclohexane-1,4-dicarboxylate, diisotridecyl cyclohexane-1,4-dicarboxylate, di-n-pentyl cyclohexane-1,4-dicarboxylate and diisopentyl cyclohexane-1,4-dicarboxylate;
diisopropyl, cyclohexane-1,2-dicarboxylate, di-n-hexyl cyclohexane-1,2-dicarboxylate, diisohexyl cyclohexane-1,2-dicarboxylate, di-n-heptyl cyclohexane-1,2-dicarboxylate, diisoheptyl cyclohexane-1,2-dicarboxylate, di-2-propylheptyl cyclohexane-1,2-dicarboxylate, diisoundecyl cyclohexane-1,2-dicarboxylate, di-n-dodecyl cyclo-hexane-1,2-dicarboxylate, di-n-tridecyl cyclohexane-1,2-dicarboxylate, diisotridecyl cyclohexane-1,2-dicarboxylate, di-n-pentyl cyclohexane-1,2-dicarboxylate and diiso-pentyl cyclohexane-1,2-dicarboxylate;
cyclohexane-1,2-dicarboxylic acid alkyl esters, such as, for example, monomethyl cyclohexane-1,2-dicarboxylate, dimethyl cyclohexane-1,2-dicarboxylate, diethyl cyclo-hexane-1,2-dicarboxylate, di-n-propyl cyclohexane-1,2-dicarboxylate, di-n-butyl cyclo-hexane-1,2-dicarboxylate, di-tert-butyl cyclohexane-1,2-dicarboxylate, diisobutyl cyclo-hexane-1,2-dicarboxylate, monoglycol cyclohexane-1,2-dicarboxylate, diglycol cyclo-hexane-1,2-dicarboxylate, di-n-octyl cyclohexane-1,2-dicarboxylate, diisooctyl cyclo-hexane-1,2-dicarboxylate, di-2-ethylhexyl cyclohexane-1,2-dicarboxylate, di-n-nonyl cyclohexane-1,2-dicarboxylate, diisononyl cyclohexane-1,2-dicarboxylate, di-n-decyl cyclohexane-1,2-dicarboxylate, diisodecyl cyclohexane-1,2-dicarboxylate, di-n-undecyl cyclohexane-1,2-dicarboxylate, diisododecyl cyclohexane-1,2-dicarboxylate, di-n-octadecyl cyclohexane-1,2-dicarboxylate, diisooctadecyl cyclohexane-1,2-dicarboxylate, di-n-eicosyl cyclohexane-1,2-dicarboxylate, monocyclohexyl cyclohexane-1,2-dicarboxylate and dicyclohexyl cyclohexane-1,2-dicarboxylate;
mixed esters of cyclohexane-1,2-dicarboxylic acid with C1 to C13 alcohols, such as, for example, ethyl methyl cyclohexane-1,2-dicarboxylate, n-propyl methyl cyclohexane-1,2-dicarboxylate, isopropyl methyl cyclohexane-1,2-dicarboxylate, n-butyl methyl cyclohexane-1,2-dicarboxylate, tert-butyl methyl cyclohexane-1,2-dicarboxylate, iso-butyl methyl cyclohexane-1,2-dicarboxylate, glycol methyl cyclohexane-1,2-dicarboxylate, n-hexyl methyl cyclohexane-1,2-dicarboxylate, isohexyl methyl cyclohexane-1,2-dicarboxylate, n-heptyl methyl cyclohexane-1,2-dicarboxylate, iso-heptyl methyl cyclohexane-1,2-dicarboxylate, n-octyl methyl cyclohexane-1,2-dicarboxylate, isooctyl methyl cyclohexane-1,2-dicarboxylate, 2-ethylhexyl methyl cyclohexane-1,2-dicarboxylate, n-nonyl methyl cyclohexane-1,2-dicarboxylate, isononyl methyl cyclohexane-1,2-dicarboxylate, 2-propylheptyl methyl cyclohexane-1,2-dicarboxylate, n-decyl methyl cyclohexane-1,2-dicarboxylate, isodecyl methyl cyclohexane-1,2-dicarboxylate, n-undecyl methyl cyclohexane-1,2-dicarboxylate, iso-undecyl methyl cyclohexane-1,2-dicarboxylate, n-dodecyl methyl cyclohexane-1,2-dicarboxylate, isododecyl methyl cyclohexane-1,2-dicarboxylate, n-tridecyl methyl cyclohexane-1,2-dicarboxylate, isotridecyl methyl cyclohexane-1,2-dicarboxylate, n-propyl ethyl cyclohexane-1,2-dicarboxylate, isopropyl ethyl cyclohexane-1,2-dicarboxylate, n-butyl ethyl cyclohexane-1,2-dicarboxylate, tert-butyl ethyl cyclo-hexane-1,2-dicarboxylate, isobutyl ethyl cyclohexane-1,2-dicarboxylate, glycol ethyl cyclohexane-1,2-dicarboxylate, n-hexyl ethyl cyclohexane-1,2-dicarboxylate, isohexyl ethyl cyclohexane-1,2-dicarboxylate, n-heptyl ethyl cyclohexane-1,2-dicarboxylate, iso-heptyl ethyl cyclohexane-1,2-dicarboxylate, n-octyl ethyl cyclohexane-1,2-dicarboxylate, isooctyl ethyl cyclohexane-1,2-dicarboxylate, 2-ethylhexyl ethyl cyclohexane-1,2-dicarboxylate, n-nonyl ethyl cyclohexane-1,2-dicarboxylate, isononyl ethyl cyclohexane-1,2-dicarboxylate, 2-propylheptyl ethyl cyclohexane-1,2-dicarboxylate, n-decyl ethyl cyclohexane-1,2-dicarboxylate, isodecyl ethyl cyclo-hexane-1,2-dicarboxylate, n-undecyl ethyl cyclohexane-1,2-dicarboxylate, isoundecyl ethyl cyclohexane-1,2-dicarboxylate, n-dodecyl ethyl cyclohexane-1,2-dicarboxylate, isododecyl ethyl cyclohexane-1,2-dicarboxylate, n-tridecyl ethyl cyclohexane-1,2-dicarboxylate, isotridecyl ethyl cyclohexane-1,2-dicarboxylate, isopropyl n-propyl cyclohexane-1,2-dicarboxylate, n-butyl n-propyl cyclohexane-1,2-dicarboxylate, tert-butyl n-propyl cyclohexane-1,2-dicarboxylate, isobutyl n-propyl cyclohexane-1,2-dicarboxylate, glycol n-propyl cyclohexane-1,2-dicarboxylate, n-hexyl n-propyl cyclohexane-1,2-dicarboxylate, isohexyl n-propyl cyclohexane-1,2-dicarboxylate, n-heptyl n-propyl cyclohexane-1,2-dicarboxylate, isoheptyl n-propyl cyclohexane-1,2-dicarboxylate, n-octyl n-propyl cyclohexane-1,2-dicarboxylate, isooctyl n-propyl cyclohexane-1,2-dicarboxylate, 2-ethylhexyl n-propyl cyclohexane-1,2-dicarboxylate, n-nonyl n-propyl cyclohexane-1,2-dicarboxylate, isononyl n-propyl cyclohexane-1,2-dicarboxylate, 2-propylheptyl n-propyl cyclohexane-1,2-dicarboxylate, n-decyl n-propyl cyclohexane-1,2-dicarboxylate, isodecyl n-propyl cyclohexane-1,2-dicarboxylate, n-undecyl n-propyl cyclohexane-1,2-dicarboxylate, isoundecyl n-propyl cyclohexane-1,2-dicarboxylate, n-dodecyl n-propyl cyclohexane-1,2-dicarboxylate, isododecyl n-propyl cyclohexane-1,2-dicarboxylate, n-tridecyl n-propyl cyclohexane-1,2-dicarboxylate, isotridecyl n-propyl cyclohexane-1,2-dicarboxylate, n-butyl isopropyl cyclohexane-1,2-dicarboxylate, tert-butyl isopropyl cyclohexane-1,2-dicarboxylate, isobutyl isopropyl cyclohexane-1,2-dicarboxylate, glycol isopropyl cyclohexane-1,2-dicarboxylate, n-hexyl isopropyl cyclohexane-1,2-dicarboxylate, isohexyl isopropyl cyclohexane-1,2-dicarboxylate, n-heptyl isopropyl cyclohexane-1,2-dicarboxylate, isoheptyl isopropyl cyclohexane-1,2-dicarboxylate, n-octyl isopropyl cyclohexane-1,2-dicarboxylate, isooctyl isopropyl cyclohexane-1,2-dicarboxylate, 2-ethylhexyl isopropyl cyclohexane-1,2-dicarboxylate, n-nonyl iso-propyl cyclohexane-1,2-dicarboxylate, isononyl isopropyl cyclohexane-1,2-dicarboxylate, 2-propylheptyl isopropyl cyclohexane-1,2-dicarboxylate, n-decyl iso-propyl cyclohexane-1,2-dicarboxylate, isodecyl isopropyl cyclohexane-1,2-dicarboxylate, n-undecyl isopropyl cyclohexane-1,2-dicarboxylate, isoundecyl isopropyl cyclohexane-1,2-dicarboxylate, n-dodecyl isopropyl cyclohexane-1,2-dicarboxylate, isododecyl isopropyl cyclohexane-1,2-dicarboxylate, n-tridecyl iso-propyl cyclohexane-1,2-dicarboxylate, isotridecyl isopropyl cyclohexane-1,2-dicarboxylate, tert-butyl n-butyl cyclohexane-1,2-dicarboxylate, isobutyl n-butyl cyclohexane-1,2-dicarboxylate, glycol n-butyl cyclohexane-1,2-dicarboxylate, n-hexyl n-butyl cyclohexane-1,2-dicarboxylate, isohexyl n-butyl cyclohexane-1,2-dicarboxylate, n-heptyl n-butyl cyclohexane-1,2-dicarboxylate, isoheptyl n-butyl cyclohexane-1,2-dicarboxylate, n-octyl n-butyl cyclohexane-1,2-dicarboxylate, isooctyl n-butyl cyclohexane-1,2-dicarboxylate, 2-ethylhexyl n-butyl cyclohexane-1,2-dicarboxylate, n-nonyl n-butyl cyclohexane-1,2-dicarboxylate, isononyl n-butyl cyclohexane-1,2-dicarboxylate, 2-propylheptyl n-butyl cyclohexane-1,2-dicarboxylate, n-decyl n-butyl cyclohexane-1,2-dicarboxylate, isodecyl n-butyl cyclohexane-1,2-dicarboxylate, n-undecyl n-butyl cyclohexane-1,2-dicarboxylate, isoundecyl n-butyl cyclohexane-1,2-dicarboxylate, n-dodecyl n-butyl cyclohexane-1,2-dicarboxylate, isododecyl n-butyl cyclohexane-1,2-dicarboxylate, n-tridecyl n-butyl cyclohexane-1,2-dicarboxylate, iso-tridecyl n-butyl cyclohexane-1,2-dicarboxylate, isobutyl tert-butyl cyclohexane-1,2-dicarboxylate, glycol tert-butyl cyclohexane-1,2-dicarboxylate, n-hexyl tert-butyl cyclohexane-1,2-dicarboxylate, isohexyl, tert-butyl cyclohexane-1,2-dicarboxylate, n-heptyl tert-butyl cyclohexane-1,2-dicarboxylate, isoheptyl tert-butyl cyclohexane-1,2-dicarboxylate, n-octyl tert-butyl cyclohexane-1,2-dicarboxylate, isooctyl tert-butyl cyclohexane-1,2-dicarboxylate, 2-ethylhexyl tert-butyl cyclohexane-1,2-dicarboxylate, n-nonyl tert-butyl cyclohexane-1,2-dicarboxylate, isononyl tert-butyl cyclohexane-1,2-dicarboxylate, 2-propylheptyl tert-butyl cyclohexane-1,2-dicarboxylate, n-decyl tert-butyl cyclohexane-1,2-dicarboxylate, isodecyl tert-butyl cyclohexane-1,2-dicarboxylate, n-undecyl tert-butyl cyclohexane-1,2-dicarboxylate, isoundecyl tert-butyl cyclohexane-1,2-dicarboxylate, n-dodecyl tert-butyl cyclohexane-1,2-dicarboxylate, isododecyl tert-butyl cyclohexane-1,2-dicarboxylate, n-tridecyl tert-butyl cyclohexane-1,2-dicarboxylate, isotridecyl tert-butyl cyclohexane-1,2-dicarboxylate, glycol isobutyl cyclohexane-1,2-dicarboxylate, n-hexyl isobutyl cyclohexane-1,2-dicarboxylate, iso-hexyl isobutyl cyclohexane-1,2-dicarboxylate, n-heptyl isobutyl cyclohexane 1,2-dicarboxylate, isoheptyl isobutyl cyclohexane-1,2-dicarboxylate, n-octyl isobutyl cyclohexane-1,2-dicarboxylate, isooctyl isobutyl cyclohexane-1,2-dicarboxylate, 2-ethylhexyl isobutyl cyclohexane-1,2-dicarboxylate, n-nonyl isobutyl cyclohexane-1,2-dicarboxylate, isononyl isobutyl cyclohexane-1,2-dicarboxylate, 2-propylheptyl iso-butyl cyclohexane-1,2-dicarboxylate, n-decyl isobutyl cyclohexane-1,2-dicarboxylate, isodecyl isobutyl cyclohexane-1,2-dicarboxylate, n-undecyl isobutyl cyclohexane-1,2-dicarboxylate, isoundecyl isobutyl cyclohexane-1,2-dicarboxylate, n-dodecyl iso-butyl cyclohexane-1,2-dicarboxylate, isododecyl isobutyl cyclohexane-1,2-dicarboxylate, n-tridecyl isobutyl cyclohexane-1,2-dicarboxylate, isotridecyl isobutyl cyclohexane-1,2-dicarboxylate, n-hexyl glycol cyclohexane-1,2-dicarboxylate, isohexyl glycol cyclohexane-1,2-dicarboxylate, n-heptyl glycol cyclohexane-1,2-dicarboxylate, isoheptyl glycol cyclohexane-1,2-dicarboxylate, n-octyl glycol cyclohexane-1,2-dicarboxylate, isooctyl glycol cyclohexane-1,2-dicarboxylate, 2-ethylhexyl glycol cyclohexane-1,2-dicarboxylate, n-nonyl glycol cyclohexane-1,2-dicarboxylate, isononyl glycol cyclohexane-1,2-dicarboxylate, 2-propylheptyl glycol cyclohexane-1,2-dicarboxylate, n-decyl glycol cyclohexane-1,2-dicarboxylate, isodecyl glycol cyclohexane-1,2-dicarboxylate, n-undecyl glycol cyclohexane-1,2-dicarboxylate, isoundecyl glycol cyclohexane-1,2-dicarboxylate, n-dodecyl glycol cyclohexane-1,2-dicarboxylate, isododecyl glycol cyclohexane-1,2-dicarboxylate, n-tridecyl glycol cyclohexane-1,2-dicarboxylate, isotridecyl glycol cyclohexane-1,2-dicarboxylate, isohexyl n-hexyl cyclohexane-1,2-dicarboxylate, n-heptyl n-hexyl cyclohexane-1,2-dicarboxylate, iso-heptyl n-hexyl cyclohexane-1,2-dicarboxylate, n-octyl n-hexyl cyclohexane-1,2-dicarboxylate, isooctyl n-hexyl cyclohexane-1,2-dicarboxylate, 2-ethylhexyl n-hexyl cyclohexane-1,2-dicarboxylate, n-nonyl n-hexyl cyclohexane-1,2-dicarboxylate, iso-nonyl n-hexyl cyclohexane-1,2-dicarboxylate, 2-propylheptyl n-hexyl cyclohexane-1,2-dicarboxylate, n-decyl n-hexyl cyclohexane-1,2-dicarboxylate, isodecyl n-hexyl cyclohexane-1,2-dicarboxylate, n-undecyl n-hexyl cyclohexane-1,2-dicarboxylate, iso-undecyl n-hexyl cyclohexane-1,2-dicarboxylate, n-dodecyl n-hexyl cyclohexane-1,2-dicarboxylate, isododecyl n-hexyl cyclohexane-1,2-dicarboxylate, n-tridecyl n-hexyl cyclohexane-1,2-dicarboxylate, isotridecyl n-hexyl cyclohexane-1,2-dicarboxylate, n-heptyl isohexyl cyclohexane-1,2-dicarboxylate, isoheptyl isohexyl cyclohexane-1,2-dicarboxylate, n-octyl isohexyl cyclohexane-1,2-dicarboxylate, isooctyl isohexyl cyclohexane-1,2-dicarboxylate, 2-ethylhexyl isohexyl cyclohexane-1,2-dicarboxylate, n-nonyl isohexyl cyclohexane-1,2-dicarboxylate, isononyl isohexyl cyclohexane-1,2-dicarboxylate, 2-propylheptyl isohexyl cyclohexane-1,2-dicarboxylate, n-decyl iso-hexyl cyclohexane-1,2-dicarboxylate, isodecyl isohexyl cyclohexane-1,2-dicarboxylate, n-undecyl isohexyl, cyclohexane-1,2-dicarboxylate, isoundecyl isohexyl cyclohexane-1,2-dicarboxylate, n-dodecyl isohexyl cyclohexane-1,2-dicarboxylate, isododecyl iso-hexyl cyclohexane-1,2-dicarboxylate, n-tridecyl isohexyl cyclohexane-1,2-dicarboxylate, isotridecyl isohexyl cyclohexane-1,2-dicarboxylate, isoheptyl n-heptyl cyclohexane-1,2-dicarboxylate, n-octyl n-heptyl cyclohexane-1,2-dicarboxylate, isooctyl n-heptyl cyclohexane-1,2-dicarboxylate, 2-ethylhexyl n-heptyl cyclohexane-1,2-dicarboxylate, n-nonyl n-heptyl cyclohexane-1,2-dicarboxylate, isononyl n-heptyl cyclohexane-1,2-dicarboxylate, 2-propylheptyl n-heptyl cyclohexane-1,2-dicarboxylate, n-decyl n-heptyl cyclohexane-1,2-dicarboxylate, isodecyl n-heptyl cyclohexane-1,2-dicarboxylate, n-undecyl n-heptyl cyclohexane-1,2-dicarboxylate, isoundecyl n-heptyl cyclohexane-1,2-dicarboxylate, n-dodecyl n-heptyl cyclohexane-1,2-dicarboxylate, isododecyl n-heptyl cyclohexane-1,2-dicarboxylate, n-tridecyl n-heptyl cyclohexane-1,2-dicarboxylate, isotridecyl n-heptyl cyclohexane-1,2-dicarboxylate, n-octyl isoheptyl cyclohexane-1,2-dicarboxylate, isooctyl isoheptyl cyclohexane-1,2-dicarboxylate, 2-ethylhexyl isoheptyl cyclohexane-1,2-dicarboxylate, n-nonyl isoheptyl cyclohexane-1,2-dicarboxylate, isononyl isoheptyl cyclohexane-1,2-dicarboxylate, 2-propylheptyl isoheptyl cyclohexane-1,2-dicarboxylate, n-decyl isoheptyl cyclohexane-1,2-dicarboxylate, isodecyl isoheptyl cyclohexane-1,2-dicarboxylate, n-undecyl isoheptyl cyclohexane-1,2-dicarboxylate, isoundecyl isoheptyl cyclohexane-1,2-dicarboxylate, n-dodecyl isoheptyl cyclohexane-1,2-dicarboxylate, isododecyl isoheptyl cyclohexane-1,2-dicarboxylate, n-tridecyl isoheptyl cyclohexane-1,2-dicarboxylate, isotridecyl isoheptyl cyclohexane-1,2-dicarboxylate, isooctyl n-octyl cyclohexane-1,2-dicarboxylate, 2-ethylhexyl n-octyl cyclohexane-1,2-dicarboxylate, n-nonyl n-octyl cyclohexane-1,2-dicarboxylate, isononyl n-octyl cyclohexane-1,2-dicarboxylate, 2-propylheptyl n-octyl cyclohexane-1,2-dicarboxylate, n-decyl n-octyl cyclohexane-1,2-dicarboxylate, isodecyl n-octyl cyclohexane-1,2-dicarboxylate, n-undecyl n-octyl cyclohexane-1,2-dicarboxylate, iso-undecyl n-octyl cyclohexane-1,2-dicarboxylate, n-dodecyl n-octyl cyclohexane-1,2-dicarboxylate, isododecyl n-octyl cyclohexane-1,2-dicarboxylate, n-tridecyl n-octyl cyclohexane-1,2-dicarboxylate, isotridecyl n-octyl cyclohexane-1,2-dicarboxylate, 2-ethylhexyl isooctyl cyclohexane-1,2-dicarboxylate, n-nonyl isooctyl cyclohexane-1,2-dicarboxylate, isononyl isooctyl cyclohexane-1,2-dicarboxylate, 2-propylheptyl isooctyl cyclohexane-1,2-dicarboxylate, n-decyl isooctyl cyclohexane-1,2-dicarboxylate, isodecyl isooctyl cyclohexane-1,2-dicarboxylate, n-undecyl isooctyl cyclohexane-1,2-dicarboxylate, isoundecyl isooctyl cyclohexane-1,2-dicarboxylate, n-dodecyl iso-octyl cyclohexane-1,2-dicarboxylate, isododecyl isooctyl cyclohexane-1,2-dicarboxylate, n-tridecyl isooctyl cyclohexane-1,2-dicarboxlyate, isotridecyl isooctyl cyclohexane-1,2-dicarboxylate, n-nonyl 2-ethylhexyl cyclohexane-1,2-dicarboxylate, isononyl 2-ethylhexyl cyclohexane-1,2-dicarboxylate, 2-propylheptyl 2-ethylhexyl cyclo-hexane-1,2-dicarboxylate, n-decyl 2-ethylhexyl cyclohexane-1,2-dicarboxylate, isodecyl 2-ethylhexyl cyclohexane-1,2-dicarboxylate, n-undecyl 2-ethylhexyl cyclohexane-1,2-dicarboxylate, isoundecyl 2-ethylhexyl cyclohexane-1,2-dicarboxylate, n-dodecyl 2-ethylhexyl cyclohexane-1,2-dicarboxylate, isododecyl 2-ethylhexyl cyclohexane-1,2-dicarboxylate, n-tridecyl 2-ethylhexyl cyclohexane-1,2-dicarboxylate, isotridecyl 2-ethylhexyl cyclohexane-1,2-dicarboxylate, isononyl n-nonyl cyclohexane-1,2-dicarboxylate, 2-propylheptyl n-nonyl cyclohexane-1,2-dicarboxylate, n-decyl n-nonyl cyclohexane-1,2-dicarboxylate, isodecyl n-nonyl cyclohexane-1,2-dicarboxylate, n-undecyl n-nonyl cyclohexane-1,2-dicarboxylate, isoundecyl n-nonyl cyclohexane-1,2-dicarboxylate, n-dodecyl n-nonyl cyclohexane-1,2-dicarboxylate, isododecyl n-nonyl cyclohexane-1,2-dicarboxylate, n-tridecyl n-nonyl cyclohexane-1,2-dicarboxylate, isotridecyl n-nonyl cyclohexane-1,2-dicarboxylate, 2-propylheptyl isononyl cyclohexane-1,2-dicarboxylate, n-decyl isononyl cyclohexane-1,2-dicarboxylate, isodecyl isononyl cyclohexane-1,2-dicarboxylate, n-undecyl isononyl cyclohexane-1,2-dicarboxylate, isoundecyl isononyl cyclohexane-1,2-dicarboxylate, n-dodecyl isononyl cyclohexane-1,2-dicarboxylate, isododecyl isononyl cyclohexane-1,2-dicarboxylate, n-tridecyl isononyl cyclohexane-1,2-dicarboxylate, isotridecyl iso-nonyl cyclohexane-1,2-dicarboxylate, n-decyl 2-propylheptyl cyclohexane-1,2-dicarboxylate, isodecyl 2-propylheptyl cyclohexane-1,2-dicarboxylate, n-undecyl 2-propylheptyl cyclohexane-1,2-dicarboxylate, isoundecyl 2-propylheptyl cyclohexane-1,2-dicarboxylate, n-dodecyl 2-propylheptyl cyclohexane-1,2-dicarboxylate, isododecyl 2-propylheptyl cyclohexane-1,2-dicarboxylate, n-tridecyl 2-propylheptyl cyclohexane-1,2-dicarboxylate, isotridecyl 2-propylheptyl cyclohexane-1,2-dicarboxylate, isodecyl n-decyl cyclohexane-1,2-dicarboxylate, n-undecyl n-decyl cyclohexane-1,2-dicarboxylate, isoundecyl n-decyl cyclohexane-1,2-dicarboxylate, n-dodecyl n-decyl cyclohexane-1,2-dicarboxylate, isododecyl n-decyl cyclohexane-1,2-dicarboxylate, n-tridecyl n-decyl cyclohexane-1,2-dicarboxylate, isotridecyl n-decyl cyclohexane-1,2-dicarboxlate, n-undecyl isodecyl cyclohexane-1,2-dicarboxylate, isoundecyl iso-decyl cyclohexane-1,2-dicarboxylate, n-dodecyl isodecyl cyclohexane-1,2-dicarboxylate, isododecyl isodecyl cyclohexane-1,2-dicarboxylate, n-tridecyl iso-decyl cyclohexane-1,2-dicarboxylate, isotridecyl isodecyl cyclohexane-1,2-dicarboxylate, isoundecyl n-undecyl cyclohexane-1,2-dicarboxylate, n-dodecyl n-undecyl cyclohexane-1,2-dicarboxylate, isododecyl n-undecyl cyclohexane-1,2-dicarboxylate, n-tridecyl n-undecyl cyclohexane-1,2-dicarboxylate, isotridecyl n-undecyl cyclohexane-1,2-dicarboxylate, n-dodecyl isoundecyl cyclohexane-1,2-dicarboxylate, isododecyl isoundecyl cyclohexane-1,2-dicarboxylate, n-tridecyl iso-undecyl cyclohexane-1,2-dicarboxylate, isotridecyl isoundecyl cyclohexane-1,2-dicarboxylate, isododecyl n-dodecyl cyclohexane-1,2-dicarboxylate, n-tridecyl n-dodecyl cyclohexane-1,2-dicarboxylate, isotridecyl n-dodecyl cyclohexane-n-tridecyl isododecyl cyclohexane-1,2-dicarboxylate, isotridecyl isododecyl cyclohexane-1,2-dicarboxylate, isotridecyl n-tridecyl cyclohexane-1,2-dicarboxylate, methyl cyclohexyl cyclohexane-1,2-dicarboxylate, ethyl cyclohexyl cyclohexane-1,2-dicarboxylate, n-propyl cyclohexyl cyclohexane-1,2-dicarboxylate, iso-propyl cyclohexyl cyclohexane-1,2-dicarboxylate, n-butyl cyclohexyl cyclohexane-1,2-dicarboxylate, tert-butyl cyclohexyl cyclohexane-1,2-dicarboxylate, isobutyl cyclo-hexyl cyclohexane-1,2-dicarboxylate, glycol cyclohexyl cyclohexane-1,2-dicarboxylate, n-hexyl cyclohexyl cyclohexane-1,2-dicarboxylate, isohexyl cyclohexyl cyclohexane-1,2-dicarboxylate, n-heptyl cyclohexyl cyclohexane-1,2-dicarboxylate, isoheptyl cyclo-hexyl cyclohexane-1,2-dicarboxylate, n-octyl cyclohexyl cyclohexan-1,2-dicarboxylate, isooctyl cyclohexyl cyclohexane-1,2-dicarboxylate, 2-ethylhexyl cyclohexyl cyclo-hexane-1,2-dicarboxylate, n-nonyl cyclohexyl cyclohexane-1,2-dicarboxylate, isononyl cyclohexyl cyclohexane-1,2-dicarboxylate, 2-propylheptyl cyclohexyl cyclohexane-1,2-dicarboxylate, n-decyl cyclohexyl cyclohexane-1,2-dicarboxylate, isodecyl cyclohexyl cyclohexane-1,2-dicarboxylate, n-undecyl cyclohexyl cyclohexane-1,2-dicarboxylate, isoundecyl cyclohexyl cyclohexane-1,2-dicarboxylate, n-dodecyl cyclohexyl cyclohexane-1,2-dicarboxylate, isododecyl cyclohexyl cyclohexane-1,2-dicarboxylate, n-triclecyl cyclohexyl cyclohexane-1,2-dicarboxylate, isotridecyl cyclohexyl cyclohexane-1,2-dicarboxylate, methyl isopentyl cyclohexane-1,2-dicarboxylate, ethyl isopentyl cyclohexane-1,2-dicarboxylate, n-propyl isopentyl cyclohexane-1,2-dicarboxylate, isopropyl isopentyl cyclohexane-1,2-dicarboxylate, n-butyl isopentyl cyclohexane-1,2-dicarboxylate, tert-butyl isopentyl cyclohexane-1,2-dicarboxylate, isobutyl isopentyl cyclohexane-1,2-dicarboxylate, glycol isopentyl cyclohexane-1,2-dicarboxylate, n-hexyl isopentyl cyclohexane-1,2-dicarboxylate, isohexyl isopentyl cyclohexane-1,2-dicarboxylate, n-heptyl isopentyl cyclohexane-1,2-dicarboxylate, isoheptyl isopentyl cyclohexane-1,2-dicarboxylate, n-octyl isopentyl cyclohexane-1,2-dicarboxylate, isooctyl isopentyl cyclohexane-1,2-dicarboxylate, 2-ethylhexyl isopentyl cyclohexane-1,2-dicarboxylate, n-nonyl isopentyl cyclohexane-1,2-dicarboxylate, isononyl isopentyl cyclohexane-1,2-dicarboxylate, 2-propylheptyl isopentyl cyclohexane-1,2-dicarboxylate, n-decyl isopentyl cyclohexane-1,2-dicarboxylate, isodecyl isopentyl cyclohexane-1,2-dicarboxylate, n-undecyl isopentyl cyclohexane-1,2-dicarboxylate, isoundecyl isopentyl cyclohexane-1,2-dicarboxylate, n-dodecyl isopentyl cyclohexane-1,2-dicarboxylate, isododecyl isopentyl cyclohexane-1,2-dicarboxylate, n-tridecyl isopentyl cyclohexane-1,2-dicarboxylate, isotridecyl iso-pentyl cyclohexane-1,2-dicarboxylate, methyl n-pentyl cyclohexane-1,2-dicarboxylate, ethyl n-pentyl cyclohexane-1,2-dicarboxylate, n-propyl n-pentyl cyclohexane-1,2-dicarboxylate, isopropyl n-pentyl cyclohexane-1,2-dicarboxylate, n-butyl n-pentyl cyclohexane-1,2-dicarboxylate, tert-butyl n-pentyl cyclohexane-1,2-dicarboxylate, iso-butyl n-pentyl cyclohexane-1,2-dicarboxylate, glycol n-pentyl cyclohexane-1,2-dicarboxylate, n-hexyl n-pentyl cyclohexane-1,2-dicarboxylate, isohexyl n-pentyl cyclohexane-1,2-dicarboxylate, n-heptyl n-pentyl cyclohexane-1,2-dicarboxylate, iso-heptyl n-pentyl cyclohexane-1,2-dicarboxylate, n-octyl n-pentyl cyclohexane-1,2-dicarboxylate, isooctyl n-pentyl cyclohexane-1,2-dicarboxylate, 2-ethylhexyl n-pentyl cyclohexane-1,2-dicarboxylate, n-nonyl n-pentyl cyclohexane-1,2-dicarboxylate, isononyl n-pentyl cyclohexane-1,2-dicarboxylate, 2-propylheptyl n-pentyl cyclohexane-1,2-dicarboxylate, n-decyl n-pentyl cyclohexane-1,2-dicarboxylate, isodecyl n-pentyl cyclohexane-1,2-dicarboxylate, n-undecyl n-pentyl cyclohexane-1,2-dicarboxylate, isoundecyl n-pentyl cyclohexane-1,2-dicarboxylate, n-dodecyl n-pentyl cyclohexane-1,2-dicarboxylate, isododecyl n-pentyl cyclohexane-1,2-dicarboxylate, n-tridecyl n-pentyl cyclohexane-1,2-dicarboxylate and isotridecyl n-pentyl cyclohexane-1,2-dicarboxylate;
mixed esters of cyclohexane-1,3-dicarboxylic acid with C1 to C13 alcohols, such as, for example, ethyl methyl cyclohexane-1,3-dicarboxylate, n-propyl methyl cyclohexane-1,3-dicarboxylate, isopropyl methyl cyclohexane-1,3-dicarboxylate, n-butyl methyl cyclohexane-1,3-dicarboxylate, tert-butyl methyl cyclohexane-1,3-dicarboxylate, iso-butyl methyl cyclohexane-1,3-dicarboxylate, glycol methyl cyclohexane-1,3-dicarboxylate, n-hexyl methyl cyclohexane-1,3-dicarboxylate, isohexyl methyl cyclohexane-1,3-dicarboxylate, n-heptyl methyl cyclohexane-1,3-dicarboxylate, iso-heptyl methyl cyclohexane-1,3-dicarboxylate, n-octyl methyl cyclohexane-1,3-dicarboxylate, isooctyl methyl cyclohexane-1,3-dicarboxylate, 2-ethylhexyl methyl cyclohexane-1,3-dicarboxylate, n-nonyl methyl cyclohexane-1,3-dicarboxylate, isononyl methyl cyclohexane-1,3-dicarboxylate, 2-propylheptyl methyl cyclohexane-1,3-dicarboxylate, n-decyl methyl cyclohexane-1,3-dicarboxylate, isodecyl methyl cyclohexane-1,3-dicarboxylate, n-undecyl methyl cyclohexane-1,3-dicarboxylate, iso-undecyl methyl cyclohexane-1,3-dicarboxylate, n-dodecyl methyl cyclohexane-1,3-dicarboxylate, isododecyl methyl cyclohexane-1,3-dicarboxylate, n-tridecyl methyl cyclohexane-1,3-dicarboxylate, isotridecyl methyl cyclohexane-1,3-dicarboxylate, n-propyl ethyl cyclohexane-1,3-dicarboxylate, isopropyl ethyl cyclohexane-1,3-dicarboxylate, n-butyl ethyl cyclohexane-1,3-dicarboxylate, tert-butyl ethyl cyclo-hexane-1,3-dicarboxylate, isobutyl ethyl cyclohexane-1,3-dicarboxylate, glycol ethyl cyclohexane-1,3-dicarboxylate, n-hexyl ethyl cyclohexane-1,3-dicarboxylate, isohexyl ethyl cyclohexane-1,3-dicarboxylate, n-heptyl ethyl cyclohexane-1,3-dicarboxylate, iso-heptyl ethyl cyclohexane-1,3-dicarboxylate, n-octyl ethyl cyclohexane-1,3-dicarboxylate, isooctyl ethyl cyclohexane-1,3-dicarboxylate, 2-ethylhexyl ethyl cyclohexane-1,3-dicarboxylate, n-nonyl ethyl cyclohexane-1,3-dicarboxylate, isononyl ethyl cyclohexane-1,3-dicarboxylate, 2-propylheptyl ethyl cyclohexane-1,3-dicarboxylate, n-decyl ethyl cyclohexane-1,3-dicarboxylate, isodecyl ethyl cyclo-hexane-1,3-dicarboxylate, n-undecyl ethyl cyclohexane-1,3-dicarboxylate, isoundecyl ethyl cyclohexane-1,3-dicarboxylate, n-dodecyl ethyl cyclohexane-1,3-dicarboxylate, isododecyl ethyl cyclohexane-1,3-dicarboxylate, n-tridecyl ethyl cyclohexane-1,3-dicarboxylate, isotridecyl ethyl cyclohexane-1,3-dicarboxylate, isopropyl n-propyl cyclohexane-1,3-dicarboxylate, n-butyl n-propyl cyclohexane-1,3-dicarboxylate, tert-butyl n-propyl cyclohexane-1,3-dicarboxylate, isobutyl n-propyl cyclohexane-1,3-dicarboxylate, glycol n-propyl cyclohexane-1,3-dicarboxylate, n-hexyl n-propyl cyclohexane-1,3-dicarboxylate, isohexyl n-propyl cyclohexane-1,3-dicarboxylate, n-heptyl n-propyl cyclohexane-1,3-dicarboxylate, isoheptyl n-propyl cyclohexane-1,3-dicarboxylate, n-octyl n-propyl cyclohexane-1,3-dicarboxylate, isooctyl n-propyl cyclohexane-1,3-dicarboxylate, 2-ethylhexyl n-propyl cyclohexane-1,3-dicarboxylate, n-nonyl n-propyl cyclohexane-1,3-dicarboxylate, isononyl n-propyl cyclohexane-1,3-dicarboxylate, 2-propylheptyl n-propyl cyclohexane-1,3-dicarboxylate, n-decyl n-propyl cyclohexane-1,3-dicarboxylate, isodecyl n-propyl cyclohexane-1,3-dicarboxylate, n-undecyl n-propyl cyclohexane-1,3-dicarboxylate, isoundecyl n-propyl cyclohexane-1,3-dicarboxylate, n-dodecyl n-propyl cyclohexane-1,3-dicarboxylate, isododecyl n-propyl cyclohexane-1,3-dicarboxylate, n-tridecyl n-propyl cyclohexane-1,3-dicarboxylate, isotridecyl n-propyl cyclohexane-1,3-dicarboxylate, n-butyl isopropyl cyclohexane-1,3-dicarboxylate, tert-butyl isopropyl cyclohexane-1,3-dicarboxylate, isobutyl isopropyl cyclohexane-1,3-dicarboxylate, glycol isopropyl cyclohexane-1,3-dicarboxylate, n-hexyl isopropyl cyclohexane-1,3-dicarboxylate, isohexyl isopropyl cyclohexane-1,3-dicarboxylate, n-heptyl isopropyl cyclohexane-1,3-dicarboxylate, isoheptyl isopropyl cyclohexane-1,3-dicarboxylate, n-octyl isopropyl cyclohexane-1,3-dicarboxylate, isooctyl isopropyl cyclohexane-1,3-dicarboxylate, 2-ethylhexyl isopropyl cyclohexane-1,3-dicarboxylate, n-nonyl iso-propyl cyclohexane-1,3-dicarboxylate, isononyl isopropyl cyclohexane-1,3-dicarboxylate, 2-propylheptyl isopropyl cyclohexane-1,3-dicarboxylate, n-decyl iso-propyl cyclohexane-1,3-dicarboxylate, isodecyl isopropyl cyclohexane-1,3-dicarboxylate, n-undecyl isopropyl cyclohexane-1,3-dicarboxylate, isoundecyl iso-propyl cyclohexane-1,3-dicarboxylate, n-dodecyl isopropyl cyclohexane-1,3-dicarboxylate, isododecyl isopropyl cyclohexane-1,3-dicarboxylate, n-tridecyl iso-propyl cyclohexane-1,3-dicarboxylate, isotridecyl isopropyl cyclohexane-1,3-dicarboxylate, tert-butyl n-butyl cyclohexane-1,3-dicarboxylate, isobutyl n-butyl cyclohexane-1,3-dicarboxylate, glycol n-butyl cyclohexane-1,3-dicarboxylate, n-hexyl n-butyl cyclohexane-1,3-dicarboxylate, isohexyl n-butyl cyclohexane-1,3-dicarboxylate, n-heptyl n-butyl cyclohexane-1,3-dicarboxylate, isoheptyl n-butyl cyclohexane-1,3-dicarboxylate, n-octyl n-butyl cyclohexane-1,3-dicarboxylate, isooctyl n-butyl cyclo-hexane-1,3-dicarboxylate, 2-ethylhexyl n-butyl cyclohexane-1,3-dicarboxylate, n-nonyl n-butyl cyclohexane-1,3-dicarboxylate, isononyl n-butyl cyclohexane-1,3-dicarboxylate, 2-propylheptyl n-butyl cyclohexane-1,3-dicarboxylate, n-decyl n-butyl cyclohexane-1,3-dicarboxylate, isodecyl n-butyl cyclohexane-1,3-dicarboxylate, n-undecyl n-butyl cyclohexane-1,3-dicarboxylate, isoundecyl, n-butyl cyclohexane-1,3-dicarboxylate, n-dodecyl n-butyl cyclohexane-1,3-dicarboxylate, isododecyl n-butyl cyclohexane-1,3-dicarboxylate, n-tridecyl n-butyl cyclohexane-1,3-dicarboxylate, isotridecyl n-butyl cyclohexane-1,3-dicarboxylate, isobutyl tert-butyl cyclohexane-1,3-dicarboxylate, glycol tert-butyl cyclohexane-1,3-dicarboxylate, n-hexyl tert-butyl cyclohexane-1,3-dicarboxylate, isohexyl tert-butyl cyclohexane-1,3-dicarboxylate, n-heptyl tert-butyl cyclohexane-1,3-dicarboxylate, isoheptyl tert-butyl cyclohexane-1,3-dicarboxylate, n-octyl tert-butyl cyclohexane-1,3-dicarboxylate, isooctyl tert-butyl cyclohexane-1,3-dicarboxylate, 2-ethylhexyl tert-butyl cyclohexane-1,3-dicarboxylate, n-nonyl tert-butyl cyclohexane-1,3-dicarboxylate, isononyl tert-butyl cyclohexane-1,3-dicarboxylate, 2-propylheptyl tert-butyl cyclohexane-1,3-dicarboxylate, n-decyl tert-butyl cyclohexane-1,3-dicarboxylate, isodecyl tert-butyl cyclohexane-1,3-dicarboxylate, n-undecyl tert-butyl cyclohexane-1,3-dicarboxylate, isoundecyl tert-butyl cyclohexane-1,3-dicarboxylate, n-dodecyl tert-butyl cyclohexane-1,3-dicarboxylate, isododecyl tert-butyl cyclohexane-1,3-dicarboxylate, n-tridecyl tert-butyl cyclohexane-1,3-dicarboxylate, isotridecyl tert-butyl cyclohexane-1,3-dicarboxylate, glycol isobutyl cyclohexane-1,3-dicarboxylate, n-hexyl isobutyl cyclohexane-1,3-dicarboxylate, iso-hexyl isobutyl cyclohexane-1,3-dicarboxylate, n-heptyl isobutyl cyclohexane-1,3-dicarboxylate, isoheptyl isobutyl cyclohexane-1,3-dicarboxylate, n-octyl isobutyl cyclohexane-1,3-dicarboxylate, isooctyl isobutyl cyclohexane-1,3-dicarboxylate, 2-ethylhexyl isobutyl cyclohexane-1,3-dicarboxylate, n-nonyl isobutyl cyclohexane-1,3-dicarboxylate, isononyl isobutyl cyclohexane-1,3-dicarboxylate, 2-propylheptyl iso-butyl cyclohexane-1,3-dicarboxylate, n-decyl isobutyl cyclohexane-1,3-dicarboxylate, isodecyl isobutyl cyclohexane-1,3-dicarboxylate, n-undecyl isobutyl cyclohexane-1,3-dicarboxylate, isoundecyl isobutyl cyclohexane-1,3-dicarboxylate, n-dodecyl iso-butyl cyclohexane-1,3-dicarboxylate, isododecyl isobutyl cyclohexane-1,3-dicarboxylate, n-tridecyl isobutyl cyclohexane-1,3-dicarboxylate, isotridecyl isobutyl cyclohexane-1,3-dicarboxylate, n-hexyl glycol cyclohexane-1,3-dicarboxylate, isohexyl glycol cyclohexane-1,3-dicarboxylate, n-heptyl glycol cyclohexane-1,3-dicarboxylate, isoheptyl glycol cyclohexane-1,3-dicarboxylate, n-octyl glycol cyclohexane-1,3-dicarboxylate, isooctyl glycol cyclohexane-1,3-dicarboxylate, 2-ethylhexyl glycol cyclohexane-1,3-dicarboxylate, n-nonyl glycol cyclohexane-1,3-dicarboxylate, isononyl glycol cyclohexane-1,3-dicarboxylate, 2-propylheptyl glycol cyclohexane-1,3-dicarboxylate, n-decyl glycol cyclohexane-1,3-dicarboxylate, isodecyl glycol cyclo-hexane-1,3-dicarboxylate, n-undecyl glycol cyclohexane-1,3-dicarboxylate, isoundecyl glycol cyclohexane-1,3-dicarboxylate, n-dodecyl glycol cyclohexane-1,3-dicarboxylate, isododecyl glycol cyclohexane-1,3-dicarboxylate, n-tridecyl glycol cyclohexane-1,3-dicarboxylate, isotridecyl glycol cyclohexane-1,3-dicarboxylate, isohexyl n-hexyl cyclohexane-1,3-dicarboxylate, n-heptyl n-hexyl cyclohexane-1,3-dicarboxylate, iso-heptyl n-hexyl cyclohexane-1,3-dicarboxylate, n-octyl n-hexyl cyclohexane-1,3-dicarboxylate, isooctyl n-hexyl cyclohexane-1,3-dicarboxylate, 2-ethylhexyl n-hexyl cyclohexane-1,3-dicarboxylate, n-nonyl n-hexyl cyclohexane-1,3-dicarboxylate, iso-nonyl n-hexyl cyclohexane-1,3-dicarboxylate, 2-propylheptyl n-hexyl cyclohexane-1,3-dicarboxylate, n-decyl n-hexyl cyclohexane-1,3-dicarboxylate, isodecyl n-hexyl cyclohexane-1,3-dicarboxylate, n-undecyl n-hexyl cyclohexane-1,3-dicarboxylate, iso-undecyl n-hexyl cyclohexane-1,3-dicarboxylate, n-dodecyl n-hexyl cyclohexane-1,3-dicarboxylate, isododecyl n-hexyl cyclohexane-1,3-dicarboxylate, n-tridecyl n-hexyl cyclohexane-1,3-dicarboxylate, isotridecyl n-hexyl cyclohexane-1,3-dicarboxylate, n-heptyl isohexyl cyclohexane-1,3-dicarboxylate, isoheptyl isohexyl cyclohexane-1,3-dicarboxylate, n-octyl isohexyl cyclohexane-1,3-dicarboxylate, isooctyl isohexyl cyclohexane-1,3-dicarboxylate, 2-ethylhexyl isohexyl cyclohexane-1,3-dicarboxylate, n-nonyl isohexyl cyclohexane-1,3-dicarboxylate, isononyl isohexyl cyclohexane-1,3-dicarboxylate, 2-propylheptyl isohexyl cyclohexane-1,3-dicarboxylate, n-decyl iso-hexyl cyclohexane-1,3-dicarboxylate, isodecyl isohexyl cyclohexane-1,3-dicarboxylate, n-undecyl isohexyl cyclohexane-1,3-dicarboxylate, isoundecyl isohexyl cyclohexane-1,3-dicarboxylate, n-dodecyl isohexyl cyclohexane-1,3-dicarboxylate, isododecyl iso-hexyl cyclohexane-1,3-dicarboxylate, n-tridecyl isohexyl cyclohexane-1,3-dicarboxylate, isotridecyl isohexyl cyclohexane-1,3-dicarboxylate, isoheptyl n-heptyl cyclohexane-1,3-dicarboxylate, n-octyl n-heptyl cyclohexane-1,3-dicarboxylate, isooctyl n-heptyl cyclohexane-1,3-dicarboxylate, 2-ethylhexyl n-heptyl cyclohexane-1,3-dicarboxylate, n-nonyl n-heptyl cyclohexane-1,3-dicarboxylate, isononyl n-heptyl cyclohexane-1,3-dicarboxylate, 2-propylheptyl n-heptyl cyclohexane-1,3-dicarboxylate, n-decyl n-heptyl cyclohexane-1,3-dicarboxylate, isodecyl n-heptyl cyclohexane-1,3-dicarboxylate, n-undecyl n-heptyl cyclohexane-1,3-dicarboxylate, isoundecyl n-heptyl cyclohexane-1,3-dicarboxylate, n-dodecyl n-heptyl cyclohexane-1,3-dicarboxylate, isododecyl n-heptyl cyclohexane-1,3-dicarboxylate, n-tridecyl n-heptyl cyclohexane-1,3-dicarboxylate, isotridecyl n-heptyl cyclohexane-1,3-dicarboxylate, n-octyl isoheptyl cyclohexane-1,3-dicarboxylate, isooctyl isoheptyl cyclohexane-1,3-dicarboxylate, 2-ethylhexyl isoheptyl cyclohexane-1,3-dicarboxylate, n-nonyl isoheptyl cyclohexane-1,3-dicarboxylate, isononyl isoheptyl cyclohexane-1,3-dicarboxylate, 2-propylheptyl isoheptyl cyclohexane-1,3-dicarboxylate, n-decyl iso-heptyl cyclohexane-1,3-dicarboxylate, isodecyl isoheptyl cyclohexane-1,3-dicarboxylate, n-undecyl isoheptyl cyclohexane-1,3-dicarboxylate, isoundecyl iso-heptyl cyclohexane-1,3-dicarboxylate, n-dodecyl isoheptyl cyclohexane-1,3-dicarboxylate, isododecyl isoheptyl cyclohexane-1,3-dicarboxylate, n-tridecyl iso-heptyl cyclohexane-1,3-dicarboxylate, isotridecyl isoheptyl cyclohexane-1,3-dicarboxylate, isooctyl n-octyl cyclohexane-1,3-dicarboxylate, 2-ethylhexyl n-octyl cyclohexane-1,3-dicarboxylate, n-nonyl n-octyl cyclohexane-1,3-dicarboxylate, isononyl n-octyl cyclohexane-1,3-dicarboxylate, 2-propylheptyl n-octyl cyclohexane-1,3-dicarboxylate, n-decyl n-octyl cyclohexane-1,3-dicarboxylate, isodecyl n-octyl cyclohexane-1,3-dicarboxylate, n-undecyl n-octyl cyclohexane-1,3-dicarboxylate, iso-undecyl n-octyl cyclohexane-1,3-dicarboxylate, n-dodecyl n-octyl cyclohexane-1,3-dicarboxylate, isododecyl n-octyl cyclohexane-1,3-dicarboxylate, n-tridecyl n-octyl cyclohexane-1,3-dicarboxylate, isotridecyl n-octyl cyclohexane-1,3-dicarboxylate, 2-ethylhexyl isooctyl cyclohexane-1,3-dicarboxylate, n-nonyl isooctyl cyclohexane-1,3-dicarboxylate, isononyl isooctyl cyclohexane-1,3-dicarboxylate, 2-propylheptyl iso-octyl cyclohexane-1,3-dicarboxylate, n-decyl isooctyl cyclohexane-1,3-dicarboxylate, isodecyl isooctyl cyclohexane-1,3-dicarboxylate, n-undecyl isooctyl cyclohexane-1,3-dicarboxylate, isoundecyl isooctyl cyclohexane-1,3-dicarboxylate, n-dodecyl iso-octyl cyclohexane-1,3-dicarboxylate, isododecyl isooctyl cyclohexane-1,3-dicarboxylate, n-tridecyl isooctyl cyclohexane-1,3-dicarboxylate, isotridecyl isooctyl cyclohexane-1,3-dicarboxylate, n-nonyl 2-ethylhexyl cyclohexane-1,3-dicarboxylate, isononyl 2-ethylhexyl cyclohexane-1,3-dicarboxylate, 2-propylheptyl 2-ethylhexyl cyclo-hexane-1,3-dicarboxylate, n-decyl 2-ethylhexyl cyclohexane-1,3-dicarboxylate, isodecyl 2-ethylhexyl cyclohexane-1,3-dicarboxylate, n-undecyl 2-ethylhexyl cyclohexane-1,3-dicarboxylate, isoundecyl 2-ethylhexyl cyclohexane-1,3-dicarboxylate, n-dodecyl 2-ethylhexyl cyclohexane-1,3-dicarboxylate, isododecyl 2-ethylhexyl cyclohexane-1,3-dicarboxylate, n-tridecyl 2-ethylhexyl cyclohexane-1,3-dicarboxylate, isotridecyl 2-ethylhexyl cyclohexane-1,3-dicarboxylate, isononyl n-nonyl cyclohexane-1,3-dicarboxylate, 2-propylheptyl n-nonyl cyclohexane-1,3-dicarboxylate, n-decyl n-nonyl cyclohexane-1,3-dicarboxylate, isodecyl n-nonyl cyclohexane-1,3-dicarboxylate, n-undecyl n-nonyl cyclohexane-1,3-dicarboxylate, isoundecyl n-nonyl cyclohexane-1,3-dicarboxylate, n-dodecyl n-nonyl cyclohexane-1,3-dicarboxylate, isododecyl n-nonyl cyclohexane-1,3-dicarboxylate, n-tridecyl n-nonyl cyclohexane-1,3-dicarboxylate, isotridecyl n-nonyl cyclohexane-1,3-dicarboxylate, 2-propylheptyl isononyl cyclohexane-1,3-dicarboxylate, n-decyl isononyl cyclohexane-1,3-dicarboxylate, isodecyl isononyl cyclohexane-1,3-dicarboxylate, n-undecyl isononyl cyclohexane-1,3-dicarboxylate, isoundecyl isononyl cyclohexane-1,3-dicarboxylate, n-dodecyl isononyl cyclohexane-1,3-dicarboxylate, isododecyl isononyl cyclohexane-1,3-dicarboxylate, n-tridecyl isononyl cyclohexane-1,3-dicarboxylate, isotridecyl iso-nonyl cyclohexane-1,3-dicarboxylate, n-decyl 2-propylheptyl cyclohexane 1,3-dicarboxylate, isodecyl 2-propylheptyl cyclohexane-1,3-dicarboxylate, n-undecyl 2-propylheptyl cyclohexane-1,3-dicarboxylate, isoundecyl 2-propylheptyl cyclohexane-1,3-dicarboxylate, n-dodecyl 2-propylheptyl cyclohexane-1,3-dicarboxylate, isododecyl 2-propylheptyl cyclohexane-1,3-dicarboxylate, n-tridecyl 2-propylheptyl cyclohexane-1,3-dicarboxylate, isotridecyl 2-propylheptyl cyclohexane-1,3-dicarboxylate, isodecyl n-decyl cyclohexane-1,3-dicarboxylate, n-undecyl n-decyl cyclohexane-1,3-dicarboxylate, isoundecyl n-decyl cyclohexane-1,3-dicarboxylate, n-dodecyl n-decyl cyclohexane-1,3-dicarboxylate, isododecyl n-decyl cyclohexane-1,3-dicarboxylate, n-tridecyl n-decyl cyclohexane-1,3-dicarboxylate, isotridecyl n-decyl cyclohexane-1,3-dicarboxylate, n-undecyl isodecyl cyclohexane-1,3-dicarboxylate, isoundecyl iso-decyl cyclohexane-1,3-dicarboxylate, n-dodecyl isodecyl cyclohexane-1,3-dicarboxylate, isododecyl isodecyl cyclohexane-1,3-dicarboxylate, n-tridecyl iso-decyl cyclohexane-1,3-dicarboxylate, isotridecyl isodecyl cyclohexane-1,3-dicarboxylate, isoundecyl n-undecyl cyclohexane-1,3-dicarboxylate, n-dodecyl n-undecyl cyclohexane-1,3-dicarboxylate, isododecyl n-undecyl cyclohexane-1,3-dicarboxylate, n-tridecyl n-undecyl cyclohexane-1,3-dicarboxylate, isotridecyl n-undecyl cyclohexane-1,3-dicarboxylate, n-dodecyl isoundecyl cyclohexane-1,3-dicarboxylate, isododecyl isoundecyl cyclohexane-1,3-dicarboxylate, n-tridecyl iso-undecyl cyclohexane-1,3-dicarboxylate, isotridecyl isoundecyl cyclohexane-1,3-dicarboxylate, isododecyl n-dodecyl cyclohexane-1,3-dicarboxylate, n-tridecyl n-dodecyl cyclohexane-1,3-dicarboxylate, isotridecyl n-dodecyl cyclohexane-1,3-dicarboxylate, n-tridecyl isododecyl cyclohexane-1,3-dicarboxylate, isotridecyl iso-dodecyl cyclohexane-1,3-dicarboxylate, isotridecyl n-tridecyl cyclohexane-1,3-dicarboxylate, methyl cyclohexyl cyclohexane-1,3-dicarboxylate, ethyl cyclohexyl cyclohexane-1,3-dicarboxylate, n-propyl cyclohexyl cyclohexane-1,3-dicarboxylate, isopropyl cyclohexyl cyclohexane-1,3-dicarboxylate, n-butyl cyclohexyl cyclohexane-1,3-dicarboxylate, tert-butyl cyclohexyl cyclohexane-1,3-dicarboxylate, isobutyl cyclo-hexyl cyclohexane-1,3-dicarboxylate, glycol cyclohexyl cyclohexane-1,3-dicarboxylate, n-hexyl cyclohexyl cyclohexane-1,3-dicarboxylate, isohexyl cyclohexyl cyclohexane-1,3-dicarboxylate, n-heptyl cyclohexyl cyclohexane-1,3-dicarboxylate, isoheptyl cyclo-hexyl cyclohexane-1,3-dicarboxylate, n-octyl cyclohexyl cyclohexan-1,3-dicarboxylate, isooctyl cyclohexyl cyclohexane-1,3-dicarboxylate, 2-ethylhexyl cyclohexyl cyclo-hexane-1,3-dicarboxylate, n-nonyl cyclohexyl cyclohexane-1,3-dicarboxylate, isononyl cyclohexyl cyclohexane-1,3-dicarboxylate, 2-propylheptyl cyclohexyl cyclohexane-1,3-dicarboxylate, n-decyl cyclohexyl cyclohexane-1,3-dicarboxylate, isodecyl cyclohexyl cyclohexane-1,3-dicarboxylate, n-undecyl cyclohexyl cyclohexane-1,3-dicarboxylate, isoundecyl cyclohexyl cyclohexane-1,3-dicarboxylate, n-dodecyl cyclohexyl cyclohexane-1,3-dicarboxylate, isododecyl cyclohexyl cyclohexane-1,3-dicarboxylate, n-tridecyl cyclohexyl cyclohexane-1,3-dicarboxylate, isotridecyl cyclohexyl cyclohexane-1,3-dicarboxylate, methyl isopentyl cyclohexane-1,3-dicarboxylate, ethyl isopentyl cyclohexane-1,3-dicarboxylate, n-propyl isopentyl cyclohexane-1,3-dicarboxylate, isopropyl isopentyl cyclohexane-1,3-dicarboxylate, n-butyl isopentyl cyclohexane-1,3-dicarboxylate, tert-butyl isopentyl cyclohexane-1,3-dicarboxylate, isobutyl isopentyl cyclohexane-1,3-dicarboxylate, glycol isopentyl cyclohexane-1,3-dicarboxylate, n-hexyl isopentyl cyclohexane-1,3-dicarboxylate, isohexyl isopentyl cyclohexane-1,3-dicarboxylate, n-heptyl isopentyl cyclohexane-1,3-dicarboxylate, isoheptyl isopentyl cyclohexane-1,3-dicarboxylate, n-octyl isopentyl cyclohexane-1,3-dicarboxylate, isooctyl isopentyl cyclohexane-1,3-dicarboxylate, 2-ethylhexyl isopentyl cyclohexane-1,3-dicarboxylate, n-nonyl isopentyl cyclohexane-1,3-dicarboxylate, isononyl isopentyl cyclohexane-1,3-dicarboxylate, 2-propylheptyl isopentyl cyclohexane-1,3-dicarboxylate, n-decyl isopentyl cyclohexane-1,3-dicarboxylate, isodecyl isopentyl cyclohexane-1,3-dicarboxylate, n-undecyl isopentyl cyclohexane-1,3-dicarboxylate, isoundecyl isopentyl cyclohexane-1,3-dicarboxylate, n-dodecyl isopentyl cyclohexane-1,3-dicarboxylate, isododecyl isopentyl cyclohexane-1,3-dicarboxylate, n-tridecyl isopentyl cyclohexane-1,3-dicarboxylate, isotridecyl iso-pentyl cyclohexane-1,3-dicarboxylate, methyl n-pentyl cyclohexane-1,3-dicarboxylate, ethyl n-pentyl cyclohexane-1,3-dicarboxylate, n-propyl n-pentyl cyclohexane-1,3-dicarboxylate, isopropyl n-pentyl cyclohexane-1,3-dicarboxylate, n-butyl n-pentyl cyclohexane-1,3-dicarboxylate, tert-butyl n-pentyl cyclohexane-1,3-dicarboxylate, iso-butyl n-pentyl cyclohexane-1,3-dicarboxylate, glycol n-pentyl cyclohexane-1,3-dicarboxylate, n-hexyl n-pentyl cyclohexane-1,3-dicarboxylate, isohexyl n-pentyl cyclohexane-1,3-dicarboxylate, n-heptyl n-pentyl cyclohexane-1,3-dicarboxylate, iso-heptyl-n-pentyl cyclohexane-1,3-dicarboxylate, n-octyl n-pentyl cyclohexane-1,3-dicarboxylate, isooctyl n-pentyl cyclohexane-1,3-dicarboxylate, 2-ethylhexyl n-pentyl cyclohexane-1,3-dicarboxylate, n-nonyl n-pentyl cyclohexane-1,3-dicarboxylate, isononyl n-pentyl cyclohexane-1,3-dicarboxylate, 2-propylheptyl n-pentyl cyclohexane-1,3-dicarboxylate, n-decyl n-pentyl cyclohexane-1,3-dicarboxylate, isodecyl n-pentyl cyclohexane-1,3-dicarboxylate, n-undecyl n-pentyl cyclohexane-1,3-dicarboxylate, isoundecyl n-pentyl cyclohexane-1,3-dicarboxylate, n-dodecyl n-pentyl cyclohexane-1,3-dicarboxylate, isododecyl n-pentyl cyclohexane-1,3-dicarboxylate, n-tridecyl n-pentyl cyclohexane-1,3-dicarboxylate and isotridecyl n-pentyl cyclohexane-1,3-dicarboxylate;
mixed esters of cyclohexane-1,4-dicarboxylic add with C1 to C13 alcohols, such as, for example, ethyl methyl cyclohexane-1,4-dicarboxylate, n-propyl methyl cyclohexane-1,4-dicarboxylate, isopropyl methyl cyclohexane-1,4-dicarboxylate, n-butyl methyl cyclohexane-1,4-dicarboxylate, tert-butyl methyl cyclohexane-1,4-dicarboxylate, iso-butyl methyl cyclohexane-1,4-dicarboxylate, glycol methyl cyclohexane-1,4-dicarboxylate, n-hexyl methyl cyclohexane-1,4-dicarboxylate, isohexyl methyl cyclohexane-1,4-dicarboxylate, n-heptyl methyl cyclohexane-1,4-dicarboxylate, iso-heptyl methyl cyclohexane-1,4-dicarboxylate, n-octyl methyl cyclohexane-1,4-dicarboxylate, isooctyl methyl cyclohexane-1,4-dicarboxylate, 2-ethylhexyl methyl cyclohexane-1,4-dicarboxylate, n-nonyl methyl cyclohexane-1,4-dicarboxylate, isononyl methyl cyclohexane-1,4-dicarboxylate, 2-propylheptyl methyl cyclohexane-1,4-dicarboxylate, n-decyl methyl cyclohexane-1,4-dicarboxylate, isodecyl methyl cyclohexane-1,4-dicarboxylate, n-undecyl methyl cyclohexane-1,4-dicarboxylate, iso-undecyl methyl cyclohexane-1,4-dicarboxylate, n-dodecyl methyl cyclohexane-1,4-dicarboxylate, isododecyl methyl cyclohexane-1,4-dicarboxylate, n-tridecyl methyl cyclohexane-1,4-dicarboxylate, isotridecyl methyl cyclohexane-1,4-dicarboxylate, n-propyl ethyl cyclohexane-1,4-dicarboxylate, isopropyl ethyl cyclohexane-1,4-dicarboxylate, n-butyl ethyl cyclohexane-1,4-dicarboxylate, tert-butyl ethyl cyclo-hexane-1,4-dicarboxylate, isobutyl ethyl cyclohexane-1,4-dicarboxylate, glycol ethyl cyclohexane-1,4-dicarboxylate, n-hexyl ethyl cyclohexane-1,4-dicarboxylate, isohexyl ethyl cyclohexane-1,4-dicarboxylate, n-heptyl ethyl cyclohexane-1,4-dicarboxylate, iso-heptyl ethyl cyclohexane-1,4-dicarboxylate, n-octyl ethyl cyclohexane-1,4-dicarboxylate, isooctyl ethyl cyclohexane-1,4-dicarboxylate, 2-ethylhexyl ethyl cyclohexane-1,4-dicarboxylate, n-nonyl ethyl cyclohexane-1,4-dicarboxylate, isononyl ethyl cyclohexane-1,4-dicarboxylate, 2-propylheptyl ethyl cyclohexane-1,4-dicarboxylate, n-decyl ethyl cyclohexane-1,4-dicarboxylate, isodecyl ethyl cyclo-hexane-1,4-dicarboxylate, n-undecyl ethyl cyclohexane-1,4-dicarboxylate, isoundecyl ethyl cyclohexane-1,4-dicarboxylate, n-dodecyl ethyl cyclohexane-1,4-dicarboxylate, isododecyl ethyl cyclohexane-1,4-dicarboxylate, n-tridecyl ethyl cyclohexane-1,4-dicarboxylate, isotridecyl ethyl cyclohexane-1,4-dicarboxylate, isopropyl n-propyl cyclohexane-1,4-dicarboxylate, n-butyl n-propyl cyclohexane-1,4-dicarboxylate, tert-butyl n-propyl cyclohexane-1,4-dicarboxylate, isobutyl n-propyl cyclohexane-1,4-dicarboxylate, glycol n-propyl cyclohexane-1,4-dicarboxylate, n-hexyl n-propyl cyclohexane-1,4-dicarboxylate, isohexyl n-propyl cyclohexane-1,4-dicarboxylate, n-heptyl n-propyl cyclohexane-1,4-dicarboxylate, isoheptyl n-propyl cyclohexane-1,4-dicarboxylate, n-octyl n-propyl cyclohexane-1,4-dicarboxylate, isooctyl n-propyl cyclohexane-1,4-dicarboxylate, 2-ethylhexyl n-propyl cyclohexane-1,4-dicarboxylate, n-nonyl n-propyl cyclohexane-1,4-dicarboxylate, isononyl n-propyl cyclohexane-1,4-dicarboxylate, 2-propylheptyl n-propyl cyclohexane-1,4-dicarboxylate, n-decyl n-propyl cyclohexane-1,4-dicarboxylate, isodecyl n-propyl cyclohexane-1,4-dicarboxylate, n-undecyl n-propyl cyclohexane-1,4-dicarboxylate, isoundecyl n-propyl cyclohexane-1,4-dicarboxylate, n-dodecyl n-propyl cyclohexane-1,4-dicarboxylate, isododecyl n-propyl cyclohexane-1,4-dicarboxylate, n-tridecyl n-propyl cyclohexane-1,4-dicarboxylate, isotridecyl n-propyl cyclohexane-1,4-dicarboxylate, n-butyl isopropyl cyclohexane-1,4-dicarboxylate, tert-butyl isopropyl cyclohexane-1,4-dicarboxylate, isobutyl isopropyl cyclohexane-1,4-dicarboxylate, glycol isopropyl cyclohexane-1,4-dicarboxylate, n-hexyl isopropyl cyclohexane-1,4-dicarboxylate, isohexyl isopropyl cyclohexane-1,4-dicarboxylate, n-heptyl isopropyl cyclohexane-1,4-dicarboxylate, isoheptyl isopropyl cyclohexane-1,4-dicarboxylate, n-octyl isopropyl cyclohexane-1,4-dicarboxylate, isooctyl isopropyl cyclohexane-1,4-dicarboxylate, 2-ethylhexyl isopropyl cyclohexane-1,4-dicarboxylate, n-nonyl iso-propyl cyclohexane-1,4-dicarboxylate, isononyl isopropyl cyclohexane-1,4-dicarboxylate, 2-propylheptyl isopropyl cyclohexane-1,4-dicarboxylate, n-decyl iso-propyl cyclohexane-1,4-dicarboxylate, isodecyl isopropyl cyclohexane-1,4-dicarboxylate, n-undecyl isopropyl cyclohexane-1,4-dicarboxylate, isoundecyl iso-propyl cyclohexane-1,4-dicarboxylate, n-dodecyl isopropyl cyclohexane-1,4-dicarboxylate, isododecyl isopropyl cyclohexane-1,4-dicarboxylate, n-tridecyl iso-propyl cyclohexane-1,4-dicarboxylate, isotridecyl isopropyl cyclohexane-1,4-dicarboxylate, tert-butyl n-butyl cyclohexane-1,4-dicarboxylate, isobutyl n-butyl cyclohexane-1,4-dicarboxylate, glycol n-butyl cyclohexane-1,4-dicarboxylate, n-hexyl n-butyl cyclohexane-1,4-dicarboxylate, isohexyl n-butyl cyclohexane-1,4-dicarboxylate, n-heptyl n-butyl cyclohexane-1,4-dicarboxylate, isoheptyl n-butyl cyclohexane-1,4-dicarboxylate, n-octyl n-butyl cyclohexane-1,4-dicarboxylate, isooctyl n-butyl cyclohexane-1,4-dicarboxylate, 2-ethylhexyl n-butyl cyclohexane-1,4-dicarboxylate, n-nonyl n-butyl cyclohexane-1,4-dicarboxylate, isononyl n-butyl cyclohexane-1,4-dicarboxylate, 2-propylheptyl n-butyl cyclohexane-1,4-dicarboxylate, n-decyl n-butyl cyclohexane-1,4-dicarboxylate, isodecyl n-butyl cyclohexane-1,4-dicarboxylate, n-undecyl n-butyl cyclohexane-1,4-dicarboxylate, isoundecyl n-butyl cyclohexane-1,4-dicarboxylate, n-dodecyl n-butyl cyclohexane-1,4-dicarboxylate, isododecyl n-butyl cyclohexane-1,4-dicarboxylate, n-tridecyl n-butyl cyclohexane-1,4-dicarboxylate, iso-tridecyl n-butyl cyclohexane-1,4-dicarboxylate, isobutyl tert-butyl cyclohexane-1,4-dicarboxylate, glycol tert-butyl cyclohexane-1,4-dicarboxylate, n-hexyl tert-butyl cyclohexane-1,4-dicarboxylate, isohexyl tert-butyl cyclohexane-1,4-dicarboxylate, n-heptyl tert-butyl cyclohexane-1,4-dicarboxylate, isoheptyl tert-butyl cyclohexane-1,4-dicarboxylate, n-octyl tert-butyl cyclohexane-1,4-dicarboxylate, isooctyl tert-butyl cyclohexane-1,4-dicarboxylate, 2-ethylhexyl tert-butyl cyclohexane-1,4-dicarboxylate, n-nonyl tert-butyl cyclohexane-1,4-dicarboxylate, isononyl tert-butyl cyclohexane-1,4-dicarboxylate, 2-propylheptyl tert-butyl cyclohexane-1,4-dicarboxylate, n-decyl tert-butyl cyclohexane-1,4-dicarboxylate, isodecyl tert-butyl cyclohexane-1,4-dicarboxylate, n-undecyl tert-butyl cyclohexane-1,4-dicarboxylate, isoundecyl tert-butyl cyclohexane-1,4-dicarboxylate, n-dodecyl tert-butyl cyclohexane-1,4-dicarboxylate, isododecyl tert-butyl cyclohexane-1,4-dicarboxylate, n-tridecyl tert-butyl cyclohexane-1,4-dicarboxylate, isotridecyl tert-butyl cyclohexane-1,4-dicarboxylate, glycol isobutyl cyclohexane-1,4-dicarboxylate, n-hexyl isobutyl cyclohexane-1,4-dicarboxylate, iso-hexyl isobutyl cyclohexane-1,4-dicarboxylate, n-heptyl isobutyl cyclohexane-1,4-dicarboxylate, isoheptyl isobutyl cyclohexane-1,4-dicarboxylate, n-octyl isobutyl cyclohexane-1,4-dicarboxylate, isooctyl isobutyl cyclohexane-1,4-dicarboxylate, 2-ethylhexyl isobutyl cyclohexane-1,4-dicarboxylate, n-nonyl isobutyl cyclohexane-1,4-dicarboxylate, isononyl isobutyl cyclohexane-1,4-dicarboxylate, 2-propylheptyl iso-butyl cyclohexane-1,4-dicarboxylate, n-decyl isobutyl cyclohexane-1,4-dicarboxylate, isodecyl isobutyl cyclohexane-1,4-dicarboxylate, n-undecyl isobutyl cyclohexane-1,4-dicarboxylate, isoundecyl isobutyl cyclohexane-1,4-dicarboxylate, n-dodecyl iso-butyl cyclohexane-1,4-dicarboxylate, isododecyl isobutyl cyclohexane-1,4-dicarboxylate, n-tridecyl isobutyl cyclohexane-1,4-dicarboxylate, isotridecyl isobutyl cyclohexane-1,4-dicarboxylate, n-hexyl glycol cyclohexane-1,4-dicarboxylate, isohexyl glycol cyclohexane-1,4-dicarboxylate, n-heptyl glycol cyclohexane-1,4-dicarboxylate, isoheptyl glycol cyclohexane-1,4-dicarboxylate, n-octyl glycol cyclohexane-1,4-dicarboxylate, isooctyl glycol cyclohexane-1,4-dicarboxylate, 2-ethylhexyl glycol cyclohexane-1,4-dicarboxylate, n-nonyl glycol cyclohexane-1,4-dicarboxylate, isononyl glycol cyclohexane-1,4-dicarboxylate, 2-propylheptyl glycol cyclohexane-1,4-dicarboxylate, n-decyl glycol cyclohexane-1,4-dicarboxylate, isodecyl glycol cyclo-hexane-1,4-dicarboxylate, n-undecyl glycol cyclohexane-1,4-dicarboxylate, isoundecyl glycol cyclohexane-1,4-dicarboxylate, n-dodecyl glycol cyclohexane-1,4-dicarboxylate, isododecyl glycol cyclohexane-1,4-dicarboxylate, n-tridecyl glycol cyclohexane-1,4-dicarboxylate, isotridecyl glycol cyclohexane-1,4-dicarboxylate, isohexyl n-hexyl cyclohexane-1,4-dicarboxylate, n-heptyl n-hexyl cyclohexane-1,4-dicarboxylate, iso-heptyl n-hexyl cyclohexane-1,4-dicarboxylate, n-octyl n-hexyl cyclohexane-1,4-dicarboxylate, isooctyl n-hexyl cyclohexane-1,4-dicarboxylate, 2-ethylhexyl n-hexyl cyclohexane-1,4-dicarboxylate, n-nonyl n-hexyl cyclohexane-1,4-dicarboxylate, iso-nonyl n-hexyl cyclohexane-1,4-dicarboxylate, 2-propylheptyl, n-hexyl cyclohexane-1,4-dicarboxylate, n-decyl n-hexyl cyclohexane-1,4-dicarboxylate, isodecyl n-hexyl cyclohexane-1,4-dicarboxylate, n-undecyl n-hexyl cyclohexane-1,4-dicarboxylate, iso-undecyl n-hexyl cyclohexane-1,4-dicarboxylate, n-dodecyl n-hexyl cyclohexane-1,4-dicarboxylate, isododecyl n-hexyl cyclohexane-1,4-dicarboxylate, n-tridecyl n-hexyl cyclohexane-1,4-dicarboxylate, isotridecyl n-hexyl cyclohexane-1,4-dicarboxylate, n-heptyl isohexyl cyclohexane-1,4-dicarboxylate, isoheptyl isohexyl cyclohexane-1,4-dicarboxylate, n-octyl isohexyl cyclohexane-1,4-dicarboxylate, isooctyl isohexyl cyclohexane-1,4-dicarboxylate, 2-ethylhexyl isohexyl cyclohexane-1,4-dicarboxylate, n-nonyl isohexyl cyclohexane-1,4-dicarboxylate, isononyl isohexyl cyclohexane-1,4-dicarboxylate, 2-propylheptyl isohexyl cyclohexane-1,4-dicarboxylate, n-decyl iso-hexyl cyclohexane-1,4-dicarboxylate, isodecyl isohexyl cyclohexane-1,4-dicarboxylate, n-undecyl isohexyl cyclohexane-1,4-dicarboxylate, isoundecyl isohexyl cyclohexane-1,4-dicarboxylate, n-dodecyl isohexyl cyclohexane-1,4-dicarboxylate, isododecyl iso-hexyl cyclohexane-1,4-dicarboxylate, n-tridecyl isohexyl cyclohexane-1,4-dicarboxylate, isotridecyl isohexyl cyclohexane-1,4-dicarboxylate, isoheptyl n-heptyl cyclohexane-1,4-dicarboxylate, n-octyl n-heptyl cyclohexane-1,4-dicarboxylate, isooctyl n-heptyl cyclohexane-1,4-dicarboxylate, 2-ethylhexyl n-heptyl cyclohexane-1,4-dicarboxylate, n-nonyl n-heptyl cyclohexane-1,4-dicarboxylate, isononyl n-heptyl cyclohexane-1,4-dicarboxylate, 2-propylheptyl n-heptyl cyclohexane-1,4-dicarboxylate, n-decyl n-heptyl cyclohexane-1,4-dicarboxylate, isodecyl n-heptyl cyclohexane-1,4-dicarboxylate, n-undecyl n-heptyl cyclohexane-1,4-dicarboxylate, isoundecyl n-heptyl cyclohexane-1,4-dicarboxylate, n-dodecyl n-heptyl cyclohexane-1,4-dicarboxylate, isododecyl n-heptyl cyclohexane-1,4-dicarboxylate, n-tridecyl n-heptyl cyclohexane-1,4-dicarboxylate, isotridecyl n-heptyl cyclohexane-1,4-dicarboxylate, n-octyl isoheptyl cyclohexane-1,4-dicarboxylate, isooctyl isoheptyl cyclohexane-1,4-dicarboxylate, 2-ethylhexyl isoheptyl cyclohexane-1,4-dicarboxylate, n-nonyl isoheptyl cyclohexane-1,4-dicarboxylate, isononyl isoheptyl cyclohexane-1,4-dicarboxylate, 2-propylheptyl isoheptyl cyclohexane-1,4-dicarboxylate, n-decyl iso-heptyl cyclohexane-1,4-dicarboxylate, isodecyl isoheptyl cyclohexane-1,4-dicarboxylate, n-undecyl isoheptyl cyclohexane-1,4-dicarboxylate, isoundecyl iso-heptyl cyclohexane-1,4-dicarboxylate, n-dodecyl isoheptyl cyclohexane-1,4-dicarboxylate, isododecyl isoheptyl cyclohexane-1,4-dicarboxylate, n-tridecyl iso-heptyl cyclohexane-1,4-dicarboxylate, isotridecyl isoheptyl cyclohexane 1,4-dicarboxylate, isooctyl n-octyl cyclohexane-1,4-dicarboxylate, 2-ethylhexyl n-octyl cyclohexane-1,4-dicarboxylate, n-nonyl n-octyl cyclohexane-1,4-dicarboxylate, isononyl n-octyl cyclohexane-1,4-dicarboxylate, 2-propylheptyl n-octyl cyclohexane-1,4-dicarboxylate, n-decyl n-octyl cyclohexane-1,4-dicarboxylate, isodecyl n-octyl cyclohexane-1,4-dicarboxylate, n-undecyl n-octyl cyclohexane-1,4-dicarboxylate, iso-undecyl n-octyl cyclohexane-1,4-dicarboxylate, n-dodecyl n-octyl cyclohexane-1,4-dicarboxylate, isododecyl n-octyl cyclohexane-1,4-dicarboxylate, n-tridecyl n-octyl cyclohexane-1,4-dicarboxylate, isotridecyl n-octyl cyclohexane-1,4-dicarboxylate, 2-ethylhexyl isooctyl cyclohexane-1,4-dicarboxylate, n-nonyl isooctyl cyclohexane-1,4-dicarboxylate, isononyl isooctyl cyclohexane-1,4-dicarboxylate, 2-propylheptyl iso-octyl cyclohexane-1,4-dicarboxylate, n-decyl isooctyl cyclohexane-1,4-dicarboxylate, isodecyl isooctyl cyclohexane-1,4-dicarboxylate, n-undecyl isooctyl cyclohexane-1,4-dicarboxylate, isoundecyl isooctyl cyclohexane-1,4-dicarboxylate, n-dodecyl iso-octyl cyclohexane-1,4-dicarboxylate, isododecyl isooctyl cyclohexane-1,4-dicarboxylate, n-tridecyl isooctyl cyclohexane-1,4-dicarboxlyate, isotridecyl isooctyl cyclohexane-1,4-dicarboxylate, n-nonyl 2-ethylhexyl cyclohexane-1,4-dicarboxylate, isononyl 2-ethylhexyl cyclohexane-1,4-dicarboxylate, 2-propylheptyl 2-ethylhexyl cyclo-hexane-1,4-dicarboxylate, n-decyl 2-ethylhexyl cyclohexane-1,4-dicarboxylate, isodecyl 2-ethylhexyl cyclohexane-1,4-dicarboxylate, n-undecyl 2-ethylhexyl cyclohexane-1,4-dicarboxylate, isoundecyl 2-ethylhexyl cyclohexane-1,4-dicarboxylate, n-dodecyl 2-ethylhexyl cyclohexane-1,4-dicarboxylate, isododecyl 2-ethylhexyl cyclohexane-1,4-dicarboxylate, n-tridecyl 2-ethylhexyl cyclohexane-1,4-dicarboxylate, isotridecyl 2-ethylhexyl cyclohexane-1,4-dicarboxylate, isononyl n-nonyl cyclohexane-1,4-dicarboxylate, 2-propylheptyl n-nonyl cyclohexane-1,4-dicarboxylate, n-decyl n-nonyl cyclohexane-1,4-dicarboxylate, isodecyl n-nonyl cyclohexane-1,4-dicarboxylate, n-undecyl n-nonyl cyclohexane-1,4-dicarboxylate, isoundecyl n-nonyl cyclohexane-1,4-dicarboxylate, n-dodecyl n-nonyl cyclohexane-1,4-dicarboxylate, isododecyl n-nonyl cyclohexane-1,4-dicarboxylate, n-tridecyl n-nonyl cyclohexane-1,4-dicarboxylate, isotridecyl n-nonyl cyclohexane-1,4-dicarboxylate, 2-propylheptyl isononyl cyclohexane-1,4-dicarboxylate, n-decyl isononyl cyclohexane-1,4-dicarboxylate, isodecyl isononyl cyclohexane-1,4-dicarboxylate, n-undecyl isononyl cyclohexane-1,4-dicarboxylate, isoundecyl isononyl cyclohexane-1,4-dicarboxylate, n-dodecyl isononyl cyclohexane-1,4-dicarboxylate, isododecyl isononyl cyclohexane-1,4-dicarboxylate, n-tridecyl isononyl cyclohexane-1,4-dicarboxylate, isotridecyl iso-nonyl cyclohexane-1,4-dicarboxylate, n-decyl 2-propylheptyl cyclohexane-1,4-dicarboxylate, isodecyl 2-propylheptyl cyclohexane-1,4-dicarboxylate, n-undecyl 2-propylheptyl cyclohexane-1,4-dicarboxylate, isoundecyl 2-propylheptyl cyclohexane-1,4-dicarboxylate, n-dodecyl 2-propylheptyl cyclohexane-1,4-dicarboxylate, isododecyl 2-propylheptyl cyclohexane-1,4-dicarboxylate, n-tridecyl 2-propylheptyl cyclohexane-1,4-dicarboxylate, isotridecyl 2-propylheptyl cyclohexane-1,4-dicarboxylate, isodecyl n-decyl cyclohexane-1,4-dicarboxylate, n-undecyl n-decyl cyclohexane-1,4-dicarboxylate, isoundecyl n-decyl cyclohexane-1,4-dicarboxylate, n-dodecyl n-decyl cyclohexane-1,4-dicarboxylate, isododecyl n-decyl cyclohexane-1,4-dicarboxylate, n-tridecyl n-decyl cyclohexane-1,4-dicarboxylate, isotridecyl n-decyl cyclohexane-1,4-dicarboxlate, n-undecyl isodecyl cyclohexane-1,4-dicarboxylate, isoundecyl iso-decyl cyclohexane-1,4-dicarboxylate, n-dodecyl isodecyl cyclohexane-1,4-dicarboxylate, isododecyl isodecyl cyclohexane-1,4-dicarboxylate, n-tridecyl iso-decyl cyclohexane-1,4-dicarboxylate, isotridecyl isodecyl cyclohexane-1,4-dicarboxylate, isoundecyl n-undecyl cyclohexane-1,4-dicarboxylate, n-dodecyl n-undecyl cyclohexane-1,4-dicarboxylate, isododecyl n-undecyl cyclohexane-1,4-dicarboxylate, n-tridecyl n-undecyl cyclohexane-1,4-dicarboxylate, isotridecyl n-undecyl cyclohexane-1,4-dicarboxylate, n-dodecyl isoundecyl cyclohexane-1,4-dicarboxylate, isododecyl isoundecyl cyclohexane-1,4-dicarboxylate, n-tridecyl iso-undecyl cyclohexane-1,4-dicarboxylate, isotridecyl isoundecyl cyclohexane-1,4-dicarboxylate, isododecyl n-dodecyl cyclohexane-1,4-dicarboxylate, n-tridecyl n-dodecyl cyclohexane-1,4-dicarboxylate, isotridecyl n-dodecyl cyclohexane-1,4-dicarboxylate, n-tridecyl isododecyl cyclohexane-1,4-dicarboxylate, isotridecyl iso-dodecyl cyclohexane-1,4-dicarboxylate, isotridecyl n-tridecyl cyclohexane-1,4-dicarboxylate, methyl cyclohexyl cyclohexane-1,4-dicarboxylate, ethyl cyclohexyl cyclohexane-1,4-dicarboxylate, n-propyl cyclohexyl cyclohexane-1,4-dicarboxylate, iso-propyl cyclohexyl cyclohexane-1,4-dicarboxylate, n-butyl cyclohexyl cyclohexane-1,4-dicarboxylate, tert-butyl cyclohexyl cyclohexane-1,4-dicarboxylate, isobutyl cyclo-hexyl cyclohexane-1,4-dicarboxylate, glycol cyclohexyl cyclohexane-1,4-dicarboxylate, n-hexyl cyclohexyl cyclohexane-1,4-dicarboxylate, isohexyl cyclohexyl cyclohexane-1,4-dicarboxylate, n-heptyl cyclohexyl cyclohexane-1,4-dicarboxylate, isoheptyl cyclo-hexyl cyclohexane-1,4-dicarboxylate, n-octyl cyclohexyl cyclohexane-1,4-dicarboxylate, isooctyl cyclohexyl cyclohexane-1,4-dicarboxylate, 2-ethylhexyl cyclohexyl cyclo-hexane-1,4-dicarboxylate, n-nonyl cyclohexyl cyclohexane-1,4-dicarboxylate, isononyl cyclohexyl cyclohexane-1,4-dicarboxylate, 2-propylheptyl cyclohexyl cyclohexane-1,4-dicarboxylate, n-decyl cyclohexyl cyclohexane-1,4-dicarboxylate, isodecyl cyclohexyl cyclohexane-1,4-dicarboxylate, n-undecyl cyclohexyl cyclohexane-1,4-dicarboxylate, isoundecyl cyclohexyl cyclohexane-1,4-dicarboxylate, n-dodecyl cyclohexyl cyclohexane-1,4-dicarboxylate, isododecyl cyclohexyl cyclohexane-1,4-dicarboxylate, n-tridecyl cyclohexyl cyclohexane-1,4-dicarboxylate, isotridecyl cyclohexyl cyclohexane-1,4-dicarboxylate, methyl isopentyl cyclohexane-1,4-dicarboxylate, ethyl isopentyl cyclohexane-1,4-dicarboxylate, n-propyl isopentyl cyclohexane-1,4-dicarboxylate, isopropyl isopentyl cyclohexane-1,4-dicarboxylate, n-butyl isopentyl cyclohexane-1,4-dicarboxylate, tert-butyl isopentyl cyclohexane-1,4-dicarboxylate, isobutyl isopentyl cyclohexane-1,4-dicarboxylate, glycol isopentyl cyclohexane-1,4-dicarboxylate, n-hexyl isopentyl cyclohexane-1,4-dicarboxylate, isohexyl isopentyl cyclohexane-1,4-dicarboxylate, n-heptyl isopentyl cyclohexane-1,4-dicarboxylate, isoheptyl isopentyl cyclohexane-1,4-dicarboxylate, n-octyl isopentyl cyclohexane-1,4-dicarboxylate, isooctyl isopentyl cyclohexane-1,4-dicarboxylate, 2-ethylhexyl isopentyl cyclohexane-1,4-dicarboxylate, n-nonyl isopentyl cyclohexane-1,4-dicarboxylate, isononyl isopentyl cyclohexane-1,4-dicarboxylate, 2-propylheptyl isopentyl cyclohexane-1,4-dicarboxylate, n-decyl isopentyl cyclohexane-1,4-dicarboxylate, isodecyl isopentyl cyclohexane-1,4-dicarboxylate, n-undecyl isopentyl cyclohexane-1,4-dicarboxylate, isoundecyl isopentyl cyclohexane-1,4-dicarboxylate, n-dodecyl isopentyl cyclohexane-1,4-dicarboxylate, isododecyl isopentyl cyclohexane-1,4-dicarboxylate, n-tridecyl isopentyl cyclohexane-1,4-dicarboxylate, isotridecyl iso-pentyl cyclohexane-1,4-dicarboxylate, methyl n-pentyl cyclohexane-1,4-dicarboxylate, ethyl n-pentyl cyclohexane-1,4-dicarboxylate, n-propyl n-pentyl cyclohexane-1,4-dicarboxylate, isopropyl n-pentyl cyclohexane-1,4-dicarboxylate, n-butyl n-pentyl cyclohexane-1,4-dicarboxylate, tert-butyl n-pentyl cyclohexane-1,4-dicarboxylate, iso-butyl n-pentyl cyclohexane-1,4-dicarboxylate, glycol n-pentyl cyclohexane-1,4-dicarboxylate, n-hexyl n-pentyl cyclohexane-1,4-dicarboxylate, isohexyl n-pentyl cyclohexane-1,4-dicarboxylate, n-heptyl n-pentyl cyclohexane-1,4-dicarboxylate, iso-heptyl n-pentyl cyclohexane-1,4-dicarboxylate, n-octyl n-pentyl cyclohexane-1,4-dicarboxylate, isooctyl n-pentyl cyclohexane-1,4-dicarboxylate, 2-ethylhexyl n-pentyl cyclohexane-1,4-dicarboxylate, n-nonyl n-pentyl cyclohexane-1,4-dicarboxylate, isononyl n-pentyl cyclohexane-1,4-dicarboxylate, 2-propylheptyl n-pentylcyclohexane-1,4-dicarboxylate, n-decyl n-pentyl cyclohexane-1,4-dicarboxylate, isodecyl n-pentyl cyclohexane-1,4-dicarboxylate, n-undecyl n-pentyl cyclohexane-1,4-dicarboxylate, isoundecyl n-pentyl cyclohexane-1,4-dicarboxylate, n-dodecyl n-pentyl cyclohexane-1,4-dicarboxylate, isododecyl n-pentyl cyclohexane-1,4-dicarboxylate, n-tridecyl n-pentyl cyclohexane-1,4-dicarboxylate and isotridecyl n-pentyl cyclohexane-1,4-dicarboxylate;
cyclohexane-1,3-dicarboxylic acid alkyl esters, such as, for example, monomethyl cyclohexane-1,3-dicarboxylate, dimethyl cyclohexane-1,3-dicarboxylate, diethyl cyclo-hexane-1,3-dicarboxylate, di-n-propyl cyclohexane-1,3-dicarboxylate, di-n-butyl cyclo-hexane-1,3-dicarboxylate, di-tert-butyl cyclohexane-1,3-dicarboxylate, diisobutyl cyclo-hexane-1,3-dicarboxylate, monoglycol cyclohexane-1,3-dicarboxylate, diglycol cyclo-hexane-1,3-dicarboxylate, di-n-octyl cyclohexane-1,3-dicarboxylate, diisooctyl cyclo-hexane-1,3-dicarboxylate, di-2-ethylhexyl cyclohexane-1,3-dicarboxylate, di-n-nonyl cyclohexane-1,3-dicarboxylate, diisononyl cyclohexane-1,3-dicarboxylate, di-n-decyl cyclohexane-1,3-dicarboxylate, diisodecyl cyclohexane-1,3-dicarboxylate, di-n-undecyl cyclohexane-1,3-dicarboxylate, diisododecyl cyclohexane-1,3-dicarboxylate, di-n-octadecyl cyclohexane-1,3-dicarboxylate, diisooctadecyl cyclohexane-1,3-dicarboxylate, di-n-eicosyl cyclohexane-1,3-dicarboxylate, monocyclohexyl cyclohexane-1,3-dicarboxylate and dicyclohexyl cyclohexane-1,3-dicarboxylate;
diisopropyl cyclohexane-1,3-dicarboxylate, di-n-hexyl cyclohexane-1,3-dicarboxylate, diisohexyl cyclohexane-1,3-dicarboxylate, di-n-heptyl cyclohexane-1,3-dicarboxylate, diisoheptyl cyclohexane-1,3-dicarboxylate, di-2-propylheptyl cyclohexane-1,3-dicarboxylate, diisoundecyl cyclohexane-1,3-dicarboxylate, di-n-dodecyl cyclo-hexane-1,3-dicarboxylate, di-n-tridecyl cyclohexane-1,2-dicarboxylate, diisotridecyl cyclohexane-1,3-dicarboxylate, di-n-pentyl cyclohexane-1,3-dicarboxylate and diiso-pentyl cyclohexane-1,3-dicarboxylate;
cyclohexane-1,2,4-tricarboxylic acid alkyl esters, such as, for example, monomethyl cyclohexane-1,2,4-tricarboxylate, dimethyl cyclohexane-1,2,4-tricarboxylate, diethyl cyclohexane-1,2,4-tricarboxylate, di-n-propyl cyclohexane-1,2,4-tricarboxylate, diiso-propyl cyclohexane-1,2,4-tricarboxylate, di-n-butyl cyclohexane-1,2,4-triicarboxylate, di-tert-butyl cyclohexane-1,2,4-tricarboxylate, diisobutyl cyclohexane-1,2,4-tri-carboxylate, monoglycol cyclohexane-1,2,4-tricarboxylate, diglycol cyclohexane-1,2,4-tricarboxylate, di-n-octyl cyclohexane-1,2,4-tricarboxylate, diisooctyl cyclohexane-1,2,4-tricarboxylate, di-2-ethylhexyl cyclohexane-1,2,4-tricarboxylate, di-n-nonyl cyclo-hexane-1,2,4-tricarboxylate, diisononyl cyclohexane-1,2,4-tricarboxylate, di-n-decyl cyclohexane-1,2,4-tricarboxylate, diisodecyl cyclohexane-1,2,4-tricarboxylate, di-n-undecyl cyclohexane-1,2,4-tricarboxylate, diisododecyl cyclohexane-1,2,4-tri-carboxylate, di-n-octadecyl cyclohexane-1,2,4-tricarboxylate, diisooctadecyl cyclo-hexane-1,2,4-tricarboxylate, di-n-eicosyl cyclohexane-1,2,4-tricarboxylate, monocyclo-hexyl cyclohexane-1,2,4-tricarboxylate, dicyclohexyl cyclohexane-1,2,4-tricarboxylate, and also trimethyl cyclohexane-1,2,4-tricarboxylate, triethyl cyclohexane-1,2,4-tri-carboxylate, tri-n-propyl cyclohexane-1,2,4-tricarboxylate, tri-n-butyl cyclohexane-1,2,4-tricarboxylate, tri-tert-butyl cyclohexane-1,2,4-tricarboxylate, triisobutyl cyclo-hexane-1,2,4-tricarboxylate, triglycol cyclohexane-1,2,4-tricarboxylate, tri-n-octyl cyclo-hexane-1,2,4-tricarboxylate, triisooctyl cyclohexane-1,2,4-tricarboxylate, tri-2-ethylhexyl cyclohexane-1,2,4-tricarboxylate, tri-n-nonyl cyclohexane-1,2,4-tricarboxylate, triisononyl cyclohexane-1,2,4-tricarboxylate, tri-n-decyl cyclohexane-1,2,4-tricarboxylate, triisododecyl cyclohexane-1,2,4-tricarboxylate, tri-n-undecyl cyclohexane-1,2,4-tri-carboxylate, triisododecyl cyclohexane-1,2,4-tricarboxylate, tri-n-octadecyl cyclo-hexane-1,2,4-tricarboxylate, triisooctadecyl cyclohexane-1,2,4-tricarboxylate, tri-n-eicosyl cyclohexane-1,2,4-tricarboxylate, tricyclohexyl cyclohexane-1,2,4-tri-carboxylate, di-n-hexyl cyclohexane-1,2,4-tricarboxylate, diisohexyl cyclohexane-1,2,4-tricarboxylate, tri-n-hexyl cyclohexane-1,2,4-tricarboxylate, triisohexyl cyclo-hexane-1,2,4-tricarboxylate, di-n-heptyl cyclohexane-1,2,4-tricarboxylate, diisoheptyl cyclohexane-1,2,4-tricarboxylate, tri-n-heptyl cyclohexane-1,2,4-tricarboxylate, triiso-heptyl cyclohexane-1,2,4-tricarboxylate, di-n-pentyl cyclohexane-1,2,4-tricarboxylate, diisopentyl cyclohexane-1,2,4-tricarboxylate, tri-n-pentyl cyclohexane-1,2,4-tri-carboxylate, triisopentyl cyclohexane-1,2,4-tricarboxylate, di-n-tridecyl cyclohexane-1,2,4-tricarboxylate, diisotridecyl cyclohexane-1,2,4-tricarboxylate, tri-n-tridecyl cyclo-hexane-1,2,4-tricarboxylate, triisotridecyl cyclohexane-1,2,4-tricarboxylate, di-n-dodecyl cyclohexane-1,2,4-tricarboxylate, diisoundecyl cyclohexane-1,2,4-tricarboxylate, tri-n-dodecyl cyclohexane-1,2,4-tricarboxylate, triisoundecyl cyclohexane-1,2,4-tri-carboxylate and triisopropyl cyclohexane-1,2,4-tricarboxylate.

Cyclohexane-1,3,5-tricarboxylic acid alkyl esters, such as, for example, monomethyl cyclohexane-1,3,5-tricarboxylate, dimethyl cyclohexane-1,3,5-tricarboxylate, diethyl cyclohexane-1,3,5-tricarboxylate, di-n-propyl cyclohexane-1,3,5-tricarboxylate, di-n-butyl cyclohexane-1,3,5-triicarboxylate, di-tert-butyl cyclohexane-1,3,5-tricarboxylate, diisobutyl cyclohexane-1,3,5-tricarboxylate, monoglycol cyclohexane-1,3,5-tri-carboxylate, diglycol cyclohexane-1,3,5-tricarboxylate, di-n-octyl cyclohexane-1,3,5-tri-carboxylate, diisooctyl cyclohexane-1,3,5-tricarboxylate, di-2-ethylhexyl cyclohexane-1,3,5-tricarboxylate, di-n-nonyl cyclohexane-1,3,5-tricarboxylate, diisononyl cyclo-hexane-1,3,5-tricarboxylate, di-n-decyl cyclohexane-1,3,5-tricarboxylate, diisodecyl cyclohexane-1,3,5-tricarboxylate, di-n-undecyl cyclohexane-1,3,5-tricarboxylate, diiso-dodecyl cyclohexane-1,3,5-tricarboxylate, di-n-octadecyl cyclohexane-1,3,5-tri-carboxylate, diisooctadecyl cyclohexane-1,3,5-tricarboxylate, di-n-eicosyl cyclohexane-1,3,5-tricarboxylate, monocyclohexyl cyclohexane-1,3,5-tricarboxylate, dicyclohexyl cyclohexane-1,3,5-tricarboxylate, and also trimethyl cyclohexane-1,3,5-tricarboxylate, triethyl cyclohexane-1,3,5-tricarboxylate, tri-n-propyl cyclohexane-1,3,5-tricarboxylate, tri-n-butyl cyclohexane-1,3,5-tricarboxyalte, tri-tert-butyl cyclohexane-1,3,5-tri-carboxylate, triisobutyl cyclohexane-1,3,5-tricarboxylate, triglycol cyclohexane-1,3,5-tri-carboxylate, tri-n-octyl cyclohexane-1,3,5-tricarboxylate, triisooctyl cyclohexane-1,3,5-tricarboxylate, tri-2-ethylhexyl cyclohexane-1,3,5-tricarboxylate, tri-n-nonyl cyclo-hexane-1,3,5-tricarboxylate, triisononyl cyclohexane-1,3,5-tricarboxylate, tri-n-decyl cyclohexane-1,3,5-tricarboxylate, triisododecyl cyclohexane-1,3,5-tricarboxylate, tri-n-undecyl cyclohexane-1,3,5-tricarboxylate, triisododecyl cyclohexane-1,3,5-tri-carboxylate, tri-n-octadecyl cyclohexane-1,3,5-tricarboxylate, triisooctadecyl cyclo-hexane-1,3,5-tricarboxylate, tri-n-eicosyl cyclohexane-1,3,5-tricarboxylate, tricyclohexyl cyclohexane-1,3,5-tricarboxylate, di-n-hexyl cyclohexane-1,3,5-tricarboxylate, diiso-hexyl cyclohexane-1,3,5-tricarboxylate, tri-n-hexyl cyclohexane-1,3,5-tricarboxylate, triisohexyl cyclohexane-1,3,5-tricarboxylate, di-n-heptyl cyclohexane-1,3,5-tri-carboxylate, diisoheptyl cyclohexane-1,3,5-tricarboxylate, tri-n-heptyl cyclohexane-1,3,5-tricarboxylate, triisoheptyl cyclohexane-1,3,5-tricarboxylate, di-n-pentyl cyclo-hexane-1,3,5-tricarboxylate, diisopentyl cyclohexane-1,3,5-tricarboxylate, tri-n-pentyl cyclohexane-1,3,5-tricarboxylate, trilsopentyl cyclohexane-1,3,5-tricarboxylate, di-n-tridecyl cyclohexane-1,3,5-tricarboxylate, diisotridecyl cyclohexane-1,3,5-tricarboxylate, tri-n-tridecyl cyclohexane-1,3,5-tricarboxylate, triisotridecyl cyclohexane-1,3,5-tri-carboxylate, di-n-dodecyl cyclohexane-1,3,5-tricarboxylate, diisoundecyl cyclohexane-1,3,5-tricarboxylate, tri-n-dodecyl cyclohexane-1,3,5-tricarboxylate, triisoundecyl cyclo-hexane-1,3,5-tricarboxylate and triisopropyl cyclohexane-1,3,5-tricarboxylate.

Cyclohexane-1,2,3-tricarboxylic acid alkyl esters, such as, for example, monomethyl cyclohexane-1,2,3-tricarboxylate, dimethyl cyclohexane-1,2,3-tricarboxylate, diethyl cyclohexane-1,2,3-tricarboxylate, di-n-propyl cyclohexane-1,2,3-tricarboxylate, di-n-butyl cyclohexane-1,2,3-triicarboxylate, di-tert-butyl cyclohexane-1,2,3-tricarboxylate, diisobutyl cyclohexane-1,2,3-tricarboxylate, monoglycol cyclohexane-1,2,3-tri-carboxylate, diglycol cyclohexane-1,2,3-tricarboxylate, di-n-octyl cyclohexane-1,2,3-tri-carboxylate, diisooctyl cyclohexane-1,2,3-tricarboxylate, di-2-ethylhexyl cyclohexane-1,2,3-tricarboxylate, di-n-nonyl cyclohexane-1,2,3-tricarboxylate, diisononyl cyclo-hexane-1,2,3-tricarboxylate, di-n-decyl cyclohexane-1,2,3-tricarboxylate, diisodecyl cyclohexane-1,2,3-tricarboxylate, di-n-undecyl cyclohexane-1,2,3-tricarboxylate, diiso-dodecyl cyclohexane-1,2,3-tricarboxylate, di-n-octadecyl cyclohexane-1,2,3-tri-carboxylate, diisooctadecyl cyclohexane-1,2,3-tricarboxylate, di-n-eicosyl cyclohexane-1,2,3-tricarboxylate, monocyclohexyl cyclohexane-1,2,3-tricarboxylate, dicyclohexyl cyclohexane-1,2,3-tricarboxylate, and also trimethyl cyclohexane-1,2,3-tricarboxylate, triethyl cyclohexane-1,2,3-tricarboxylate, tri-n-propyl cyclohexane-1,2,3-tricarboxylate, tri-n-butyl cyclohexane-1,2,3-tricarboxyalte, tri-tert-butyl cyclohexane-1,2,3-tri-carboxylate, triisobutyl cyclohexane-1,2,3-tricarboxylate, triglycol cyclohexane-1,2,3-tri-carboxylate, tri-n-octyl cyclohexane-1,2,3-tricarboxylate, triisooctyl cyclohexane-1,2,3-tricarboxylate, tri-2-ethylhexyl cyclohexane-1,2,3-tricarboxylate, tri-n-nonyl cyclo-hexane-1,2,3-tricarboxylate, triisononyl cyclohexane-1,2,3-tricarboxylate, tri-n-decyl cyclohexane-1,2,3-tricarboxylate, triisododecyl cyclohexane-1,2,3-tricarboxylate, tri-n-undecyl cyclohexane-1,2,3-tricarboxylate, triisododecyl cyclohexane-1,2,3-tri-carboxylate, tri-n-octadecyl cyclohexane-1,2,3-tricarboxylate, triisooctadecyl cyclo-hexane-1,2,3-tricarboxylate, tri-n-eicosyl cyclohexane-1,2,3-tricarboxylate, tricyclohexyl cyclohexane-1,2,3-tricarboxylate, di-n-hexyl cyclohexane-1,2,3-tricarboxylate, diiso-hexyl cyclohexane-1,2,3-tricarboxylate, tri-n-hexyl cyclohexane-1,2,3-tricarboxylate, triisohexyl cyclohexane-1,2,3-tricarboxylate, di-n-heptyl cyclohexane-1,2,3-tri-diisoheptyl cyclohexane-1,2,3-tricarboxylate, tri-n-heptyl cyclohexane-1,2,3-tricarboxylate, triisoheptyl cyclohexane-1,2,3-tricarboxylate, di-n-pentyl cyclo-hexane-1,2,3-tricarboxylate, diisopentyl cyclohexane-1,2,3-tricarboxylate, tri-n-pentyl cyclohexane-1,2,3-tricarboxylate, triisopentyl cyclohexane-1,2,3-tricarboxylate, di-n-tridecyl cyclohexane-1,2,3-tricarboxylate, diisotridecyl cyclohexane-1,2,3-tricarboxylate, tri-n-tridecyl cyclohexane-1,2,3-tricarboxylate, triisotridecyl cyclohexane-1,2,3-tri-carboxylate, di-n-dodecyl cyclohexane-1,2,3-tricarboxylate, diisoundecyl cyclohexane-1,2,3-tricarboxylate, tri-n-dodecyl cyclohexane-1,2,3-tricarboxylate, triisoundecyl cyclo-hexane-1,2,3-tricarboxylate and triisopropyl cyclohexane-1,2,3-tricarboxylate.

Cyclohexane-1,2,4,5-tetracarboxylic acid alkyl esters, such as, for example, mono-methyl cyclohexane-1,2,4,5-tetracarboxylate, dimethyl cyclohexane-1,2,4,5-tetra-carboxylate, diethyl cyclohexane-1,2,4,5-tetracarboxylate, di-n-propyl cyclohexane-1,2,4,5-tetracarboxylate, di-n-butyl cyclohexane-1,2,4,5-tetracarboxylate, di-tert-butyl cyclohexane-1,2,4,5-tetracarboxylate, diisobutyl cyclohexane-1,2,4,5-tetracarboxylate, monoglycol cyclohexane-1,2,4,5-tetracarboxylate, diglycol cyclohexane-1,2,4,5-tetra-carboxylate, di-n-octyl cyclohexane-1,2,4,5-tetracarboxylate, diisooctyl cyclohexane-1,2,4,5-tetracarboxylate, di-2-ethylhexyl cyclohexane-1,2,4,5-tetracarboxylate, di-n-nonyl cyclohexane-1,2,4,5-tetracarboxylate, diisononyl cyclohexane-1,2,4,5-tetra-carboxylate, di-n-decyl cyclohexane-1,2,4,5-tetracarboxylate, diisodecyl cyclohexane-1,2,4,5-tetracarboxylate, di-n-undecyl cyclohexane-1,2,4,5-tetracarboxylate, diisododecyl cyclohexane-1,2,4,5-tetracarboxylate, di-n-octadecyl cyclohexane-1,2,4,5-tetracarboxylate, diisooctadecyl cyclohexane-1,2,4,5-tetracarboxylate, di-n-eicosyl cyclohexane-1,2,4,5-tetracarboxylate, monocyclohexyl cyclohexane-1,2,4,5-tetra-carboxylate, trimethyl cyclohexane-1,2,4,5-tetracarboxylate, triethyl cyclohexane-1,2,4,5-tetracarboxylate, tri-n-propyl cyclohexane-1,2,4,5-tetracarboxylate, tri-n-butyl cyclohexane-1,2,4,5-tetracarboxylate, tri-tert-butyl cyclohexane-1,2,4,5-tetra-carboxylate, triisobutyl cyclohexane-1,2,4,5-tetracarboxylate, triglycol cyclohexane-1,2,4,5-tetracarboxylate, tri-n-cetyl cyclohexane-1,2,4,5-tetracarboxylate, triisooctyl cyclohexane-1,2,4,5-tetracarboxylate, tri-2-ethylhexyl cyclohexane-1,2,4,5-tetra-carboxylate, tri-n-nonyl cyclohexane-1,2,4,5-tetracarboxylate, triisononyl cyclohexane-1,2,4,5-tetracarboxylate, tri-n-decyl cyclohexane-1,2,4,5-tetracarboxylate, triisododecyl cyclohexane-1,2,4,5-tetracarboxylate, tri-n-undecyl cyclohexane-1,2,4,5-tetra-carboxylate, triisododecyl cyclohexane-1,2,4,5-tetracarboxylate, tri-n-octadecyl cyclo-hexane-1,2,4,5-tetracarboxylate, triisooctadecyl cyclohexane-1,2,4,5-tetracarboxylate, tri-n-eicosyl cyclohexane-1,2,4,5-tetracarboxylate, tricyclohexyl cyclohexane-1,2,4,5-tetracarboxylate, and also tetramethyl cyclohexane-1,2,4,5-tetracarboxylate, tetraethyl cyclohexane-1,2,4,5-tetracarboxylate, tetra-n-propyl cyclohexane-1,2,4,5-tetracarboxylate, tetra-n-butyl cyclohexane-1,2,4,5-tetracarboxylate, tetra-tert-butyl cyclohexane-1,2,4,5-tetracarboxylate, tetraisobutyl cyclohexane-1,2,4,5-tetra-carboxylate, tetraglycol cyclohexane-1,2,4,5-tetracarboxylate, tetra-n-octyl cyclo-hexane-1,2,4,5-tetracarboxylate; tetraisooctyl cyclohexane-1,2,4,5-tetracarboxylate, tetra-2-ethylhexyl cyclohexane-1,2,4,5-tetracarboxylate, tetra-n-nonyl cyclohexane-1,2,4,5-tetracarboxylate, tetraisononyl cyclohexane-1,2,4,5-tetracarboxylate, tetra-n-decyl cyclohexane-1,2,4,5-tetracarboxylate, tetraisodecyl cyclohexane-1,2,4,5-tetra-carboxylate, tetraisododecyl cyclohexane-1,2,4,5-tetracarboxylate, tetra-n-undecyl cyclohexane-1,2,4,5-tetracarboxylate, tetra-n-octadecyl cyclohexane-1,2,4,5-tetra-carboxylate, tetraisooctadecyl cyclohexane-1,2,4,5-tetracarboxylate, tetra-n-eicosyl cyclohexane-1,2,4,5-tetracarboxylate, tetracyclohexyl cyclohexane-1,2,4,5-tetra-carboxylate, di-n-hexyl cyclohexane-1,2,4,5-tetracarboxylate, diisohexyl cyclohexane-1,2,4,5-tetracarboxylate, tri-n-hexyl cyclohexane-1,2,4,5-tetracarboxylate, triisohexyl cyclohexane-1,2,4,5-tetracarboxylate, di-n-heptyl cyclohexane-1,2,4,5-tetracarboxylate, diisoheptyl cyclohexane-1,2,4,5-tetracarboxylate, tri-n-heptyl cyclohexane-1,2,4,5-tetra-carboxylate; triisoheptyl cyclohexane-1,2,4,5-tetracarboxylate, di-n-pentyl cyclohexane-1,2,4,5-tetracarboxylate, diisopentyl cyclohexane-1,2,4,5-tetracarboxylate, tri-n-pentyl cyclohexane-1,2,4,5-tetracarboxylate, triisopentyl cyclohexane-1,2,4,5-tetra-carboxylate, di-n-tridecyl cyclohexane-1,2,4,5-tetracarboxylate, diisotridecyl cyclo-hexane-1,2,4,5-tetracarboxylate, tri-n-tridecyl cyclohexane-1,2,4,5-tetracarboxylate, triisotridecyl cyclohexane-1,2,4,5-tetracarboxylate, di-n-dodecyl cyclohexane-1,2,4,5-tetracarboxylate, diisoundecyl cyclohexane-1,2,4,5-tetracarboxylate, tri-n-dodecyl cyclohexane-1,2,4,5-tetracarboxylate, triisoundecyl cyclohexane-1,2,4,5-tetra-carboxylate, triisopropyl cyclohexane-1,2,4,5-tetracarboxylate, tetra-n-hexyl cyclo-hexane-1,2,4,5-tetracarboxylate, tetraisohexyl cyclohexane-1,2,4,5-tetracarboxylate, tetra-n-heptyl cyclohexane-1,2,4,5-tetracarboxylate, tetraisoheptyl cyclohexane-1,2,4,5-tetracarboxylate, tetra-n-pentyl cyclohexane-1,2,4,5-tetracarboxylate, tetraisopentyl cyclohexane-1,2,4,5-tetracarboxylate, tetra-n-tridecyl cyclohexane-1,2,4,5-tetra-carboxylate, tetraisotridecyl cyclohexane-1,2,4,5-tetracarboxylate, tetra-n-dodecyl cyclohexane-1,2,4,5-tetracarboxylate, tetraisoundecyl cyclohexane-1,2,4,5-tetra-carboxylate and tetraisopropyl cyclohexane-1,2,4,5-tetracarboxylate.

Also particularly suitable, furthermore, for achieving the object underlying the invention are the cyclohexane-1,2-dicarboxylic esters which are disclosed in WO 99/32427 and are listed again below:

Mixed esters of cyclohexane-1,2-dicarboxylic acid with C1 to C13 alcohols; cyclo-hexane-1,2-dicarboxylic acid di(isopentyl) esters, obtainable by hydrogenating di(iso-pentyl) phthalate with the Chemical Abstracts Registry Number (below: CAS No.) 84777-06-0;

cyclohexane-1,2-dicarboxylic acid di(soheptyl) esters, obtainable by hydrogenating di(isoheptyl) phthalate with the CAS No. 71888-89-6;
cyclohexane-1,2-dicarboxylic acid di(isononyl) esters, obtainable by hydrogenating di(isononyl) phthalate with the CAS No. 68515-48-0;
cyclohexane-1,2-dicarboxylic acid di(isononyl) esters, obtainable by hydrogenating di(isononyl) phthalate with the CAS No. 28553-12-0, based on n-butene;
cyclohexane-1,2-dicarboxylic acid di(isononyl) esters, obtainable by hydrogenating di(isononyl) phthalate with the CAS No. 28553-12-0, based on isobutene;
a 1,2-di-C9 ester of cyclohexanedicarboxylic acid, obtainable by hydrogenating a di(nonyl) phthalate with the CAS No. 68515-46-8;
a cyclohexane-1,2-dicarboxylic acid di(isodecyl) ester, obtainable by hydrogenating a di(isodecyl) phthalate with the CAS No. 68515-49-1;
a 1,2-di-C7-11 ester of cyclohexanedicarboxylic acid, obtainable by hydrogenating the corresponding phthalic ester with the CAS No. 68515-42-4;
a 1,2-di-C7-11 ester of cyclohexanedicarboxylic acid, obtainable by hydrogenating the di-C7-11 phthalates with the following CAS Nos.
111 381-89-6,
111 381 90-9,
111 381 91-0,
68515-44-6,
68515-45-7 and
3648-20-2;
a 1,2-di-C9-11 ester of cyclohexanedicarboxylic acid, obtainable by hydrogenating a di-C9-11 phthalate with the CAS No. 98515-43-6;
a 1,2-di(isodecyl)cyclohexanedicarboxylic ester, obtainable by hydrogenating a di(iso-decyl) phthalate consisting primarily of di(2-propylheptyl) phthalate;
a 1,2-di-C7-9 cyclohexanedicarboxylic ester, obtainable by hydrogenating the corresponding phthalic ester of the branched-chain or linear C7-9 alkyl ester groups; corresponding phthalates which can be used, for example, as starting products have the following CAS Nos:
di-C7,9 alkyl phthalate with the CAS No. 111 381-89-6;
di-C7 alkyl phthalate with the CAS No. 68515-44-6; and
di-C9 alkyl phthalate with the CAS No. 68515-45-7.

The content of WO 99/32427, which refers, among other things, to these above-listed compounds and to the preparation of cyclohexanepolycarboxylic acids using specific catalysts containing macropores, is incorporated in its entirety by reference into the present specification.

In accordance with the invention it is also possible to use hydrogenation products of phthalic acid mixed esters with C10 and C13 alcohols, as are described in DE-A 100 32 580.

Furthermore, the hydrogenation products of the commercially available benzene polycarboxylic esters with the trade names Jayflex DINP (CAS No. 68515-48-0), Jayflex DIDP (CAS No. 68515-49-1), Palatinol 9-P, Vestinol 9 (CAS No. 28553-12-0), TOTM-I (CAS No. 3319-31-1), Linplast 68-TM, Palatinol N(CAS No. 28553-12-0), Jayflex DHP (CAS No. 68515-50-4), Jayflex DIDP (CAS No. 27554-26-3), Jayflex UDP (CAS No. 68515-47-9), Jayflex DIUP (CAS No. 85507-79-5), Jayflex DTDP (CAS No 68515-47-9), Jayflex L9P (CAS No. 68515-45-7), Jayflex L911P (CAS No. 68515-43-5), Jayflex L11P (CAS No. 3648-20-2), Witamol 110 (CAS No. 90193-91-2), Witamol 118 (Di-n-C8-C10-alkylphthalat), Unimoll BB (CAS No. 85-68-7), Linplast 1012 BP (CAS No. 90193-92-3), Linplast 13 XP (CAS No: 27253-26-5), Linplast 610 P (CAS No. 68515-51-5), Linplast 68 FP (CAS No. 68648-93-1) and Linplast 812 HP (CAS No. 70693-30-0), Palatinol AH (CAS No. 117-81-7), Palatinol 711 (CAS No. 68515-42-4), Palatinol 911 (CAS No. 68515-43-5), Palatinol 11 (CAS No. 3648-20-2), Palatinol Z (CAS No. 26761-40-0) and Palatinol DIPP (CAS No. 84777-06-0) are also advantageously to be used in the adhesives or sealants of the invention.

Particularly preferred adhesives and sealants of the invention comprise dialkyl esters of 1,2-cyclohexanedicarboxylic acid. Preference as ester group R is given to linear or branched alkyl groups having 1 to 13 C atoms, or mixtures of the stated alkyl groups. Particularly preferred as ester group R are linear or branched alkyl groups having 8 to 10 C atoms, or mixtures of the stated alkyl groups. Especially preferred as ester group R are alkyl groups having 9 C atoms.

The cyclohexanepolycarboxylic acid derivatives are prepared preferably in accordance with the process disclosed in WO 99/32427. This process encompasses the hydrogenation of a benzene polycarboxylic ester, or of a mixture of two or more of said esters, by contacting the benzene polycarboxylic ester or a mixture of two or more of said esters with a hydrogen-containing gas in the presence of a catalyst which as its active metal comprises at least one metal from transition group VIII of the Periodic Table, alone or together with at least one metal from transition group I or VII of the Periodic Table, applied to a support, preferably aluminum oxide, the support having macropores.

In one preferred embodiment the support, preferably aluminum oxide, has an average pore diameter of at least 50 nm and a BET surface area of not more than 30 m²/g, and the amount of the active metal is 0.01% to 30% by weight, based on the total weight of the catalyst, preferably 0.1% to 10% by weight.

In another embodiment a catalyst having a bimodal pore, distribution is used in which the amount of the active metal is 0.01% to 30% by weight, preferably 0.1% to 10% by weight, based on the total weight of the catalyst, and 10% to 50% of the pore volume of the support, preferably aluminum oxide, is formed by macropores having a pore diameter in the range from 50 nm to 10 000 nm, and 50% to 90% of the pore volume of the support is formed by mesopores having a pore diameter in the range from 2 to 50 nm, the sum of the fractions of the pore volumes adding up to 100%.

In a further embodiment the catalyst contains 0.01% to 30% by weight, preferably 0.1% to 10% by weight, based on the total weight of the catalyst, of an active, metal, applied to a support, the support having an average pore diameter of at least 0.1 μm and a BET surface area of not more than 15 m²/g. As supports it is possible in principle to use all supports, which have macropores, i.e. supports which contain exclusively macropores, and also those which include mesopores and/or micropores as well as macropores.

As active metal it is possible in principle to use all metals from transition group VIII of the Periodic Table. Preferred active metals used are platinum, rhodium, palladium, cobalt, nickel or ruthenium or a mixture of two or more of these, with ruthenium being used more particularly as active metal. Among the metals of transition group I or VII or else of transition groups I and VII of the Periodic Table that can likewise be used, which can likewise all be used in principle, preference is given to the use of copper and/or rhenium.

In the context of the present specification the terms “macropores” and “mesopores” are used in the way in which they are defined in Pure Appl. Chem., 45 p. 79 (1976), namely as pores whose diameter is above 50 nm (macropores) or whose diameter is between 2 nm and 50 nm (mesopores).

The amount of the active metal is generally 0.01% to 30%, preferably 0.01% to 5%, more preferably 0.1% to 5%, by weight, based in each case on the total weight of the catalyst'used.

The term “benzenepolycarboxylic acid or a derivative thereof” that is used encompasses all benzenepolycarboxylic acids per se, for example phthalic acid, iso-phthalic acid, terephthalic acid, trimellitic acid, trimesic acid, hemimellitic acid and pyro-mellitic acid, and derivatives thereof, particular mention being made of mono-, di-, tri- and tetra esters, more particularly alkyl esters, and anhydrides. Preference is given to the alkyl esters of the stated acids, the alkyl group being preferably a radical R as defined above.

The benzenepolycarboxylic acid alkyl esters used with preference are prepared generally by reacting benzenepolycarboxylic acids and/or benzenepolycarboxylic anhydrides with the alkyl groups of the esters of the corresponding alcohols. Suitable reaction conditions for the reaction of the benzenepolycarboxylic acids with the corresponding alcohols are known to the skilled person.

Additionally provided by the present specification are adhesive or sealant comprising (A) 10% to 90% by weight of at least one compound selected from the group consisting of polyurethanes, polyureas, polyacrylates and polysulphides, and (B) 1% to 50% by weight of at least one cyclohexanepolycarboxylic acid derivative, the adhesive or sealant containing no C₄ to C₈ alkyl terephthalate, and component (B) being preparable by the following process:
a) esterifying a benzenepolycarboxylic acid of the formula II

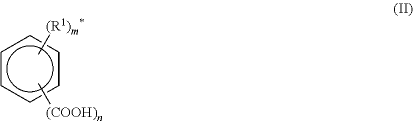

in which
R¹* is hydrogen or a C₁-C₁₀ alkyl or C₃-C₈ cycloalkyl group,
m is 2, 3 or 4, and
n is 2, 3 or 4,
   with one or more alcohols of the formula

R—OH

in which
R is C₁-C₃₀ alkyl, preferably C₁-C₂₀ alkyl, more preferably C₁-C₁₈ alkyl, very preferably C₁-C₁₃ alkyl,
   to give a benzenepolycarboxylic ester of the formula III

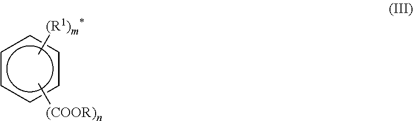

b) hydrogenating the benzenepolycarboxylic ester of the formula III to give a corresponding cyclohexanepolycarboxylic ester of the general formula I.

Preferred embodiments of R¹*, m, n and R have been mentioned above in relation to the cyclohexanepolycarboxylic esters of formula I.

A preferred embodiment of the hydrogenation of the benzenepolycarboxylic ester of the formula III (step b)) has been mentioned above.

Benzenepolycarboxylic acids used with preference are phthalic acid, isophthalic acid, terephthalic acid, trimellitic acid, trimesic acid, hemimellitic acid and pyromellitic acid. Very particular preference is given to using phthalic acid. The acids referred to above are available commercially.

Alcohols used are preferably the alcohols corresponding to the radicals R of the cyclo-hexanepolycarboxylic acid derivatives of the formula I. It is therefore preferred to use linear or branched alcohols with C₁-C₁₃ alkyl radicals. The alcohols used for esterification with the benzenepolycarboxylic acids may in each case be the individual isomers of the alcohols, corresponding to the aforementioned radicals R, or mixtures of different alcohols with isomeric alkyl radicals having the same number of carbon atoms, and/or mixtures of different alcohols with different numbers of carbon atoms.

The alcohols or alcohol mixtures that are suitable for reaction with the benzenepoly-carboxylic acids may be prepared by all of the processes that are known to the skilled person. Suitable processes for preparing alcohols, or process steps employed in the preparation of alcohols, are, for example, the following:
hydroformylation with subsequent hydrogenation of the aldehydes formed, for example as disclosed in WO 92/13818, DE-A 2 009 505, DE-A 199 24 339, EP-A 1 113 034, WO 00/63151, WO 99/25668, JP-A 1 160 928, JP-A 03 083 935, JP-A 2000/053803, EP-A 0 278 407, EP-A 1 178 029, FR-A 1 304 144, JP-A 30 44 340, JP-A 30 44 341, JP-A 30.44 342, JP-A 0 40 36251, GB-A 721,540, DE-A 195 304 14, JP-A 2001/049029, U.S. Pat. No. 2,781,396, U.S. Pat. No. 3,094,564, FR-A 1 324 873, JP-A 0 816 9854, U.S. Pat. No. 3,153,673, U.S. Pat. No. 3,127,451, U.S. Pat. No. 1,828,344, WO 2003/66642, WO 2003/18912, EP-A 0424 767, WO 2002/68369, EP-A 0 366 089, JP-A 2001/002829, DE-A 1.00 35 617, DE-A 199.55 593, WO 2002/00580, EP-A 0 643 031, U.S. Pat. No. 2,876,264, JP-A 2000/319444 and DE-A 100 32 580;
hydrogenation of aldol products, for example as disclosed in DE-A 102 51 311, JP-A 05 194 761, U.S. Pat. No. 3,272,873, DE-A 3 151 086, JP-A 2001/322959, WO 98/03462 and EP-A 0 603 630;
hydration of alkenes, for example as disclosed in U.S. Pat. No. 5,136,108, EP-A-0 325 144, EP-A 0 325 143, DE-A 100 50 627, U.S. Pat. No. 4,982,022, GB-A 2,187,741, DE-A 36 28 008, U.S. Pat. No. 3,277,191, JP-A 2000/191 566, DE-A 854 377, DE-A 38 01 275, DE-A 39 25 217, JP-A 06 321 828, JP-A 02 088 536, JP-A 06 287 156, JP-A 06 287155, JP-A 54 141 712, JP-A 08 283 186, JP-A 09 263 558 and U.S. Pat. No. 4,684,751;
hydrogenation of carboxylic acids and carboxylic esters, especially fatty acids and fatty esters, for example as disclosed in U.S. Pat. No. 5,463,143, U.S. Pat. No. 5,475,159, WO 94/10112, CA 2,314,690, WO 94/06738, JP-A 06 065 125 and U.S. Pat. No. 3,361,832;
hydrogenation of unsaturated alcohols or of carbonyl compounds, for example as disclosed in EP-A 0 394 842, DE-A 1 269 605, WO 88/05767, FR-A 1,595,013, EP-A 0 326 674, BE-A 756 877, BE-A 757 561, DE-A 1 277 232, FR-A 1,499,041 and DE-A 1 276.620;
hydrogenation of epoxides, for example as disclosed in FR-A 1,508,939, GB-A 879 803 and DE-A 1 078 106;
processes comprising a telomerization step, for example as disclosed in EP-A 0 330 999, DE-A 1 138 751, U.S. Pat. No. 5,908,807, NE-6,603,884 and U.S. Pat. No. 3,091,628;
processes comprising an isomerization step, for example as disclosed in DE-A 42 28 887;
hydrolysis of sulphates, for example as disclosed in GB-A 1,165,309;
reaction of dienes with amines, for example as disclosed in DE-A 44 31 528;
enzymatic preparation of alcohols, for example as disclosed in WO 93/24644;
selective hydrogenation of dienes, for example as disclosed in U.S. Pat. No. 3,203,998, DE-A 21 41 186, GB-A 2,093,025, JP-A 02 12924, JP-A 1 122 8468, DE-A 195 44 133, WO 94/00410, GB-A 2,260,136, DE-A 44 10 746 and JP-A 08 176 036;
preparation of alcohols from nitriles, for example as disclosed in EP-A 0 271 092;
preparation of alcohols by reaction of alkynes; for example as disclosed in RU 205 9597-C1; and
hydrogenolysis of substituted tetrahydropyrans, for example as disclosed in GB 1,320,188.

The skilled person is aware of further processes for preparing alcohols that can likewise be used for preparing alcohols or alcohol mixtures that are suitable for esterification with benzene polycarboxylic acids. Alcohols used with preference are—as mentioned above—alcohols which contain C₁-C₁₃ alkyl radicals. In particular the relatively long-chain C₅-C₁₃ alcohols or alcohol mixtures which comprise these alcohols are prepared with particular preference by catalytic hydroformylation (also referred to as, the oxo process) of olefins and subsequent hydrogenation of the aldehydes formed. Suitable hydroformylation processes are known to the skilled person and are disclosed in the documents identified above. The alcohols and alcohol mixtures disclosed in the documents identified can be reacted with the aforementioned benzenepolycarboxylic acids to give the desired benzenepolycarboxylic acid alkyl esters and ester mixtures.

C₅ alcohols and mixtures containing C₅ alcohols, more preferably n-pentanol, can be prepared, for example, by hydroformylating butadiene in the presence of an aqueous solution of a rhodium compound and of a phosphine as catalyst. Such a process is disclosed for example in EP-A 0 643 031.

Suitable C₇ alcohol mixtures which can be used for esterification with the benzene polycarboxylic acids are disclosed for example in JP-A 2000/319 444. The C₇ alcohol mixture is prepared by hydroformylation with subsequent hydrogenation of the aldehydes formed.

Mixtures comprising C₈ alcohols and the processes for preparing them are disclosed for example in GB-A 721 540, which describes a process for preparing isooctyl alcohols starting from heptenes by means of hydroformylation and subsequent hydrogenation. Further documents disclosed in the preparation of C₇ alcohols and/or mixtures comprising these alcohols are DE-A 195 30 414, JP-A 2001/49029, U.S. Pat. No. 2,781,396, U.S. Pat. No. 3,094,564, FR-A 1,324,873, JP-A 08 169 854, U.S. Pat. No. 3,153,673, U.S. Pat. No. 3,127,451 and U.S. Pat. No. 1,828,344.

C₉ alcohols and mixtures comprising C₉ alcohols are prepared preferably by dimerizing butenes, hydroformylating the resultant octenes, and subsequently hydrogenating the resultant C₉ aldehyde.

Suitable processes and mixtures comprising C₉ alcohols are disclosed for example in WO 92/13818, DE-A 20 09 505, DE-A 199 24 339, EP-A 1 113 034, WO 2000/63151, WO 99/25668, JP-A 1 160 928, JP-A 03 083 935, JP-A 2000/053803, EP-A 0 278 407 and EP-A 1 178 029.

C₁₀ alcohols and mixtures comprising these alcohols are disclosed for example in WO 2003/66642, WO 2003/18912, EP-A 0 424 767, WO 2002/68369, EP-A 0 366 089 and JP-A 2001/002829.

C₁₂ alcohols and mixtures comprising C₁₂ alcohols, more particularly trimethylnonanol, and a process for its preparation are disclosed for example in WO 98/03462.

C₁₃ alcohols and mixtures comprising these alcohols are disclosed for example in DE-A 100 32 580, DE-A 199 55 593 and WO 2002/00580.

In the auxiliaries or as auxiliaries in accordance with the present invention, particular preference is given to using dialkyl esters of the aforementioned cyclohexane-dicarboxylic acids, more particularly 1,2-, 1,3- or 1,4-dialkyl esters and especially 1,2-dialkyl esters. In this context it is possible to use dialkyl esters in which both ester groups of the dialkyl esters carry the same alkyl radicals, and also ester groups in which the two ester groups of the dialkyl esters carry different alkyl groups. Examples of mixed and non-mixed dialkyl esters of cyclohexanedicarboxylic acids have already been given above. It is also possible for the alkyl groups of the cyclohexanedicarboxylic acid alkyl esters to have the same number of carbon atoms and yet to be linear or have different branches and so to form isomer mixtures. Isomer mixtures of this kind can also be used if the number of carbons in the alkyl groups of the dialkyl esters is different. The fraction of the various isomers of the alkyl groups is generally a product of the composition of the alcohols used for the esterification of the benzene dicarboxylic acids, which, following esterification, are hydrogenated to form the cyclo-hexanedicarboxylic esters. Suitable alcohol mixtures have already been specified above. For the purposes of the present invention, therefore, linear or branched alkyl radicals having a particular number of carbon atoms comprehend not only the individual isomers but also isomer mixtures whose composition—as mentioned above—is a product of the composition of the alcohols used for esterifying the benzene-dicarboxylic acids. Linear alkyl radicals for the purposes of the present invention are exclusively linear alkyl radicals, but also mixtures of alkyl radicals which are predominantly linear.

Where the alkyl radicals R of the cyclohexanepolycarboxylic esters are C₁ to C₄ alkyl radicals, they are obtained by reacting the benzenepolycarboxylic acids of the formula II with methanol, ethanol, n-propanol, isopropanol, n-butanol, isobutanol, sec-butanol or tert-butanol. For preparing benzenepolycarboxylic esters in which R is 3 or 4, it is possible to use mixtures of the stated propanols or butanols, or individual isomers. Preference is given to using individual isomers of propanol or butanol. The preparation of the aforementioned C₁ to C₄ alcohols is known to the skilled person.

Where the alkyl radicals R of the cyclohexanepolycarboxylic esters are C₅ to C₁₃ alkyl radicals, it is preferred to use C₅ to C₁₃ alcohols which degrees of branching (ISO index) of generally 0.10 to 4, preferably 0.5 to 3, more preferably 0.8 to 2 and more particularly 1 to 1.5; in other words, in general, the alcohols are mixtures of different isomers. Very particular preference is given to using C9 alcohol mixtures with an ISO index of 1 to 1.5, more particularly nonanol mixtures with an ISO index of 1.25 or 1.6.

The ISO index is a dimensionless variable which can be determined by means of gas chromatography (“GC”). The following GC conditions, for example, can be employed.

| Method: | capillary GC | |
|---|---|---|
| Apparatus: | capillary gas chromatograph with autosampler, | |
| | split/splitlessinjection system and flame | |
| | ionization detector (FID) | |
| Chemicals: | MSTFA (N-methyl-N-trimethylsilyltriflouroacetamide)- | |
| | calibration alcohols for determining the retention times | |
| Sample | 3 drops of the sample are held in 1 ml of MSTFA and for | |
| Preparation: | 60 minutes at 80° C. | |
| GC conditions | capillary column: | Ultra-1 (from Carl Roth GmbH; |
| | | 76185 Karlsruhe, DE) |
| | stationary phase | polydimethylsiloxane |
| | length: | 50 m |
| | internal diameter: | 0.25 mm |
| | film thickness: | 0.1 micrometer |
| | carrier gas: | helium |
| | column admission | 200 psi constant |
| | pressure: | |
| | split: | 80 ml/min |
| | septum flushing: | 3 ml/min |
| | oven temperature: | 120° C., 25 min isothermal |
| | injector temperature: | 250° C. |
| | detector temperature: | 250° C. (FID) |
| | injection volume: | 0.5 microlitre |

Calculation The procedure when calculating the Iso index is evident from the table below:

| Compo- | | | Fraction | |
|---|---|---|---|---|
| nent | Name | Branching | in area % | Index |
| 1 | 2-Ethyl-2-methylhexan-1-ol | 2 | 1.00 | 0.0200 |
| 2 | 2-Ethyl-4-methylhexan-1-ol | 2 | 1.00 | 0.0200 |
| 3 | 2-Ethyl-4-methylhexan-1-ol | 2 | 1.00 | 0.0200 |
| 4 | 2-Propyl-3-methylpentan-1-ol | 2 | 1.00 | 0.0200 |
| 5 | 2-Propyl-hexan-1-ol | 1 | 1.00 | 0.0100 |
| 6 | 2,5-Dimethylheptan-1-ol | 2 | 1.00 | 0.0200 |
| 7 | 2,3-Dimethylheptan-1-ol | 2 | 1.00 | 0.0200 |
| 8 | 2,3,4-Trimethylhexan-1-ol | 3 | 1.00 | 0.0300 |
| 9 | 2-Ethylheptan-1-ol | 1 | 1.00 | 0.0100 |
| 10 | 3-Ethyl-4-methylhexan-1-ol | 2 | 82.00 | 1.6400 |
| 11 | 3-Ethylheptan-1-ol | 1 | 1.00 | 0.0100 |
| 12 | 2-Methyloctan-1-ol | 1 | 1.00 | 0.0100 |
| 13 | 4,5-Dimethylheptan-1-ol | 2 | 1.00 | 0.0200 |
| 14 | 4,5-Dimethylheptan-1-ol | 2 | 1.00 | 0.0200 |
| 15 | 4-Methyloctan-1-ol | 1 | 1.00 | 0.0100 |
| 15a | 7-Methyloctan-1-ol | 1 | 1.00 | 0.0000 |
| 16 | 6-Methyloctan-1-ol | 1 | 1.00 | 0.0100 |
| 17 | Nonan-1-ol | 0 | 1.00 | 0.0000 |
| | | Total: | 99.00 | 1.9000 |
| | Unknown component | 2 | 1.00 | 0.0200 |
| | | | Iso index: | 1.9200 |

The C₅ to C₁₃ alcohols are prepared in accordance with the processes identified above. For preparing cyclohexanepolycarboxylic esters in which R is 9 it is particularly preferred to use a nonanol mixture in which 0% to 20%, preferably 0.5% to 18%, more preferably 6% to 16% by weight of the nonanol mixture contains no branching, 5% to 90%, preferably 10% to 80%, more preferably 45% to 75% by weight contains one branch, 5% to 70%, preferably 10% to 60%, more preferably 15% to 35% by weight contains two branches, 0% to 10%, preferably 0% to 8%, more preferably 0% to 4% by weight contains three branches and 0% to 40%, preferably 0.1% to 30%, more preferably 0.5% to 6.5% by weight is made up of other components. By other components are meant, generally, nonanols having more than three branches, decanols or octanols, the sum of the stated components being 100% by weight.

One particularly preferred embodiment of a nonanol mixture which is used for preparing cyclohexanepolycarboxylic acid derivatives that are used with preference has the following composition:
1.73% to 3.73%, preferably 1.93% to 3.53%, more preferably 2.23% to 3.23% by weight of 3-ethyl-6-methylhexanol;
0.38% to 1.38%, preferably 0.48% to 1.28%, more preferably 0.58% to 1.18% by weight of 2,6-dimethylheptanol;
2.78% to 4.78%, preferably 2.98% to 4.58%, more preferably 3.28% to 4.28% by weight of 3,5-dimethylheptanol;
6.30% to 16.30%, preferably 7.30% to 15.30%, more preferably 8.30% to 14.30% by weight of 3,6-dimethylheptanol;
5.74% to 11.74%, preferably 6.24% to 11.24%, more preferably 6.74% to 10.74% by weight of 4,6-dimethylheptanol;
1.64% to 3.64%, preferably 1.84% to 3.44%, more preferably 2.14% to 3.14% by weight of 3,4,5-trimethylhexanol;
1.47% to 5.47%, preferably 1.97% to 4.97%, more preferably 2.47% to 4.47% by weight of 3,4,5-trimethylhexanol, 3-methyl-4-ethylhexanol and 6-ethyl-4-methylhexanol;
4.00% to 10.00%, preferably 4.50% to 9.50%, more preferably 5.00% to 9.00% by weight of 3,4-dimethylheptanol;
0.99% to 2.99%, preferably 1.19% to 2.79%, more preferably 1.49% to 2.49% by weight, of 4-ethyl-5-methylhexanol and 3-ethylheptanol;
2.45% to 8.45%, preferably 2.95% to 7.95%, more preferably 3.45% to 7.45% by weight of 4,5-dimethylheptanol and 3-methyloctanol;
1.21% to 5.21%, preferably 1.71% to 4.71%, more preferably 2.21% to 4.21% by weight of 4,5-dimethylheptanol;
1.55% to 5.55%, preferably 2.05% to 5.05%, more preferably 2.55% to 4.55% by weight of 5,6-dimethylheptanol;
1.63% to 3.63%, preferably 1.83% to 3.43%, more preferably 2.13% to 3.13% by weight of 4-methyloctanol;
0.98% to 2.98%, preferably 1:18% to 2.78%, more preferably 1.48% to 2.48% by weight of 5-methyloctanol;
0.70% to 2.70%, preferably 0.90% to 2.50%, more preferably 1.20% to 2.20% by weight of 3,6,6-trimethylhexanol;
1.96% to 3.96%, preferably 2.16% to 3.76%, more preferably 2.46% to 3.46% by weight of 7-methyloctanol;
1.24% to 3.24%, preferably 1.44% to 3.04%, more preferably 1.74% to 2.74% by weight of 6-methyloctanol;
0.1% to 3%, preferably 0.2% to 2%, more preferably 0.3% to 1% by weight of n-nonanol;
25% to 35%, preferably 28% to 33%, more preferably 29% to 32% by weight of other alcohols having 9 and 10 carbon atoms; the sum total of the stated components is 100% by weight.

Another particularly preferred embodiment of a nonanol mixture which is used for preparing cyclohexanepolycarboxylic acid derivatives that are used with preference has the following composition:
6.0% to 16:0%, preferably 7.0% to 15.0%, more preferably 8.0% to 14.0% by weight of n-nonanol;
12.8% to 28.8%, preferably 14.8% to 26.8%, more preferably 15.8% to 25.8% by weight of 6-methyloctanol;
12.5% to 28.8%, preferably 14.5% to 26.5%, more preferably 15.5% to 25.5% by weight of 4-methyloctanol;
3.3% to 7.3%, preferably 3.8% to 6.8%, more preferably 4.3% to 6.3% by weight of 2-methyloctanol;
5.7% to 11:7%, preferably 6.3% to 11.3%, more preferably 6.7% to 10.7% by weight of 3-ethylheptanol;
1.9% to 3.9%, preferably 2.1% to 3.7%, more preferably 2.4% to 3.4% by weight of 2-ethylheptanol;
1.7% to 3.7%, preferably 1.9% to 3.5%, more, preferably 2.2% to 3.2% by weight of 2-propylhexanol;
3.2% to 9.2%, preferably 3.7% to 8.7%, more preferably 4,2% to 8.2% by weight, of 3,5-dimethylheptanol;
6.0% to 16.0%, preferably 7.0% to 15.0%, more preferably 8.0% to 14.0% by weight of 2,5-dimethylheptanol;
1.8% to 3.8%, preferably 2.0% to 3.6%, more preferably 2.3% to 3.3% by weight, of 2,3-dimethylheptanol;
0.6% to 2.6%, preferably 0.8% to 2.4%, more preferably 1.1% to 2.1% by weight of 3-ethyl-4-methylhexanol;
2.0% to 4.0%, preferably 2.2% to 3.8%, more preferably 2.5% to 3.5% by weight of 2-ethyl-4-methylhexanol;
0.5% to 6.5%, preferably 1.5% to 6%, more preferably 1.5% to 5.5% by weight of other alcohols having 9 carbon atoms;
   the sum total of the stated components being 100% by weight.

In the present specification the term “adhesives or sealants” refers to any composition which can be used to produce a material bond between two or more articles or bodies, or which is suitable for filling openings, seams or spaces in, on or between one or more articles or bodies (for example grooves, holes, cracks, joints, spaces between adjacent or overlapping articles, pores and seams). Thus sealants are used for example, for filling spaces caused by adjacent or overlapping structures, such as, for instance, window joints and sanitary joints or else joints in automotive, aircraft or watercraft construction, and also construction joints, civil engineering joints and flooring joints. In specific embodiments the sealants can also be used to make surfaces smooth or, in the form of a sealing compound, to prevent the ingress or egress of moisture, chemicals or gases through the aforementioned openings, joints or cavities, the aforementioned properties not constituting necessary features of the stated adhesives and sealants. Adhesives and sealants cure during or after application, by chemical or physical processes in one or more components of the composition.

In specific embodiments of the present invention the adhesives or sealants are self-curing. This means that, following application, the compositions cure, without the need for external factors, such as heating or irradiation, for the curing process. In other embodiments they may be emulsions of one or more polymers in water or other solvents (polyacrylates for example) which cure physically in the course of drying. Furthermore, however, it is also possible for the prepolymers used to undergo polymerization as a result of the ambient moisture, as is the case, for example, for the isocyanate-terminated polyurethanes or isocyanate-terminated polyurea prepolymers. The adhesives or sealants of the invention may also be two-component or multi-component systems which are brought into contact with one another and/or mixed with one another shortly before, or during, application, with the reaction thus triggered leading to the curing of the system (examples being two-component polyurethane or polyurea systems).

The polymers used as component A) are generally products obtained by the polymerization of at least one type of monomer. Where the polymers contain two or more types of monomer, these monomers may be arranged in the polymer in any form—that is, they may be present either randomly distributed or in blocks. It is essential to the invention that component (A) used is at least one polymer from the group consisting of polyurethanes, polyureas, polyacrylates and polysulphides.

The polyurethanes and polyureas are synthesized from at least one polyol and/or polyamine component and also from a polyisocyanate component, and may optionally comprise chain extenders.

The mode of preparation of the polyurethane or polyurea prepolymers is not critical to the present invention. It may therefore be a one-stage operation, in which the polyols and/or polyamines, polyisocyanates and chain extenders are reacted with one another simultaneously, which may take place, for example, in a batch reaction, or else it may be a two-stage operation, in which, for example, the first product formed is a prepolymer, which is subsequently reacted with chain extenders.

The polyurethanes or polyureas may also comprise further structural units, which more particularly may be allophanates, biuret, uretdione or cyanurates. The aforementioned groups, however, are only examples, and the polyurethanes and polyureas of the invention may also comprise further structural units. The degree of branching as well is not critical to the present invention, and so both linear and highly branched polymers can be used.

In one preferred embodiment of the invention the molar ratio of the isocyanate component present in the polymer to the sum of the polyol and/or polyamine component is 0.01 to 50, preferably 0.5 to 3.0.

The isocyanate component is preferably an aliphatic, cycloaliphatic, araliphatic and/or aromatic compound, preferably a diisocyanate or triisocyanate, and may also comprise mixtures of these compounds. It is regarded here as being preferred for it to be hexa-methylene 1,6-diisocyanate (HDI), HDI uretdione, HDI isocyanurate, HDI biuret, HDI allophanate, 1-isocyanato-3,3,5-trimethyl-5-isocyanatomethylcyclohexane (IPDI), 2,4- and/or 2,6-tolylene diisocyanate (TDI) and/or 4,4′-, 2,4′- and/or 2,2′-diphenylmethane diisocyanate (MDI), polymeric MDI, carbodiimide-modified 4,4′-MDI, m-xylene diiso-cyanate (MXDI), m- or p-tetramethylxylene diisocyanate (m-TMXDI, p-TMXDI), 4,4′-dicyclohexylmethane diisocyanate (H12MDI), naphthalene-1,5-diisocyanate, cyclo-hexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diiso-cyanate, 1,6-diisocyanato-2,2,4-trimethylhexane, 1,6-diisocyanato-2,4,4-trimethyl-hexane, 1-isocyanato-1-methyl-4(3)-isocyanatomethylcyclohexane (IMCI) and 1,12-dodecane diisocyanate (C12D1). It may also be 4-dichlorophenyl diisocyanate, dicyclohexylmethane 4,4′-diisocyanate, m-phenylene diisocyanate, p-phenylene diiso-cyanate, 4-chloro-1,3-phenylene diisocyanate, 1,6-hexamethylene diisocyanate, 1,10-decamethylene diisocyanate, lysine alkyl ester diisocyanate, 3,3′-dimethyl-4,4′-diphenylmethane diisocyanate, xylylene diisocyanate, tetramethylxylylene diiso-cyanate, 1,5-tetrahydronaphthalene diisocyanate, triisocyanatotoluene, methylene-bis(cyclohexyl) 2,4′-diisocyanate and 4-methylcyclohexane 1,3-diisocyanate. Suitable more particularly are polyisocyanates having two or three isocyanate groups per molecule. Alternatively this component may comprise mixtures of polyisocyanates, with the average NCO functionality of the isocyanate component in the mixture being able in particular to be 2.1 to 2.3, 2.2 to 2.4, 2.6 to 2.8 or 2.8 to 3.0. Derivatized polyisocyanates may likewise be used examples being sulphonated isocyanates, blocked isocyanates, isocyanurates and biuret isocyanates.

The polyol and/or polyamine component preferably comprises polyetherester polyol, fatty acid ester polyols, polyether polyols, polyester polyols, polybutadiene polyols and polycarbonate polyols, which may also comprise mixtures of these compounds. The polyols and/or polyamines contain preferably between two and 10, more preferably between two and three hydroxyl groups and/or amino groups, and possess a weight-average molecular weight of between 32 and 30 000, more preferably between 90 and 18 000 g/mol. Suitable polyols are preferably the polyhydroxy compounds that at room temperature are liquids, glasslike solids/amorphous compounds or crystalline compounds. Typical examples might include difunctional polypropylene glycols. It is also possible for preferably hydroxyl-containing random copolymers and/or block copolymers of ethylene oxide and propylene oxide to be used. Suitable polyether polyols are the polyethers known per se in polyurethane chemistry, such as the polyols prepared, using starter molecules, by means of KOH catalysis or Double Metal Cyanide (DMC) catalysis, from styrene oxide, ethylene oxide, propylene oxide, butylene oxide, tetrahydrofuran or epichlorohydrin.

Specific suitability is also possessed more particularly by poly(oxytetramethylene) glycol (polyTHF), 1,2-polybutylene glycol, or mixtures thereof. Particular suitability is possessed by polypropylene oxide, polyethylene oxide and butylene oxide and mixtures thereof. Another type of copolymer which can be used as a polyol component and which terminally contains hydroxyl groups is in accordance with the following general formula (and can be prepared, for example, by means of “Controlled” high-speed anionic polymerization according to Macromolecules 2004, 37, 4038-4043):

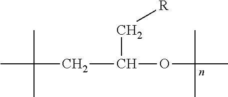

in which R is alike or different and is represented preferably by OMe, OiPr, Cl or Br.

Additionally suitable as a polyol component are, more particularly, the polyester diols and polyester polyols which at 25° C. are liquid, glasslike-amorphous or crystalline compounds and which are preparable by condensation of dicarboxylic or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimer fatty acid, with low molecular mass diols, triols or polyols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, pentaerythritol and/or trimethylolpropane.

A further suitable group of polyols are the polyesters based, for example, on caprolactone, which are also referred to as “polycaprolactones”. Other polyols which can be used are polycarbonate polyols, dimer fatty alcohols and dimerdiols, and also polyols based on vegetable oils and their derivatives, such as castor oil and its derivatives or epoxidized soybean oil. Also suitable are polycarbonates containing hydroxyl groups, which are obtainable by reacting derivatives of carbonic acid, e.g. diphenyl carbonate, dimethyl carbonate or phosgene, with diols. Particular suitability is possessed for example by ethylene glycol, 1,2- and 1,3-propanediol, 1,3- and 1,4-butanediol, 1,6-hexanediol, 1,8-octanediol, neopentyl glycol, 1,4-bishydroxymethyl-cyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butane-triol, trimethylolpropane, pentaerythritol, quinitol, mannitol, sorbitol, methylglycoside and 1,3,4,6-dianhydrohexitols. The hydroxy-functional polybutadienes as well, which are purchasable under trade names including that of “Poly-bd®”, can be used as a polyol component, as can their hydrogenated analogues. Additionally suitable are hydroxy-functional polysulphides, which are sold under the trade name “Thiokol® NPS-282”, and also hydroxy-functional polysiloxanes.

Particular suitability as a polyamine component which can be used in accordance with the invention is possessed by hydrazine, hydrazine hydrate and substituted hydrazines, such as N-methylhydrazine, N,N′-dimethylhydrazine, acid hydrazides of adipic acid, methyladipic acid, sebacic acid, hydracrylic acid, terephthalic acid, isophthalic acid, semicarbazidoalkylene hydrazides, such as 13-semicarbazidopropionyl hydrazide, semicarbazidoalkylene-carbazine esters, such as, for example, 2-semicarbazidoethyl-carbazine ester and/or aminosemicarbazide compounds, such as 13-aminoethyl semi-carbazidocarbonate. Also suitable for preparing the polyurethanes and polyureas are polyamines based on polyesters, polyolefins, polyacetals, polythioethers, polyether-carbonates, polyethylene terephthalates, polyesteramides, polycaprolactams, poly-carbonates, polycaprolactones and polyacrylates which contain at least two amine groups. Polyamines, such as those sold under the trade name of Jeffamine® (which are polyether polyamines), are also suitable.

As polyol component and/or polyamine component, suitability is also possessed by the species which are known as chain extenders and which, in the preparation of polyurethanes and polyureas, react with excess isocyanate groups; they normally have a molecular weight (Mn) of below 400 and are frequently present in the form of polyols, aminopolyols or aliphatic, cycloaliphatic or araliphatic polyamines.

Examples of suitable chain extenders are as follows:
alkanediols, such as ethanediol, 1,2- and 1,3-propanediol, 1,4- and 2,3-butane-diol, 1,5-pentanediol, 1,3-dimethylpropanediol, 1,6-hexanediol, neopentyl glycol, cyclohexanedimethanol, 2-methyl-1,3-propanediol, hexylene glycol, 2,5-dimethyl-2,5-hexanediol, ethylene glycol, 1,2- or 1,3-propanediol, 1,2-, 1,3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentyl glycol, dipropylene glycol, diethylene glycol, 1,2-, 1,3- or 1,4-cyclohexanediol, 1,2-, 1,3- or 1,4-cyclohexanedimethanol, trimethylpentanediol, ethylbutylpropane-diol, diethyloctanediols, 2-butyl-2-ethyl-1,3-propanediol, 2-butyl-2-methyl-1,3-propanediol, 2-phenyl-2-methyl-1,3-propanediol, 2-propyl-2-ethyl-1,3-propanediol, 2-di-tert-butyl-1,3-propanediol, 2-butyl-2-propyl-1,3-propanediol, 1-dihydroxymethylbicyclo[2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol-2,5-diethyl-2,5-hexanediol, 2-ethyl-5-methyl-2,5-hexanediol, 2,4-dimethyl-2,4-pentanediol, 2,3-dimethyl-2,3-butanediol, 1,4-bis(2′-hydroxypropyl)benzene and 1,3-bis(2′-hydroxy-propyl)benzene, and
δ-hydroxybutyl-ε-hydroxy-caproic esters, ω-hydroxyhexyl-γ-hydroxy-butyric esters, adipic acid-(β-hydroxyethyl) ester or terephthalic acid bis(β-hydroxy-ethyl) ester, and
aliphatic diamines, aromatic diamines and alicyclic diamines, more particularly methylenediamine, ethylenediamine, 1,2- and 1,3-diaminopropane, 1,4-diamino-butane, cadaverine (1,5-diaminopentane), 1,6-hexamethylenediamine, isophorone-diamine, piperazine, 1,4-cyclohexyldimethylamine, 4,4′-diaminodicyclohexyl-methane, aminoethylethanolamine, 2,2,4-trimethylhexamethylenediamine, 2,4,4-tri-methylhexamethylenediamine, octamethylenediamine, m- or p-phenylenediamine, 1,3- or 1,4-xylylenediamine, hydrogenated xylylenediamine, bis(4-aminocyclo-hexyl)methane, 4,4′-methyleriebis(ortho-chloroaniline), di(methylthio)toluene-diamine, diethyltoluenediamine, N,N′-dibutylaminodiphenylmethane, bis(4-amino-3-methylcyclohexyl)methane, isomer mixtures of 2,2,4- and 2,4,4-trimethyl-hexa-methylenediamine, 2-methylpentamethylenediamine, diethylenetriamine, and 4,4-diaminodicyclohexylmethane, and also
ethanolamine, hydrazineethanol, 2-[(2-aminoethyl)amino]ethanol.

Lastly it should be mentioned that the polyol component and/or polyamine component may contain double bonds, which may result, for example, from long-chain aliphatic carboxylic acids or fatty alcohols. Functionalization with olefinic double bonds is also possible, for example, through the incorporation of vinylic and/or allylic groups, which optionally are alkyl-, aryl- and/or aralkyl-substituted, and also originate unsaturated acids such as maleic anhydride, acrylic acid or methacrylic acid and their respective esters.

For the purposes of the invention it is preferred for the polyol component and/or polyamine component to be polypropylene diol, polypropylene triol, polypropylene polyol, polyethylene diol, polyethylene triol, polyethylene polyol, polypropylenediamine, polypropylenetriamine, polypropylenepolyamine, polyTHF-diamine, polybutadiene diol, polyester dial, polyester triol, polyester polyol, polyesterether diol, polyesterether triol, polyesterether polyol, more preferably polypropylene diol, polypropylene triol, polyTHF diol, polyhexanediol carbamate diol, polycaprolactamdiol and polycaprolactamtriol. It is also possible for these components to be mixtures of the stated compounds.

In one particularly preferred embodiment the polyurethanes or polyureas contain polyols having a molecular weight of between 1000 and 10 000, more particularly 2000 to 6000 and very preferably 3000 to 5000 g/mol. These polyols are, with particular preference, polyTHF diol, polypropylene glycol, and also random copolymers and/or block copolymers of ethylene oxide and propylene oxide. More particularly they may be polyether polyols which in one preferred embodiment have been prepared by DMC catalysis and in one particularly preferred embodiment have been prepared by KOH catalysis. In one preferred embodiment use is made as chain extenders of diols having a molecular weight of 60 to 500, more particularly 60 to 180, the dioligomers of glycols being particularly preferred. With regard to the inventive properties of the adhesives and sealants it is particularly advantageous, furthermore, if the polyurethanes or poly-ureas contain 2,4- and/or 2,6-tolylene diisocyanate (TDI) and/or 4,4′-, 2,4′- and/or 2,2′-diphenylmethane diisocyanate (MDI) and/or 1-isocyanato-3,3,5-trimethyl-5-isocyanato-methylcyclohexane (IPDI), more particularly isomer mixtures of TDI, where a 2,4-isomer fraction of more than 40% is particularly preferred. The combination of the specific polyols and isocyanates specified in this paragraph produces adhesives or sealants of the invention which have a particularly low glass transition temperature and a low tendency towards marginal-zone soiling, without detriment to the further performance properties.

The polyurethanes or polyureas of the present invention may also comprise crosslinker components, chain stopper components and other reactive components. Some crosslinkers have already been listed among the chain extenders having at least three NCO-reactive hydrogens. The compounds in question may more particularly be glycerol, tetra(2-hydroxypropyl)ethylenediamines, pentaerythritol, trimethylolpropene, sorbitol, sucrose, triethanolamine and polymers having at least three reactive hydrogens (e.g. polyetheramines having at least three amine groups, polymeric triols, etc.). Suitable chain stoppers are, in particular, compounds having reactive hydrogens, such as monools, monoamines, monothiols and monocarboxylic acids. One specific embodiment uses monools, where C₁ to C₁₂ alcohols (especially methanol to dodecyl alcohol), higher alcohols, polymers such as, for instance, polyethers and polyesters having an OH group and structural units such as glycerol or sucrose; in which all bar one OH group have been reacted, with no further reactive hydrogen having been introduced in the course of the reaction.

In one particularly UV-stable variant, it is preferred as polyol component to use polyesters having at least two OH groups, polycarbonates having at least two OH groups, polycarbonate esters having at least two OH groups, polyTHF, polypropylene glycol, random copolymers and/or block copolymers of ethylene oxide and propylene oxide.

Adhesives and sealants comprising polyurethanes may further comprise stabilizing additives, to, protect, for example, from UV radiation, and oxidation; additives of the Hals (hindered amine light stabilizer) type are used more particularly. Mention may be made, by way of example, of 4-amino-2,2,6,6-tetramethylpiperidine.

For the polyurethanes and polyureas it is possible as latent curing agents to use oxazolidines, more particularly oxazolidines formed from diethanolamine and isobutylaldehyde or pivalaldehyde and/or aldemines formed from isophoronediamine, e.g. Incozol HP, and imines, e.g. Vestamin A139, low molecular mass aliphatic diamines, e.g. hexanediamine, and/or polyether polyamines such as, for example, Jeffamine® and isobutyraldehyde or pivalaldehyde, and/or a polyamine such as hexamethylenediamine, for example, or a Jeffamin® blocked with a hydroxypivalaldehyde ester.

In one preferred embodiment the adhesive or sealant of the invention comprises polyurethanes or polyureas which contain free isocyanate groups. The compounds in question here are more particularly isocyanate-terminated prepolymers. The isocyanate groups are able to react with water (including moisture from the atmosphere), forming amine groups which react with the isocyanate groups of the other polyurethane or polyurea molecules, and form urea linkages, thereby curing the adhesive or sealant.

In another embodiment, polyurea or polyurethane adhesives and sealants are configured as a two-component system. The first component may comprise a polyisocyanate and/or NCO prepolymer and the second component may comprise a polyol, polyamine and/or chain extender. After the two components have, been mixed, these two constituents react with one another, thereby curing the adhesive or sealant.

In a further embodiment in accordance with the invention, polyurethane prepolymers and polyurea prepolymers are reacted with at least one suitable functionalized polymerizable compound containing double bond, such as hydroxyethyl methacrylate, hydroxyethyl acrylate, hydroxypropyl methacrylate, hydroxypropyl acrylate, 4-hydroxy-butyl vinyl ether and isoprenol, for example.

The acrylates which can be used in accordance with the invention are compounds which include at least one monomer from the series of the acrylic esters and methacrylic esters, with preferably at least 70% by weight of the polymer being composed of at least one compound from the series of the acrylic esters, methacrylic esters and styrenes.

The monomers of the acrylate component preferably comprise at least one compound from the series ethyldiglycol acrylate, 4-tert-butylcyclohexyl acrylate, dihydrocyclo-pentadienyl acrylate, lauryl (meth)acrylate, phenoxyethyl (meth)acrylate, isobornyl (meth)acrylate, dimethylaminoethyl (meth)acrylate, tyanoacrylates, citraconate, itaconate and derivatives thereof, (meth)acrylic acid, methyl (meth)acrylate, ethyl (meth)acrylate, n-propyl (meth)acrylate, isopropyl (meth)acrylate, n-butyl (meth)-acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-propylheptyl (meth)acrylate, 2-ethylhexyl (meth)acrylate, nonyl (meth)acrylate, decyl (meth)acrylate, isodecyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl(meth)acrylate, 2-hydroxyethyl (meth)acrylate, 2-hydroxypropyl (meth)acrylate, stearyl (meth)acrylate; glycidyl (meth)acrylate, 2-aminoethyl (meth)acrylates, γ-(methacryloyloxypropyl)trimethoxysilane, ethylene oxide adducts of (meth)acrylic acid, trifluoromethylmethyl(meth)acrylate, 2-trifluord-methylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoro-ethylmethyl (meth)acrylate, 2-perfluorohexylethyl (meth)acrylate, 2-perfluorodecylethyl (meth)acrylate and 2-perfluorohexa decylethyl (meth)acrylate.

In one particular embodiment the monomers in question are two or more monomers from the series n-butyl (meth)acrylate, 2-hydroxyethyl (meth)acrylate, acrylic acid, methacrylic acid and methyl methacrylate.

Another embodiment uses copolymers of at least two of all of the aforementioned monomers, the proportion being selected in the form such that the resultant copolymers have the desired performance properties for adhesives and sealants. The skilled person is aware of suitable copolymers having the desired performance properties. Preference is given more, particularly to copolymers of n-butyl acrylate and methyl methacrylate, which are used in a molar ratio at which the resultant copolymer possesses a glass transition temperature which lies between those of the corresponding homopolymers. All in all the acrylates of the present invention may be either copolymers or homopolymers.

The acrylic acid polymers may also, furthermore, comprise other ethylenically unsaturated monomers, examples being isoprenol or hydroxybutyl vinyl ether. Examples here include mono- and polyunsaturated hydrocarbon monomers, vinyl esters (e.g. vinyl esters of C₁ to C₆ saturated monocarboxylic acids), vinyl ethers, monoethylenically unsaturated monocarboxylic and polycarboxylic acids and alkyl esters of these monocarboxylic and polycarboxylic acids (e.g. acrylic esters and methacrylic esters such as, for instance, C₁ to C₁₂ alkyl and more particularly C₁ to C₄ alkyl esters), amino monomers and nitriles, vinyls and alkylvinylidenes and amides of unsaturated carboxylic acids. Also suitable are unsaturated hydrocarbon monomers comprising styrene compounds (e.g. styrene, carboxylated styrene and alpha-methyl-styrene), ethylene, propylene, butylene and conjugated dienes (butadiene, isoprene and copolymers of butadiene and isoprene). The vinyl and halovinylidene monomers include-vinyl chloride, vinylidene chloride, vinyl fluoride and vinylidene fluoride. Examples of the Vinyl esters include aliphatic vinyl esters, such as vinyl formate, vinyl acetate, vinyl propionate, vinyl butyrate, vinyl isobutyrate, vinyl valerate, vinyl caproate and allyl esters of saturated monocarboxylic acids such as allyl acetate, allyl propionate and allyl lactate. The vinyl ethers include methyl vinyl ether, ethyl vinyl ether and N-butyl vinyl ether. Typical vinyl ketones include methyl vinyl ketones, ethyl vinyl ketones and isobutyl vinyl ketones. Examples of the dialkyl esters of monoethylenically unsaturated dicarboxylic acids are dimethyl maleate, diethyl maleate, dibutyl maleate, dioctyl maleate, diisooctyl maleate, dinonyl maleate, diisodecyl maleate, ditridecyl maleate, dimethyl fumarate, diethyl fumarate, dipropyl fumarate, dibutyl fumarate, dioctyl fumarate, diisooctyl fumarate, didecyl fumarate, dimethyl itaconate, diethyl itaconate, dibutyl itaconate and dioctyl itaconate. In particular the monoethylenically unsaturated monocarboxylic acids are acrylic acid, methacrylic acid, ethacrylic acid and crotonic acid. The monoethylenically unsaturated dicarboxylic acids include maleic acid, fumaric acid, itaconic acid and citric acid. As monoethylenically unsaturated tricarboxylic adds it is possible, with a view to the present invention, to make use, for example, of aconitic acid and its halogen-substituted derivatives. It is possible, furthermore, to use the anhydrides and esters of the aforementioned acids (e.g. maleic anhydride and citric anhydride). Examples of nitriles of ethylenically unsaturated monocarboxylic, dicarboxylic and tricarboxylic acids include acrylonitrile, α-chloro-acrylonitrile and methacrylonitrile. The amides of the carboxylic acids may be acrylamides, methacrylamides and other α-substituted acrylamides and N-substituted amides, e.g. N-methylolacrylamide, N-methylolmethylacrylamide, alkylated N-methylol-acrylamides and N-methylolmethacrylamides (e.g. N-methoxymethylacrylamide and N-methoxymethylmethacrylamide). Amino monomers used may be substituted and unsubstituted aminoalkyl acrylates, hydrochloride salts of the amino monomers, and methacrylates such as, for instance, β-aminoethyl acrylate, β-aminoethyl methacrylate, dimethylaminomethyl acrylate, β-methylaminoethyl acrylate and dimethylaminomethyl methacrylate. In the context of the present invention, with regard to the cationic monomers, mention may be made of α- and β-ethylenically unsaturated compounds which are suitable for polymerization and contain primary, secondary or tertiary amino groups, examples being dimethylaminoethyl methacrylate, dimethylaminoneopentyl acrylate, dimethylaminopropyl methacrylate and tert-butylaminoethyl methacrylate, or organic and inorganic salts of these compounds, and/or alkylammonium compounds such as, for instance, trimethylammonioethyl methacrylate chloride, diallyldimethyl-ammonium chloride, β-acetamidodiethylaminoethyl acrylate chloride and meth-acrylamidopropyltrimethylammonium chloride. These cationic monomers may be used alone or in combination with the aforementioned further monomers. Examples of hydroxy-containing monomers also include the β-hydroxyethyl (meth)acrylates, β-hydroxypropyl (meth)acrylates, γ-hydroxypropyl (meth)acrylates and.

The polysulphides which can be used in accordance with the invention are organic polymers which have sulphide bonds in the polymer. These may be, by way of example, a product of the reaction of an organic dihalide with sodium disulphide. Examples of the organic dihalides include aliphatic dihalides (e.g. bis-chloroethyl-formal) and vinyl halides. Thus, for example, the reaction of bis-chloroethylformal with a sodium disulphite solution leads to a polymer of the following structure:

—[CH₂CH₂OCH₂OCH₂CH₂Sx]ₙ—

in which “n” denotes the number of monomers in the polymer and “x” the number of successive sulphide bonds in the monomer (x may vary in the monomers of the same molecule). High molecular mass polymers of this kind may then be reacted to shorter-chain polymers with terminal thiol groups (for example by reductive reaction with NaSH and Na₂SO₂, and subsequent acidification). In this way, liquid, bridged polysulphides are obtained with terminal thiol end groups, which in specific embodiments have a molecular weight in the range from 1000 to 8000. The liquid polymers may then be cured to form elastomeric solids, as for example by the oxidation of the thiol end groups to disulphite bridges, using an oxidizing reagent such as, for instance, lead oxide, manganese dioxide, para-quinone dioxime and zinc peroxide. For the purposes of the present invention, the polysulphide adhesives and sealants encompass all polysulphide polymers which can be converted to a solid by curing. In specific embodiments the polysulphide adhesives and sealants comprise 30% to 90% by weight of at least one liquid polysulphide polymer; 2% to 50% by weight of filler, 2% to 10% by weight of a cyclohexanepolycarboxylic acid derivative, 1% to 3% by weight of a water scavenger and between 6% and 15% by weight of further ingredients such as, for instance, adhesion promoters, solvents and curing agents. An example of the preparation of polysulphide adhesives and sealants is disclosed in U.S. Pat. No. 3,431,239, with this method being incorporated into the present specification by reference. Polysulphide adhesives and sealants can be used as one- or two-component systems.

Besides components (A) and (B), the composition of the invention may comprise additional, further components. These may be, among others, the following auxiliaries and additives:
Adhesion promoters, examples being epoxysilanes, anhydridosilanes, adducts of silanes with primary aminosilanes, ureidosilanes, aminosilanes, diaminosilanes, and also their analogues in the form of monomer or oligomer and urea-silanes; e.g. Dynasylan AMEO, Dynasylan AMMO, Dynasylan DAMO-T, Dynasylan 1146, Dynasylan 1189, Silquest A-Link 15, epoxy resins, alkyl titanates, titanium chelates, aromatic-polyisocyanates, phenolic resins; which conform, for example, to the general formula:

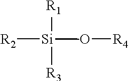

in which
R₁, R₂ and R₃ independently of one another are halogen, amine, hydrogen, alkoxy, acyloxy, alkyl, aryl, aralkyloxy, alkylaryl or aralkyl groups and also
alkyl group with olefinic groups, halides, amino, carbonyl, epoxy and glycidyloxy, ester, hydroxyimino, mercapto and sulphido, isocyanato, anhydrido, acryloyloxy, metharyloxy and vinyl groups, and also
aryl group with olefinic groups, halides, amino, carbonyl, epoxy and glycidyloxy, ester, hydroxyimino, mercapto and sulphido, isocyanato, anhydrido, acryloyloxy, metharyloyloxy and vinyl groups, and also
alkylaryl group with olefinic groups, halides, amino, carbonyl, epoxy and glycidyloxy, ester, hydroxyimino, mercapto and sulphido, isocyanato, anhydrido, acryloyloxy, metharyloyloxy and vinyl groups, and also
aralkyl group with olefinic groups, halides, amino, carbonyl, epoxy and glycidyloxy, ester, hydroxyimino, mercapto and sulphido, isocyanato, anhydrido, acryloyloxy, metharyloyloxy, and vinyl groups,
R₄ is alkyl and aryl.
Water scavengers for anhydrous systems as are present in the case of adhesives and sealants based on polyurethanes, polysulphides and/or polyureas, e.g. vinyltriethoxysilane, vinyltrimethoxysilane, α-functional silanes such as N-(silyl-methyl)-O-methyl-carbamates, more particularly N-(methylidimethoxysilylmethyl)-O-methyl-carbamate, (methacryloyloxymethyl)silanes, methoxymethylsilanes, N-phenyl-, N-cyclohexyl- and N-alkylsilanes, orthoformic esters, calcium oxide or molecular sieve;
catalysts, examples being metal catalysts in the form of organotin compounds such as dibutyltin dilaurate and dibutyltin diacetylacetonate, organobismuth compounds or bismuth complexes; compounds containing amino groups, examples being 1,4-diazabicyclo[2.2.2]octane and 2,2′-dimorpholinodiethyl ether, 1,8-diazabicyclo[5.4.0]undec-7-enes, 1,5-diazabicyclo[4.3.0]non-5-enes, and also aminosilanes. Further suitable metal catalysts include titanium, zirconium, bismuth, zinc and lithium catalysts, and also metal carboxylates, it also being possible to use combinations of different metal catalysts;
light stabilizers and ageing inhibitors, which act in particular as stabilizers against heat, light and UV radiation, examples being phenolic antioxidants which function as free-radical scavengers, such as 2,6-di-tert-butyl-p-cresol, 2,6-di-tert-butylphenol, 2,4-dimethyl-6-tert-butylphenol, 2,2′-methylenebis(4-methyl-6-tert-butylphenol), 4,4′-butylidenebis(3-methyl-6-tert-butylphenol), 4,4′-thiobis(3-methyl-6-tert-butylphenol), 5-tetrakis[methylene-3-(3,5-di-tert-butyl-4-hydroxyphenyl)propionate]methanes and 1,1,3-tris(2-methyl-4-hydroxy-5-tert-butylphenyl)butanes, and antioxidants based on amines (for example phenyl-6-naphthylamine, α-naphthylamine, N,N′-di-sec-butyl-p-phenylenediamine, phenothiazine and N,N′-diphenyl-p-phenylenediamines);
flame retardants, e.g. Al(OH)₃, huntite, brominated alkyl and aryl compounds;
biocides, such as, for example, algicides, fungicides or'fungal growth inhibitor substances, e.g. Ag, Ag*, compounds which give off CH₂O—;
fillers, e.g. ground or precipitated calcium carbonates, which optionally are coated with fatty acids or fatty acid mixtures, e.g. stearates, more particularly finely divided, coated calcium carbonate, carbon blacks, especially industrially manufactured carbon blacks, kaolins, aluminium oxides, silicas, more particularly highly disperse silica from pyrolysis processes, PVC powders or hollow beads. Preferred fillers are carbon black, calcium carbonates, such as precipitated or natural chalks such as Omya 5 GU, Omyalite 95 T, Omyacarb 90 T, Omyacarb 2 T-AV® from Omya, Ultra P-Flex® from Specialty Minerals Inc, Socal® U1S2, Socal® 312, Winnofil® 312 from Solvay, Hakuenka® from Shiraishi, highly disperse silicas from pyrolysis processes, and combinations of these fillers. Likewise suitable are minerals such as siliceous earth, talk, calcium sulphate (gypsum) in the form of anhydrite, hemihydrate or dihydrate, finely ground quartz, silica gel, precipitated or natural barium sulphate, titanium dioxide, zeolites, leucite, potash feldspar, biotide, the group of soro-, cyclo-, ino-, phyllo- and hectosilicates, the group of low-solubility sulphates such as gypsum, anhydrite or heavy spar (BaSO₄), and also calcium minerals such as calcite, metals in powder form (aluminium, zinc or iron, for example), and barium sulphate;
rheology modifiers, such as thickeners, e.g. urea compounds and also mono-amines, e.g. n-butylamine, methoxybutylamine and polyamide waxes, bentonites, silicones, polysiloxanes, hydrogenated castor oil, metal soaps, such as calcium stearate, aluminium stearate, barium stearate, precipitated silica, fumed silica and also poly(oxy-1,2-ethanediyl)-α-hydro-Ω-hydroxy polymer with oxy-1,2-ethanediyl-α-hydro-Ω-hydroxy-nonyl-phenoxyglycidyl ether oligomers and 5-isocyanato-1-(iso-cyanatomethyl)-1,3,3-trimethylcyclohexane or hydroxyethylcellulose or polyacrylic acid polymers and copolymers;
surface-active substances such as, for example, wetting agents, levelling agents, deaerating agents, defoamers and dispersants;
fibres, as for example of carbon, polyethylene or polypropylene SiO₂, cellulose;
pigments, e.g. titanium dioxide;
solvents such as, for instance, water, solvent, naphtha, methyl esters, aromatic hydrocarbons such a polyalkylbenzenes, toluene and xylene, solvents based on esters such as ethyl acetate, butyl acetate, allyl acetate and cellulose acetate, and solvents based on ketones such as methyl ethyl ketone, methyl isobutyl ketone and diisobutyl ketone, and also acetone, and mixtures of at least two of the aforementioned solvents;
   and also further substances used in adhesives and sealants.

As further components the adhesives or sealants of the invention may, in addition to the cyclohexanepolycarboxylic acid derivatives for use in accordance with the invention, further comprise one or more other, commercially customary plasticizers, examples being glycerol triacetate, phthalic acid C₄ to C₁₃ dialkyl esters, adipic acid C₄ to C₁₃ dialkyl esters, sebacic acid C₄ to C₁₃ dialkyl esters, pyromellitic acid C₄ to C13 trialkyl esters, benzoic esters, citric esters, C₁₀ to C₂₁ alkanesulphonic phenyl esters and/or polymeric plasticizers based on diol esters of aliphatic dicarboxylic acids, and adipic acid, glutaric acid or sebacic acid. Where such an additional plasticizer is added, the fraction of this additional plasticizer, based on the total amount of plasticizer in the adhesives or sealants of the invention, is generally not more than 30% by weight, preferably not more than 10% by weight. In general the cyclohexanepolycarboxylic esters for use in accordance with the invention, more particularly the cyclohexane-1,2-dicarboxylic acid C₄ to C₁₃ dialkyl esters, more preferably diisononyl cyclohexane-1,2-dicarboxylate, however, are used without addition of any such additional plasticizer.

In one embodiment the adhesive or sealant of the invention comprises 1% to 80% by weight of fillers, 0% to 50% by weight of water and/or solvents, and 0% to 20% by weight of rheology modifiers. Considered as being preferred is an amount of 25% to 40% by weight of component (A), 5% to 40% by weight of component (B), 30% to 55% by weight of fillers, 0% to 10% by weight of water and 1% to 10% by weight of rheology modifiers.

The present invention further provides for the use of the adhesive or sealant as a one- or two-component system for producing material bonds between parts to be joined. In the cured state the composition of the invention possesses a high mechanical strength in conjunction with high expandability, and also good adhesion properties.

Consequently it is suitable for a multiplicity of applications, more particularly as an elastic adhesive, as an elastic sealant or as an elastic coating. In particular it is suitable for applications which require rapid curing and impose exacting requirements on expandability at the same time as exacting requirements on the adhesion properties and the strengths.

Suitable applications are, for example, the material bonds between parts to be joined made of concrete, mortar, glass, metal, ceramic, plastic and/or wood. In one particular embodiment the parts to be joined are firstly a surface and secondly a covering in the form of carpet, PVC, laminate, rubber, cork, linoleum, wood, e.g. woodblock flooring, floorboards, boat decks or tiles. The composition of the invention can be used in particular for the jointing of natural stone. Moreover, the adhesives and sealants of the invention can be used for the manufacture or repair of industrial goods or consumer goods, and also for the sealing or bonding of components in construction or civil engineering, and also in particular, in the sanitary sector. The parts to be joined may especially be parts in automotive, trailer, lorry, caravan, train, aircraft, watercraft and railway construction.

An adhesive for elastic bonds in this, sector is applied with preference in the form of a bead in a substantially round or triangular cross-sectional area. Elastic bonds in vehicle construction are, for example, the adhesive attachment of parts such as plastic covers, trim strips, flanges, bumpers, driver's cabs or other components for installation, to the painted body of a means of transport, or the bonding of glazing into the body.

A preferred area of application in construction and civil engineering is that of construction joints, flooring joints, joints in accordance with the German Water Management Law, flashing joints, expansion joints or sealed joints in the sanitary sector. In one preferred embodiment the composition described is used as an elastic adhesive or sealant. In the form of an elastic adhesive, the composition typically has an elongation at break of at least 5%, and in the form of an elastic sealant it typically has an elongation at break of at least 300%, at room temperature.

For use of the composition as a sealant for joints, for example, in construction or civil engineering, or for use as an adhesive for elastic bonds in automotive construction, for example, the composition preferably has a paste-like consistency with properties of structural viscosity. A paste-like sealant or adhesive of this kind is applied by means of a suitable device to the part to be joined. Suitable methods of application are, for example, application from standard commercial cartridges, pouches or pouches inserted in cartridges, which are operated manually or by means of compressed air, or from a drum or hobbock by means of a conveying pump or an eccentric screw pump, optionally by means of an application robot.

The parts to be joined may where necessary be pretreated before the adhesive or sealant is applied. Such pretreatments include, in particular, physical and/or chemical cleaning processes, examples being abrading, sandblasting, brushing or the like, or treatment with cleaners or solvents, or the application of an adhesion promoter, an adhesion promoter solution or a primer.

In the context of its use as an adhesive, the composition of the invention is applied either to one or the other part to be joined, or to both, parts to be joined. Thereafter the parts to be bonded are joined, and the adhesive cures. It must in each case be ensured that the joining of the parts takes place within what is referred to as the open time, in order to ensure that the two parts are reliably bonded to one another.

The present invention further provides a process for preparing an adhesive or sealant, where a) between 10% and 50% by weight of component (A) and all of component (B) and, optionally, further components, more particularly from the series of fillers, thixotropic agents, antioxidants and UV absorbers, solvents and adhesion promoters, are introduced and mixed, and b) the remainder of component (A) and, optionally further components, more particularly, from the series of fillers, thixotropic agents, antioxidants and UV absorbers, solvents and adhesion promoters, are added and mixed.

For the preparation process of the invention it is considered preferred that the components employed are mixed with one another and/or kept moving throughout the entire operation. Alternatively the components employed may also be mixed with one another only at the end of the preparation process. Suitable mixing equipment encompasses all of the apparatus known for this purpose to the skilled person, and more particularly may be a static mixer, planetary mixer, horizontal turbulent mixer (from Drais), planetary dissolver or Dissolver (from PC Laborsysteme), intensive mixer and/or extruder.

The process of the invention for preparing the adhesive or sealant may be carried out discontinuously in, for example, a planetary mixer. It is, however, also possible to operate the process continuously, in which case extruders in particular have been found suitable for this purpose. In that case the binder is fed to the extruder, and liquid and solid adjuvants are metered in.

All in all it has been found, surprisingly, that the cyclohexanepolycarboxylic acid derivatives in the adhesives or sealants of the invention are largely stable to weathering. With the proposed adhesives and sealants comprising cyclohexanepoly-carboxylic acid derivatives, compositions are provided which feature good UV stability, temperature stability and moisture stability, without detriment to the further performance properties. Moreover, the cyclohexanepolycarboxylic acid derivatives of the invention possess a low glass transition temperature and can therefore be processed advantageously from the application standpoint. A further advantage of the proposed adhesives and sealants comprising cyclohexanepolycarboxylic acid derivatives lies in their well-balanced mechanical properties. Through the provision of the adhesives and sealants of the invention, therefore, it has been possible to solve the stated problem in its entirety.

The examples which follow illustrate the advantages of the present invention.

### EXAMPLES

### Example 1

1/3 Desmoseal M 280, plasticizer; Omyacarb 5 GU, and 2/3 Ti additive (toluenesulphonyl isocyanate), are introduced and mixed with one another under reduced pressure at a temperature of 60° C. Then 2/3 Desmoseal M 280 and Aerosil R 202 are added. In the last step, Dynasylan GLYMO, 1/3 Ti additive and Lupranat N 106 DMDEE are added and mixed. The sealant is dispensed into aluminium or plastic cartridges.

### Example 1

### Formulations

| | Jayflex | Hexamoll | | Jayflex | % by |
|---|---|---|---|---|---|
| | DIUP | DINCH | Mesamoll | DIDP | weight |
| Plasticizer | 160.00 | 160.00 | 160.00 | 160.00 | 20.00 |
| Desmoseal M 280 | 240.00 | 240.00 | 240.00 | 240.00 | 30.00 |
| Omyacarb 5 GU | 337.60 | 337.60 | 337.60 | 337.60 | 42.20 |
| Aerosil R 202 | 48.00 | 48.00 | 48.00 | 48.00 | 6.00 |
| Dynasylan GLYMO | 8.00 | 8.00 | 8.00 | 8.00 | 1.00 |
| Ti additive | 6.00 | 6.00 | 6.00 | 6.00 | 0.75 |
| Lupranat N 106 | 0.40 | 0.40 | 0.40 | 0.40 | 0.05 |
| DMDEE | | | | | |
| Total | 800.00 | 800.00 | 800.00 | 800.00 | 100.00 |

The numerical FIGURES in columns two to four relate to parts by weight.
Desmoseal M 280: polyurethane binder from Bayer MaterialScience AG
Jayflex DIUP: diisoundecyl phthalate from Exxon Mobil Corporation
Jayflex DIDP: diisodecyl phthalate from Exxon Mobil Corporation
Hexamoll DINCH: diisononyl cyclohexane-1,2-dicarboxylate from BASF SE
Mesamoll: alkanesulphonic acid phenyl ester from Lanxess Deutschland GmbH
Omyacarb 5 GU: ground chalk from Omya Inc.
Ti additive: monofunctional isocyanate from OMG Borchers GmbH
Aerosil R 202: fumed silica from Evonik Degussa GmbH
Dynasylan GLYMO: 3-glycidyloxypropyltrimethoxysilane from Evonik Degussa GmbH
Lupranat N 106 DMDEE: 2,2′-dimorpholinyldiethyl ether from BASF SE

Results. Example 1:

| | Jayflex | Hexamoll | | Jayflex |
|---|---|---|---|---|
| | DIUP | DINCH | Mesamoll | DIDP |
| Tensile strength after 7 days | | | | |
| of storage at 20° C.: | | | | |
| Extension % (DIN 53504) | 291.34 | 291.46 | 238.65 | 275.53 |
| Tensile strength N/mm² | 1.87 | 2.06 | 2.36 | 1.84 |
| (DIN 53504) | | | | |
| Force-100% N/mm² | 1.18 | 1.25 | 1.69 | 1.16 |
| (DIN 53504) | | | | |
| Glass transition temperature | −62.34 | −68.19 | −61.47 | −63.09 |
| (° C.)* | | | | |

*determined by means of dynamic scanning calorimetry (DSC) in the temperature range from −120° C. to 50° C. with a heating rate of 20 K/min and an N₂ flow rate of 50 ml/min.

### Example 2

The binder Acronal S 410 is adjusted to a pH of 8. Then the Pigmentverteiler NL is introduced, Lutensol AO 89 is added, and these components are mixed with one another. Subsequently the respective plasticizer, Kronos 2056, and Omyacarb 5 GU are added and mixing is carried out. The sealant is dispensed into aluminum or plastic cartridges. The respective formulations are shown in the table, with the numerical figures in columns two to four being parts by weight.

### Example 2

### Formulations

| | Jayflex | Hexamoll | | Jayflex | % by |
|---|---|---|---|---|---|
| | DIUP | DINCH | Mesamoll | DIDP | weight |
| Acronal S 410 pH 8 | 256.00 | 256.00 | 256.00 | 256.00 | 32.00 |
| Pigmentverteiler NL | 4.80 | 4.80 | .4.80 | 4.80 | 0.60 |
| Lutensol AO 89 | 2.40 | 2.40 | 2.40 | 2.40 | 0.30 |
| Plasticizer | 80.00 | 80.00 | 80.00 | 80.00 | 10.00 |
| Kronos 2056 | 12.00 | 12.00 | 12.00 | 12.00 | 1.50 |
| Omyacarb 5 GU | 444.80 | 444.80 | 444.80 | 444.80 | 55.60 |
| Total | 800.00 | 800.00 | 800.00 | 800.00 | 100.00 |

Acronal S 410: acrylate dispersion from BASF SE
Pigmentverteiler NL: pigment dispersant, sodium salt of polyacrylic acid, in water, from BASF SE
Lutensol AO 89: fatty alcohol ethoxylate, in water, from BASF SE
Jayflex DIUP: diisoundecyl phthalate from Exxon Mobil Corporation
Jayflex DIDP: diisodecyl phthalate from Exxon Mobil Corporation
Hexamoll DINCH: diisononyl cyclohexane-1,2-dicarboxylate from BASF SE
Mesamoll: phenyl alkanesulphonate from Lanxess Deutschland GmbH
Omyacarb 5 GU: ground chalk from Omya Inc.
Kronos 2056: titanium dioxide from KRONOS INTERNATIONAL, Inc.

### Results Example 2:

| | Jayflex | Hexamoll | | Jayflex |
|---|---|---|---|---|
| | DIUP | DINCH | Mesamoll | DIDP |
| Tensile strength after 7 days | | | | |
| of storage at 20° C.: | | | | |
| Extension % (DIN 53504) | 98.98 | 107.95 | 69.09 | 96.67 |
| Tensile strength N/mm² | 0.73 | 0.68 | 0.54 | 0.73 |
| (DIN 53504) | | | | |
| Force-100% N/mm² | 0.68 | 0.65 | / | 0.75 |
| (DIN 53504) | | | | |
| Glass transition temperature | −44.21 | −69.11 | −43.22 | −51.02 |
| (° C.)* | | | | |

*determined by means of dynamic scanning calorimetry (DSC) in the temperature range from −120° C. to 50° C. with a heating rate of 20 K/min and an N₂ flow rate of 50 ml/min.

As is evident from the examples, the addition of Hexamoll DINCH allows the glass transition temperature to be reduced as compared with the use of conventional phthalates such as DIUP, for example, in the adhesive and sealant.

1.-15. (canceled)

16. An adhesive or sealant comprising:
(A) 10% to 90% by weight of at least one compound selected from the group consisting of: polyureas, polyacrylates and polysulphides; and
(B) 1% to 50% by weight of at least one cyclohexanepolycarboxylic acid derivative wherein the adhesive or sealant containing no C₄ to C₈ alkyl terephthalate.

17. The adhesive or sealant according to claim 16, further comprising any one or more of the following:
1% to 80% by weight of fillers;
0% to 50% by weight of water and/or solvent; and/or
0% to 20% by weight of rheology modifiers.

18. The adhesive or sealant according to claim 16, wherein component (B) comprises at least one cyclohexanepolycarboxylic acid derivative of the formula (I), 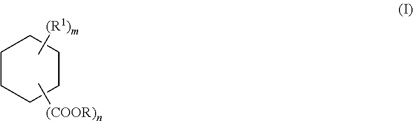
in which
R¹ is a substituent on the saturated cyclohexane ring and is a C₁-C₁₀ alkyl or C₃-C₈ cycloalkyl,
m is 0, 1, 2, 3 or 4,
n is 2, 3 or 4, and
R is a C₁-C₃₀ alkyl, C₁-C₃₀ alkoxy, C₃-C₈ cycloalkyl, C₆-C₃₀ arylphenyl or C₁-C₃₀ alkyl-cycloalkyl group, with at least one radical R being C₁-C₃₀ alkyl, C₁-C₃₀ alkoxy or C₃-C₈ cycloalkyl group.

19. The adhesive or sealant according to claim 16, wherein component (B) is cyclohexane-1,2-dicarboxylic acid di(isononyl) ester.

20. The adhesive or sealant according to claim 16, further comprising one or more of the following: auxiliaries and additives, dispersants, film-forming assistants, pigments, rheological assistants, water scavengers, adhesion promoters, catalysts, light stabilizers, ageing inhibitors, flame retardants and/or biocides.

21. The adhesive or sealant according to claim 16, characterized in that it is a one-component system.

22. The adhesive or sealant according to claim 16, characterized in that it is a two-component system.

23. A process for preparing an adhesive or sealant according to claim 16 comprising:
introducing and mixing between 30% and 50% by weight of component (A) and all of component (B) and optionally further components
adding and mixing the remainder of component (A) and optionally further components.

24. The process for preparing an adhesive or sealant according to claim 23, wherein the process is carried out discontinuously.

25. The process for preparing an adhesive or sealant according to claim 23, wherein the process is carried out continuously.

26. A method for producing material bonds between parts to be joined comprising: utilizing the adhesive or sealant according to claim 16.

27. The method of claim 26, wherein the parts to be joined are made of concrete, mortar, glass, metal, ceramic, plastic, and/or wood.

28. The method of claim 26, wherein the parts to be joined are firstly a surface and secondly a covering in the form of a carpet, PVC, a laminate, rubber, cork, linoleum, wood or tiles.

29. The method of claim 26, wherein the material bond is a construction joint, an expansion joint, a flooring joint, a facade joint, building partition joints, flashing joints, glazing, window glazing, structural glazing, roof glazing, window sealing or a sealed joint in the sanitary sector.

30. The method of claim 26, wherein the parts to be joined are parts in electrical, mechanical, automotive, lorry, caravan, train, trailer, aircraft, watercraft and railway construction.
